(19) United States
(12) Patent Application Publication
(10) Pub. No.: US 2004/0191707 A1
(43) Pub. Date: Sep. 30, 2004

(54) Emulsion of silver halide fine grains and process for the preparation of emulsion of silver halide tabular grains

(76) Inventors: Tetsurou Mitsui, Kanagawa (JP); Masayuki Hayashi, Kanagawa (JP); Katsuhisa Ohzeki, Kanagawa (JP)

Correspondence Address: BIRCH STEWART KOLASCH & BIRCH, PO BOX 747, FALLS CHURCH, VA, 22040-0747, US

(21) Appl. No.: 10/805,364

(22) Filed: Mar. 22, 2004

(30) Foreign Application Priority Data
Mar. 31, 2003 (JP) 2003-095281
Mar. 31, 2003 (JP) 2003-095282
Oct. 14, 2003 (JP) 2003-353217

(51) Int. Cl. G03C 1/46

(52) U.S. Cl. 430/567

(57) ABSTRACT

A process for the preparation of an emulsion of silver halide fine grains having a number-average equivalent circle diameter of 100 nm or less and coefficient of variation in equivalent circle diameter of 40% or less, wherein the fine grains are prepared via at least one Ostwald ripening step.

### FIELD OF THE INVENTION

The present invention relates to a process for the preparation of a monodisperse emulsion of silver halide fine grains and more particularly to a process for the preparation of an emulsion of thinner tabular grains using same.

### BACKGROUND OF THE INVENTION

As silver halide grains to be used as light-sensitive element there are widely used silver halide tabular grains for the purpose of increasing the area of receiving light. In order to raise the percent efficiency of light reception of the silver halide tabular grains, it is preferred that the thickness of the tabular grains be as small as possible. The preparation of silver halide grains generally involves two steps, i.e., nucleation for the formation of grains as growing nuclei and growth. Nucleation can he accomplished by a method involving the direct charge of a water-soluble silver solution or an aqueous solution of alkali halide into a reaction vessel having various agitation units. For the growth of grains as nuclei, too, the aforementioned ion addition method is widely practiced. However, this method is disadvantageous in that the tabular grains pass through a high saturation region in the vicinity of the port through which silver ion or halide ion is fed, causing the rise of the thickness of the tabular grains. As a countermeasure, a preparation method is reported in some references which comprises charging silver halide fine grains prepared by charging a water-soluble silver solution, an aqueous solution of alkali halide and an aqueous solution of dispersant into an external mixer provided separately of the reaction vessel into the reaction vessel to cause Ostwald ripening that makes dissolution, and then allowing the tabular grains to grow in a low saturation state. As a method which comprises continuously preparing fine grains and charging the grains into the reaction vessel, Patent Reference 1 is disclosed. However, this reference lacks description of method for the preparation of silver halide fine grains having such a desirable form. In the invention, it has been found that the fine grains can be size-controlled and monodispersed when ripened under proper conditions within a proper fine grain size range suitable for the growth of fine grains. It has been definitely proposed that when silver halide fine grains are ripened during the step for the preparation of the silver halide fine grains, monodisperse size-controlled silver halide fine grains required for the preparation of silver halide tabular grains having an extremely small thickness can be prepared. Thus, the preparation process is definitely different from the preparation processes disclosed in the aforementioned references. The prior art preparation processes are aimed at using the silver halide fine grains thus prepared for the growth of tabular grains without causing ripening while preventing the change of form as much as possible. For example, Patent Reference 2 discloses a method which comprises using a physical inhibitor to positively prevent the change of form due to ripening of fine grains. However, this method is definitely different from the definitely proposed preparation method of the invention which comprises introducing a ripening step involving the change of fine grain form into the step of preparing silver halide fine grains to effectively provide the fine grains with desired form and stability.

In recent years, there has been a growing importance of fine grain material mainly composed of nanograins in the art of up-to-date material. The method disclosed in the invention provides silver halide fine grains useful for the preparation of extremely thin silver halide tabular grains. The method of the invention also provides monodisperse silver halide fine grains the size of which are controlled in nanoscale at a high efficiency. Thus, the method of the invention can be expected to find wide application in the art of material concerning nanograins.

On the other hand, the amount of silver halide grains in the emulsion of silver halide grains to be produced is designed such that the sum of the amount of water containing dispersant required for agitation, the amount of water-soluble silver solution, the amount of aqueous solution of alkali halide and the amount of additives is less than the maximum amount of liquid in the reaction vessel. In order to raise the productivity by increasing the produced amount of silver halide grains, the concentration of the water-soluble silver solution and the aqueous solution of alkali halide, which account for the majority of the solutions to be processed, may be raised to increase the amount of silver halide grains to be produced at one batch. However, since the concentration of the water-soluble silver solution and the halide ions are properly predetermined to obtain desired silver halide grains, the rise of the concentration of these components not only causes the change of size, shape and size distribution of grains but also adversely affects photographic properties such as fog resistance, sensitivity and gradation. In order to eliminate these adverse effects, it is necessary that the water-soluble silver solution and the aqueous solution of alkali halide thus added be removed with unnecessary salts without changing the concentration thereof. A method which comprises the use of a dehydrator and a desalting device during growth to solve these problems is disclosed in Patent Reference 3. However, these methods are disadvantageous in that a water-soluble silver solution and an aqueous solution of alkali halide are directly charged into the reaction vessel, causing the rise of the thickness of tabular grains.

[Patent Reference 1] JP-B-7-23218 (the term “JP-B” as used herein means an “examined Japanese patent publication”)

[Patent Reference 2] European Patent No. 431584B1

[Patent Reference 3] U.S. Pat. No. 4,334,012

### SUMMARY OF THE INVENTION

An aim of the invention is to provide a process for the preparation of a monodisperse emulsion of silver halide fine grains having a size controlled to a small size range at a high efficiency (continuously in a short period of time). Another aim of the invention is to provide a process for the preparation of an emulsion of silver halide tabular grains having a smaller thickness at a high efficiency. A further aim of the invention is to provide a process for the preparation of a high sensitivity less foggable emulsion of tabular grains.

The invention is intended to provide a process for the preparation of monodisperse silver halide fine grains having a desired size at a high efficiency and use this preparation process to prepare an emulsion of tabular grains having an unprecedentedly smaller thickness. The invention is also intended to make the use of ultrafiltration method to make it possible to prepare an emulsion of tabular grains having a smaller thickness on an industrial basis. The aims of the invention are accomplished by the following processes.

(1) A process for the preparation of an emulsion of silver halide fine grains having a number-average equivalent circle diameter of 100 nm or less and coefficient of variation in equivalent circle diameter of 40% or less, wherein the fine grains are prepared via at least one Ostwald ripening step.

(2) The process for the preparation of an emulsion of silver halide fine grains as defined in Clause (1), wherein one or more Ostwald ripening steps are effected in such a manner that the absolute value of coefficient of variation in equivalent circle diameter of the fine grains shows a drop of at least 5% from before ripening.

(3) The process for the preparation of an emulsion of silver halide fine grains as defined in Clause (1) or (2), wherein the silver halide fine grains are continuously prepared using a device substantially free of residence portion.

(4) The process for the preparation of an emulsion of silver halide fine grains as defined in any of Clauses (1) to (3), wherein the silver halide fine grains have coefficient of variation in equivalent circle diameter of 20% or less.

(5) The process for the preparation of an emulsion of silver halide fine grains as defined in any of Clauses (1) to (4), wherein the silver halide fine grains have coefficient of variation in equivalent circle diameter of 15% or less.

(6) The process for the preparation of an emulsion of silver halide fine grains as defined in any of Clauses (1) to (5), wherein the silver halide fine grains have a number-average equivalent circle diameter of 40 nm or less.

(7) The process for the preparation of an emulsion of silver halide fine grains as defined in any of Clauses (1) to (6), wherein the silver halide fine grains have a percent twinning (proportion of twin) of 10% or less.

(8) A process for the preparation of an emulsion of silver halide tabular grains, wherein at least a part of the growth of the silver halide tabular grains is carried out by charging silver halide fine grains prepared by the method defined in any one of Clauses (1) to (7) in the reaction vessel in which the growth of the silver halide tabular grains is effected.

(9) The process for the preparation of an emulsion of silver halide tabular grains as defined in Clause (8), wherein the addition of the fine grains is effected immediately after the preparation thereof.

(10) The process for the preparation of an emulsion of silver halide tabular grains as defined in Clause (8) or (9), wherein ultrafiltration is effected in at least a part of the step of preparation of the emulsion of silver halide tabular grains.

### BRIEF DESCRIPTION OF THE DRAWINGS

FIG. 1 is a sectional view illustrating the schematic configuration of a device as an embodiment of implementation of the invention;

FIG. 2 is a schematic sectional view illustrating the process for the production of a mixer according to an embodiment of implementation of the invention;

FIG. 3 is a perspective view illustrating the schematic configuration of a magnetic coupling used in the agitator of the mixer according to an embodiment of implementation of the invention;

FIG. 4A or FIG. 4B are perspective views illustrating the action of the magnetic coupling shown in FIG. 3; and

FIG. 5 is a conceptional diagram of a silver halide preparation device (mixer and ripening unit) according to the invention.

Description of Reference Numerals and Signs

1 Reaction vessel

2 Impellor blade

3 Dispersant

4 Silver feed pipe

5 Halide feed pipe

6 Additive chemical pipe

7 Reaction solution withdrawing pipe

8 Reaction solution withdrawing valve

9 Liquid feed pipe

10 Pump

11 Feed valve

12 Feed pressure gauge

13 Ultrafiltration membrane module

14 Liquid flux pipe

15 Reflux pressure gauge

16 Reflux valve

17 Reflux flow meter

18 Liquid passing pipe

19 Passing pressure gauge

20 Passing valve

21 Passing flow meter

22 Passing liquid receiving vessel

23 Passing liquid

24 Reverse washing pipe

25 Reverse washing pump

26Reverse washing valve

27 Check valve

28 Mixer

30 Agitator

31, 32, 33 Liquid feed port

34 Liquid discharge port

35 Stirring tank

36 Main tank body

37 Seal plate

38, 39 Impellor blade

40, 41 Outer magnet

42, 43 Motor

44 Central rotary axis

45 Double-sided two-pole magnet

46 Double-ended two-pole magnet

L Magnetic line of force

47 Liquid feed pipe

48 Silver feed pipe

49 Halide feed pipe

50 Mixer for preparing unripened silver halide fine grains

51 Liquid feed pipe

52 Ripening unit

53 Ripened silver halide fine grain feed pipe

### DETAILED DESCRIPTION OF THE INVENTION

The silver halide photographic emulsion to be prepared according to the invention will be described hereinafter.

The process for the preparation of the emulsion of silver halide fine grains according to the invention will be described hereinafter. The term “size of fine grain” as used herein is meant to indicate the equivalent circle diameter of the fine grain. The equivalent circle diameter of silver halide fine grain can be determined as diameter of circle having the same projected area as grain by observing the grain under direct process electron microscope. Since the silver halide fine grains are grains subject to size increase due to ripening or the like, the observation of the fine grains to be added is effected after stopping the change of size of grains with a ripening inhibitor or growth inhibitor. Alternatively, the silver halide grains to be added are rapidly put on a mesh for observation under electron microscope, and then immediately freed of water content for observation. The silver halide fine grains can be easily observed under electron microscope at a temperature of not higher than −100° C. In some detail, 1,000 or more grains are determined for equivalent circle diameter from which the number-average equivalent circle diameter and coefficient of variation in equivalent circle diameter can be then determined. The coefficient of variation in equivalent circle diameter is obtained by dividing the standard deviation of equivalent circle diameter of 1,000 or more grains by the number-average equivalent circle diameter, and then multiplying the quotient by 100.

The term “Ostwald ripening” or “ripening” as used herein is meant to indicate a phenomenon occurring in a system having silver halide grains into which system no solutes causing precipitation of silver halide such as silver salt solution and halide solution are newly supplied externally. In some detail, the difference in solubility between grains or sites on grain causes one of the grains or sites to be dissolved and supply the solutes into the system, allowing the other grain or site to grow with the solutes. Referring to intergrain Ostwald ripening, for example, smaller grains are partly or entirely dissolved to provide the system with the solutes which are then deposited on the surface of larger grains because the greater the size of grains is, the lower is the equilibrium solubility of the surface of the grains. As a result, larger grains grow to become even larger grains.

Silver halide fine grains having a number-average equivalent circle diameter as very small as 100 nm or less, preferably 50 nm or less, more preferably 40 nm or less can be subjected to ripening under conditions predetermined such that only smaller unripened fine grains are dissolved to give a monodisperse emulsion of grains having a size falling within a proper range of small values.

In the invention, the final fine grains (hereinafter referred to as “silver halide fine grains A”) are prepared via preparation steps, including one or more Ostwald ripening steps for providing fine grains which are monodisperse within a size range desirable for the purpose. The unripened silver halide fine grains the size distribution of which is to be optimized (hereinafter referred to as “silver halide fine grains B”) are prepared by mixing and reacting an aqueous solution of silver salt with an aqueous solution of halide in the presence of a dispersant capable of protecting colloid. The preparation process may be a batchwise process involving nucleation which comprises supplying the aqueous solution of silver salt and the aqueous solution of halide into the aqueous solution containing a dispersant by a double jet process and arbitrary ripening and growth steps for forming grains having an arbitrary size and size distribution, or may involve the use of a mixer which is arranged such that the introduction of the aqueous solution of silver salt and the aqueous solution of halide into a closed site having some mixing capacity allows the continuous preparation and discharge of fine grains. The dispersant may be added to the halide solution. This is desirable particularly when the mixer which is arranged such that the introduction of the aqueous solution of silver salt and the aqueous solution of halide into a closed site having some mixing capacity allows the continuous preparation and discharge of grains is used.

The Ostwald ripening step of optimizing the size distribution of the silver halide fine grains A may be effected in the mixer in which the unripened silver halide fine grains B have been prepared or in other mixers or vessels or other devices or sites such as piping through which the emulsion moves to some vessels.

The size distribution of the silver halide fine grains A thus prepared depends on the size distribution and the ripening conditions of the unripened silver halide fine grains B. It is therefore necessary to control the size distribution of the silver halide fine grains B, However, the size distribution of the unripened fine grains B, if it is polydisperse, can easily undergo Ostwald ripening and thus have an unstable shape. On the other hand, the monodisperse silver halide fine grains obtained by ripening have a reduced difference in size between fine grains and thus undergo Ostwald ripening less easily than the unripened grains. Thus, the silver halide fine grains thus ripened have a greater stability of shape than the unripened grains. Therefore, the Ostwald ripening step of optimizing size distribution maybe effected after a predetermined period of storage of the unripened fine grains. However, in order to improve the reproducibility of production of fine grains which are allowed to grow and stabilize the shape of the fine grains thus prepared, it is desirable that the ripening step begin shortly after the preparation of the unripened silver halide fine grains B. The term “shortly after the preparation of the unripened silver halide fine grains B” as used herein is meant to indicate “within 10 minutes, preferably 1 minute, more preferably 10 seconds after the termination of the preparation of the fine grains”.

The silver halide fine grains A the size distribution of which has been adjusted properly for the purpose need to have a constant shape with a good reproducibility. To this end, the silver halide fine grains A are preferably prepared by continuously effecting the step of preparing the unripened silver halide fine grains B and the step of ripening the fine grains using a device substantially free of residence portion. The term “device substantially free of residence portion” as used herein is meant to indicate a device comprising either or both of a tubular structure in which an emulsion of fine grains, a silver salt solution, a halide solution and other additive solutions undergo no circulation or residence and a residence portion the residence time t of which is 1 minute or less, preferably 10 seconds or less, more preferably 1 second or less as represented by the following equation (1):

$$t = V / {\sum }_{i} {a}_{i} \qquad ( 1 )$$

wherein t represents residence time; V represents the volume of the residence portion; and aᵢ represents the amount of emulsion of fine grains and additive solution to be introduced into the residence portion.

The residence portion is preferably arranged such that the solutions are stirred and mixed by an impellor blade or the like to prevent themselves from being kept residing therein.

The silver halide fine grains A, if used for the preparation of silver halide tabular grains, need to be monodisperse to control the thickness of the silver halide tabular grains and prepare thinner tabular grains. Even when used for other purposes, silver halide fine grains A having a greater monodispersibility can be applied more widely. The coefficient of variation in equivalent circle diameter of the fine grains is 40% or less, preferably 20% or less, more preferably 15% or less, even more preferably 10% or less.

The ripening step of rendering the silver halide fine grains A monodisperse is preferably effected under conditions predetermined such that the coefficient of variation in equivalent circle diameter of the fine grains thus ripened is further reduced preferably by 5%, more preferably by 15%, even more preferably by 20% from that of the unripened silver halide fine grains B as calculated in terms of absolute value. The reduction of 5% as calculated in terms of absolute value means that when the coefficient of variation in equivalent circle diameter of the unripened silver halide fine grains B is 30%, the coefficient of variation in equivalent circle diameter of the silver halide fine grains A is 25%.

In order to exert a high monodispersing effect in the ripening step, it is necessary to control the concentration of excess halogen ions in either or both of preparation of the unripened silver halide fine grains B and ripening. In the case where silver bromoiodide is prepared, these steps are preferably effected at a pBr of from 1.0 to 5.0, more preferably from 1.7 to 4.0, even more preferably from 19 to 3.5. The concentration of excess halogen ions during ripening may be adjusted to the desired value during the preparation of the unripened fine grains or shortly before the initiation of ripening.

The ripening temperature is not specifically limited so far as the emulsion of unripened fine grains B is not heated or frozen to an extent such that its state is deteriorated. Ripening may be effected during storage by controlling the period of refrigeration. However, in order to allow rapid and stable progress of ripening, the ripening temperature is preferably from 30° C. to 70° C., more preferably from 40° C. to 60° C.

The period during which ripening is effected is not specifically limited and varies with the ripening conditions and the desired shape of fine grains. However, in order to prepare the emulsion A of fine grains having a constant shape with a good reproducibility, the ripening time needs to be properly long. In the case where ripening is continuously effected from the preparation of the unripened fine grains B during the use of the fine grains A in the growth of tabular grains and the emulsion A of fine grains thus prepared is then immediately supplied into the reaction vessel, the ripening time needs to be so short as to prevent the drop of production efficiency. In this case, the ripening time is preferably from not shorter than 10 seconds to not longer than 60 minutes, more preferably from not shorter than 1 minute to not longer than 30 minutes, even more preferably from not shorter than 5 minutes to not longer than 20 minutes.

In order to provide the ripened fine grains A with a desired shape, it is necessary that the equivalent circle diameter and coefficient of variation in equivalent circle diameter of the unripened silver halide fine grains B be properly predetermined and controlled in the various cases. It is necessary that the equivalent circle diameter of the unripened fine grains B be smaller than the desired equivalent circle diameter of the ripened fine grains A. Further, when the ripening conditions remain the same, fine grains B having a greater polydispersibility have a greater rise of equivalent circle diameter due to ripening.

In the case where it is necessary to reduce the percent twinning at the step of preparing the unripened silver halide fine grains B, the pH value of the solution containing a dispersant to be used in the formation of nuclei is preferably not lower than 7, more preferably not lower than 8, even more preferably not lower than 10.

Referring to the pH value during ripening, in the case where ripening has been effected at various pH values until the same coefficient of variation is reached, the higher the pH value is, the greater is the equivalent circle diameter of the ripened silver halide fine grains. Therefore, in the case where ripening is effected such that a sufficient monodispersibility is given, it is necessary that the pH value during ripening be controlled such that the silver halide fine grains A have a desired equivalent circle diameter.

The halogen composition is selected from the group consisting of silver chloride, silver bromochloride, silver bromide, silver bromoiodide, silver chloride, silver bromochloride, silver iodide, silver chloroiodide and silver bromochloroiodide but is preferably silver bromoiodide having a silver iodide content of from 1 to 5 mol %.

A water-soluble silver solution, an aqueous solution of alkali halide and a dispersant solution may be charged in the mixer for use in the preparation process of the invention to prepare desired silver halide fine grains. During this procedure, the aforementioned three solutions may be separately added. Alternatively, the dispersant solution may be added in admixture with the aqueous solution of alkali halide.

As the water-soluble silver solution there is preferably used an aqueous solution of silver nitrate. As the aqueous solution of alkali halide there may be normally used an aqueous solution of potassium, bromide, sodium bromide, potassium chloride, sodium chloride, potassium iodide, sodium iodide or mixture thereof.

The concentration of,the water-soluble silver solution and the aqueous solution of alkali halide to be charged in the fine grain preparing device for use in the preparation process of the invention is preferably 4 mol/l or less, more preferably 1 mol/l or less, most preferably 0.2 mol/l or less (preferably 0.001 mol/l or more). The temperature of the aqueous solution is preferably from not lower than 5° C. to not higher than 75° C.

As the dispersant to be used in the fine grain preparing device there is preferably used gelatin. Since gelatin has a great effect on the percent twinning in the silver halide grains thus produced, the desired concentration of the aqueous solution of gelatin depends on the purpose of the silver halide fine grains thus produced. In the case where silver halide fine grains are used as nuclei for the preparation of silver halide tabular grains, parallel double twin nuclei are needed, making it necessary to adjust the concentration of the aqueous solution of gelatin such that the desired percent twinning can be attained. It is preferred that the gelatin concentration be predetermined such that the content of gelatin per g of silver in the mixture of the aqueous solution of silver salt and the aqueous solution of halide is from 0.03 g to 0.4 g, more preferably 0.3 g or less. In the case where the silver halide grains are used for growth, it is preferred that the silver halide grains thus added be dissolved rapidly. To this end, it is preferred that there be less twin nuclei and the concentration of the aqueous solution of gelatin be higher. The concentration of the aqueous solution of gelatin is preferably such that the amount of gelatin to be added per g of silver nitrate is from 0.2 g to 3 g, more preferably 0.3 g or more, most preferably 0.4 g or more.

As the gelatin to be used as a dispersant for use in the fine grain preparing device there is preferably used an oxidized gelatin having a molecular weight as low as 30,000 or less to inhibit the rise of the thickness of the silver halide tabular grains and the agglomeration of the silver halide fine grains A and B and exert a desired effect of rendering the grains monodisperse by ripening.

As the mixer for forming the unripened silver halide fine grains B to be used in the preparation process of the invention there is preferably used any of the following three types of mixers. (1) Mixer Arranged Such that Stirring is Effected Using Two or More Rotary Axes Provided in a Closed Stirring Tank

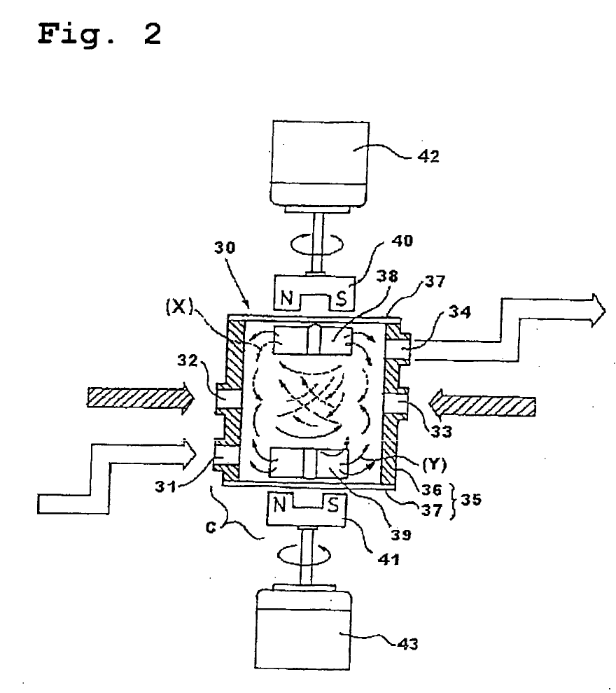

As shown in FIG. 2, a water-soluble silver solution, an aqueous solution of alkali halide and optionally an aqueous solution of dispersant are introduced into a mixer 30 provided outside the reaction vessel through addition systems (feed opening) 31, 32 and 33, respectively. (During this procedure, if necessary, the aqueous solution of dispersant may be added in admixture with the water-soluble silver solution and/or the aqueous solution of alkali halide) These solutions are rapidly and vigorously mixed in thee mixer, and then immediately introduced through a system (discharge port) 34 into the reaction vessel where silver halide fine grains are then formed. During this procedure, the emulsion discharged from the mixer may be once stored in another vessel from which it is then supplied into the reaction vessel later. After the termination of the formation of fine grains in the reaction vessel, the water-soluble silver solution, the aqueous solution of alkali halide and optionally the aqueous solution of dispersant are further supplied into the mixer 30 through the addition systems 31, 32 and 33, respectively. (During this procedure, if necessary, the aqueous solution of dispersant may be added in admixture with the water-soluble silver solution and/or the aqueous solution of alkali halide) These solutions are rapidly and vigorously mixed in the mixer, and then immediately introduced through the system 34 into the reaction vessel 1 where they are then uniformalized.

An embodiment of the mixer of the invention will be described hereinafter. As in the related art, the impellor blade is equipped with a driving axis. When the impellor blade is rotated at such a high speed by a driving machine provided outside the mixer, it is disadvantageous in that it is extremely difficult to seal the mixing tank and the driving axis. In the invention, as described below, the use of an impellor blade which is magnetically induced by an external magnet connected thereto with a magnetic coupling causes rotation requiring no driving axis, making it possible to solve this problem. In FIG. 2, the stirring tank 35 comprises a stirring tank main body 36 having a vertical central axis and a seal plate 37 which is a wall closing the upper and lower openings of the stirring tank main body 36. The stirring Lank main body 36 and the seal plate 37 each are made of a non-magnetic material having an excellent permeability. Impellor blades 38 and 39 are provided apart, i.e., at opposing upper and lower ends of the stirring tank 35. The impellor blades 38 and 39 are driven such that they are rotated in opposite directions. The impellor blades 38 and 39 form a magnetic coupling C with external magnets 40 and 41 disposed outside the wall of the tank (seal plate 37) disposed adjacent to the impellor blades 38 and 39, respectively. In other words, the impellor blades 38 and 39 are connected to the external magnets 40 and 41 with a magnetic force, respectively. By rotationally driving the external magnets 40 and 41 by separate motors 42 and 43, respectively, the impellor blades 38 and 39 are rotated in opposite directions.

In FIG. 2, the mixer is shown further provided with a stirring tank 35 comprising liquid feed ports 31, 32 and 33 through which the water-soluble silver solution, the aqueous solution of alkali halide and optionally the aqueous solution of dispersant to be stirred are allowed to flow thereinto and a discharge port 34 through which the emulsion of silver halide fine grains thus stirred is discharged and a pair of impellor blades 38 and 39 which are stirring units that are rotationally driven in the stirring tank 35 to control the state of the liquid being stirred in the stirring tank 35. The mixer 18 there is normally in a circular form but may be in other forms such as rectangular parallelepiped and hexagonal pillar. The pair of impellor blades 38 and 39 are disposed apart from each other, i.e., at opposing upper and lower inner ends of the stirring tank 35 and are rotationally driven in opposite directions. While the pair of impellor blades 38 and 39 are shown disposed at opposing upper and lower ends in FIG. 2, they may be disposed in opposing horizontal or oblique inner sides of the stirring tank. While there are shown used a pair of impellor blades disposed in opposing sites in FIG. 2, four or more even number of impellor blades constituting two or more pairs which are rotated in opposite directions may be used. Alternatively, an odd number (including one) of impellor blades which do not constitute a pair may be used. Alternatively, an even number of impellor blades constituting a pair which are rotated in opposite directions and an odd number (including one) of impellor blades can be used in combination to perform agitation at an even higher efficiency.

In the mixer of the invention, in order to realize a higher mixing efficiency during the driving of the opposing impellor blades in the mixer, it is necessary that the impellor blades be rotated at a high speed. The rotary speed of the impellor blades is 1,000 rpm or more, preferably 3,000 rpm or more, even more preferably 5,000 rpm or more.

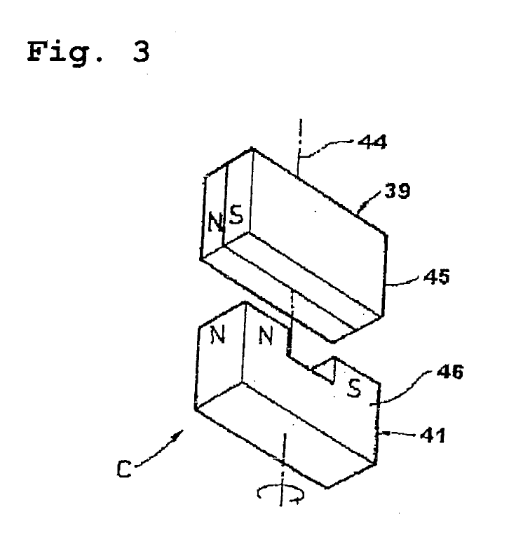

FIG. 3 illustrates the configuration of the magnetic coupling C at the lower end of the stirring tank 35. In the present embodiment of magnetic coupling C, as each of the impellor blades 38 and 39 constituting the magnetic coupling C there is used a double-sided two-pole magnet 45 comprising an N pole plane and an S pole plane disposed in parallel to the central rotary axis 44 with the central rotary axis 44 interposed therebetween as shown in FIG. 3. As the external magnet 41 there is used a double-ended two-pole magnet (U-shaped magnet) 46 comprising an N pole plane and an S pole plane disposed symmetrical about the central rotary axis 44 on a plane crossing the central rotary axis 44. Even when the magnetic coupling C comprises a double-sided two-pole magnet 45 as the external magnet 41 and a double-ended two-pole magnet 46 as the each of the impellor blades 38 and 39 as opposed to the aforementioned configuration, similar effects can be exerted.

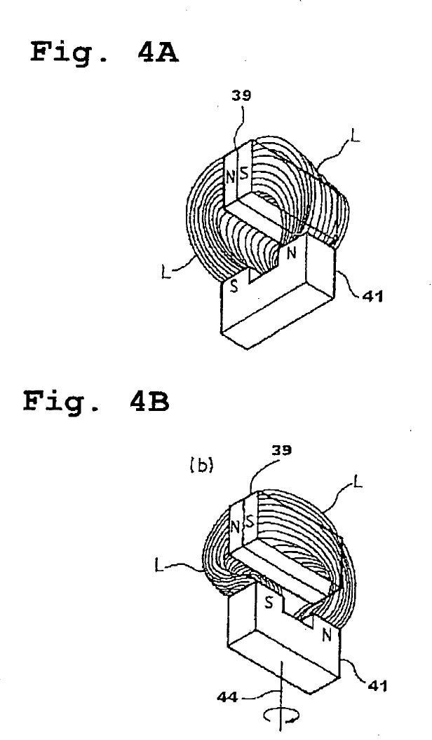

In the aforementioned magnetic coupling C, the magnetic line of force L connecting between the external magnet 41 and the impellor blades 38 and 39 is as shown in FIG. 4A. In this arrangement, the diameter of the magnetic flux connecting the two magnets can be doubled as compared with that of the magnetic flux formed in the case where the magnetic coupling is formed by two double-ended two-pole magnets. At the same time, when the external magnet 41 is rotationally driven, the magnetic flux can be deflected as shown in FIG. 4B to provide the magnetic coupling with viscosity of magnetic flux that prevents the cutting of magnetic flux, making it possible to drastically enhance the coupling strength of the magnetic coupling. The use of a high rotary type motor as motors 42 and 43 makes it possible to rotate the impellor blades 38 and 39 at a high speed.

Referring to stirring in the mixer of the invention, the pair of impellor blades may be rotated in the same opposite directions, preferably in opposite directions. The pair of impellor blades may be rotated at the same or different speeds.

As the mixer of the invention there is preferably used a mixer which comprises a rotary axis piercing the mixer wherein the rotary axis is sealed to raise the capacity of the mixer for the purpose of reducing the retention time. In this arrangement, too, the pair of impellor blades may be rotated in the same or opposite directions, preferably in opposite directions. The pair of impellor blades may be rotationally driven at the same or different speeds.

In the invention, an aqueous solution of protective colloid is charged in the mixer in the following manner.

a. The aqueous solution of dispersant is singly poured into the mixer. The concentration of the aqueous solution of dispersant is 0.5% or more, preferably 1% to 20%. The flow rate of the aqueous solution of dispersant is from 20% to 300%, preferably from 50% to 200% of the sum of the flow rate of the water-soluble silver solution and the aqueous solution of alkali halide.

b. The aqueous solution of dispersant is contained in the aqueous solution of alkali halide. The concentration of the dispersant is 0.4% or more, preferably from 1% to 20%.

c. The dispersant is contained in the water-soluble silver solution. The concentration of the dispersant is 0.4% or more, preferably from 1% to 20%. In the case where gelatin is used as dispersant, silver ion and gelatin are used to form gelatin silver which is then subjected to photo decomposition or thermal decomposition to produce silver colloid. Therefore, the water-soluble silver solution and the gelatin solution are preferably added shortly before use.

The aforementioned methods a to c may be used singly or in combination or may be used at the same time.

(2) Mixer which Gives Linear Jet to Perform Agitation

The mixer of the invention receives the water-soluble silver solution, the aqueous solution of alkali halide and the aqueous solution of dispersant in the form of linear jet and mixes the solutions to prepare silver halide fine grains. The aqueous solution of dispersant may be added to either one of the water-soluble silver solution and the aqueous solution of alkali halide. Alternatively, the three solutions may be separately added.

The flow rate of the aqueous solution to be charged in the mixer in the form of jet is preferably 100 m/sec or more, more preferably 250 m/sec or more, most preferably 500 m/sec (preferably 10⁵ m/sec).

In the mixer of the invention, the diameter of the fine tubes for mixing the solutions is preferably 20 times or less, more preferably 10 times or less, most preferably 7 times or less that of the feed port of linear jet The length of the fine tubes for mixing the solutions is preferably 10 times or more, more preferably 50 times or more, most preferably 100 times or more the diameter of the fine tubes. These fine tubes may have indentations on the inner side thereof. When the solutions thus fed flow through the fine tubes, these indentations make the flow of the solutions small turbulent flows, making the agitation more uniform. In the case where jets having a high flow rate are mixed, the temperature of the mixture rises. Therefore, the mixer is preferably equipped with a cooling device.

In the mixer of the invention, the mixing of the water-soluble silver solution and the aqueous solution of alkali halide is preferably not accompanied by mechanical agitation. If the mixing of the water-soluble silver solution and the aqueous solution of alkali halide is accompanied by mechanical agitation, agitation free from circulation can be difficultly effected. Further, in the case where mixing is effected for a short period of time such that the retention time is as short as 0.1 seconds or less, it is difficult to perform sufficient mixing by mechanical agitation.

In the mixer of the invention, both the water-soluble silver solution and the aqueous solution of alkali halide may be each added in the form of linear jet. Alternatively, one of the two aqueous solutions may be added in the form of linear jet while the other is added by the use of negative pressure generated by the jet of the former.

The agitation method satisfying the requirements of the invention can be accomplished using a high pressure homogenizer (DeBEE2000) produced by BEEINTERNATIONAL INC. The use of the dual feed method using this device allows one of the water-soluble silver solution and the aqueous solution of alkali halide to be ejected at a high speed and the other to be mixed with the former. By applying a high pressure to the aqueous solution to be added in the form of jet, the aqueous solution can be provided with a high kinetic energy that allows the two solutions to be mixed in an extremely short period of time. Further, this method forms no circulation that causes the solution to return to the portion close to the feed port. Moreover, since the liquid thus added has a sufficient kinetic energy, no mechanical agitation is required.

(3). Mixer Utilizing Laminar Flow

The mixer of the invention employs a mixing method utilizing laminar flow. The water-soluble silver solution and the aqueous solution of alkali halide are each formed into a thin lamella. These lamellas are then brought into contact with each other on a wide area to cause ions to be diffused uniformly in a short period of time, making it possible to realize faster mixing more uniformly. The migration of ions by diffusion follows Fick's law correlated to the change of concentration with time given by the following relationship as product of diffusion coefficient and concentration gradient:

t˜dl²/D

wherein D represents diffusion coefficient; dl represents the thickness of lamella; and t represents the mixing time.

As can be seen in the aforementioned relationship, since the mixing time t is proportion to the square of the thickness dl of the lamella, the reduction of the thickness of the lamella makes it possible to reduce the mixing time very effectively.

In the invention, the use of a microreactor produced by IMM (Institute fur Mikrotechnik Mianz) makes it possible to realize expected effects. For the details of microreactor, reference can be made to W. Ehrfeld, V. Hessel and H. Loewe, “Microreator”, chapter 3, 1st ed., WILEY-VCH, 2000. In other words, the principle of the microreactor is based on the multilamination of fluid and the subsequent diffusion and mixing.

The fluid of the water-soluble silver solution and the aqueous solution of alkali halide are each passed through crossing slits having a size on the order of scores of micrometers to form a large number of lamellas that are then brought into contact with each other on a wide area in the direction normal to the forward direction at the outlet of the slits. Silver ions and halide ions immediately begin to be diffused. Mixing by diffusion ends in a short period of time. The ion reaction that occurs concurrently causes the formation of silver halide fine grains.

The thickness of the lamellas in the mixer of the invention is from 1 μm to 500 μm, preferably from 1 μm to 100 μm, more preferably from 1 μm to 50 μm as determined in the direction normal to the forward direction. The mixing time in the invention utilizing laminar flow is less than 0.5 seconds, preferably 100 milliseconds, more preferably 50 milliseconds.

The micromixer which is a mixer of the invention is a device having a channel having an equivalent diameter of 1 mm or less. The term “equivalent diameter” as used herein is also referred to as “corresponding diameter” and is used in the art of mechanical engineering. Supposing a circular tube equivalent to a pipe having an arbitrary sectional shape (channel in the invention), the diameter of the equivalent circular tube is defined as equivalent diameter by d_{eq}=4A/p wherein A represents the sectional area of the pipe and p represents the length of the wetting edge of the pipe (periphery). When this equation is applied to circular tube, the equivalent diameter corresponds to the diameter of the circular tube. The equivalent diameter is used to estimate the fluidity or heat transfer properties of the pipe on the basis of the data of the equivalent circular tube. Thus, the equivalent diameter represents the spatial scale of development (representative length). The equivalent diameter of a square pipe having a side ais represented by d_{eq}=4a^{2/4}a=a. The equivalent diameter of a triangular pipe having a side a is represented by d_{eq}=a. The equivalent diameter of a channel between parallel flat plates having a channel height h is represented by d_{eq}=2h (see “Kikai Kogaku Jiten (Dictionary of Mechanical Engineering)”, compiled by The Japan Society of Mechanical Engineers, 1997, Maruzen).

The channel in the mixer of the invention is prepared by micromachining a solid substrate. Examples of the material to be micromachined include metal, silicon, Teflon, glass, ceramics, and plastic. Preferred examples of the material to be used in the case where heat resistance, pressure resistance and solvent resistance are required include metal, silicon, Teflon, glass, and ceramics. Particularly preferred among these materials is metal. Examples of the metal employable herein include nickel, aluminum, silver, gold, platinum, tantalum, stainless steel, hastelloy (Ni—Fe alloy), and titanium. Preferred among these metals are stainless steel, hastelloy and titanium, which are extremely corrosion-resistant. As the prior art batchwise reaction device there has been heretofore used a device line with glass on the surface of the metal (stainless steel, etc.) for the treatment of acidic material. The microreactor, too, may be coated with glass on the surface of the metal. The material with which the metal is coated is not limited to glass. The metal may be coated with other metals or materials. Alternatively, a material other than metal (e.g., ceramic) may be coated with a metal, glass or the like.

Representative examples of the micromachining technique for preparing the channel in the mixer of the invention include LIGA technique using X-ray lithography, high aspect ratio photolithography using EPON SU-8, microdischarge machining (μ-EDM), silicon high aspect ratio machining by deep RIE, hot embossing, photoimaging, laser machining, ion beam machining, and mechanical microcutting using micromachining tool made of hard material such as diamond. These techniques may be employed singly or in combination. Preferred among these micromachining techniques ate LIGA technique using X-ray lithography, high aspect ratio photolithography using EPON SU-8, microdischarge machining (μ-EDM), and mechanical microcutting.

The assembly of the micromixer which is a mixer of the invention is often accomplished by a bonding technique. Ordinary bonding techniques are roughly divided into two groups, i.e., solid phase bonding and liquid phase bonding. Representative examples of solid phase bonding methods which are normally used include contact bonding and diffusion bonding. Representative examples of liquid phase bonding methods which are normally used include welding, eutectic bonding, soldering, and adhesion. For assembly, a high precision bonding method capable of keeping dimensional precision causing no destruction of microstructure such as channel due to denaturation or drastic deformation of the material by high temperature heating is desirable. Examples of such a technique include direct silicon bonding, anodic bonding, surface activation bonding, direct bonding using hydrogen bond, bonding using aqueous solution of HF, Au—Si eutectic bonding, and void-free adhesion.

The equivalent diameter of the channel to be used in the mixer of the invention is 1 mm or less, preferably from 10 μm to 500 μm, particularly from 20 μm to 300 μm. The length of the channel is not specifically limited but is preferably from 1 mm to 1,000 mm, particularly from 10 mm to 500 mm.

It is not necessarily required that the number of channels to be used in the invention be only one. If necessary, a number of channels maybe arranged in parallel (numbering-up) to raise the processing effect. In the invention, reaction occurs in a flow through the channels.

The channels in the micromixer which is a mixer of the invention may be subjected to surface treatment depending on the purpose. In particular, in the case where an aqueous solution is processed, surface treatment is important because the adsorption of the sample to glass or silicon can cause troubles. The fluid control in the channels having a microsize is preferably accomplished without incorporating any mobile parts requiring complicated preparation process. For example, fluid control can be accomplished by making the use of difference in surface tension developed on the interface of a hydrophilic region and a hydrophobic region formed in the channels by surface treatment.

In order to feed a reagent or sample into the micromixer which is a mixer of the invention through the microsized channels, a function of controlling fluid is needed. In particular, the behavior of a fluid in a microregion is different from that in microscale. Therefore, a controlling method suitable for microscale must be considered. Fluid controlling modes can be divided into two groups, i.e., continuous flowing mode and liquid dropping mode (liquid plug). Driving modes can be divided into two groups, i.e., electrical driving mode and pressure driving mode. These modes will be further described hereinafter. The most widely used fluid controlling mode is, continuous flowing mode. In accordance with the continuous flowing mode fluid control, the channels in the microreactor are all filled with a fluid. The entire channels are driven by a pressure source such as external syringe pump. This mode is partly advantageous in that the control system is realized by a comparatively simple set up. However, this mode is disadvantageous in that operation accompanying the reaction at a plurality of steps or replacement of samples can be difficultly effected, the degree of freedom of system configuration is small and the driving medium is the solution itself, raising the dead volume. A mode different from the continuous flowing mode is liquid dropping mode (liquid plug). In this mode, liquid droplets partitioned by air are moved in the reactor or the channels to the reactor. The individual liquid droplets are driven by pneumatic pressure. In this arrangement, it is necessary that a vent structure capable of releasing air between the liquid droplet and the wall of the channel or between the liquid droplets to the exterior as necessary and a valve structure for keeping the pressure in the branched channels independent from each other be provided inside the reactor system. In order to control the pressure difference and hence the liquid droplets, it is necessary that a pressure control system composed of pressure source and switching valve be built outside the system. Thus, the liquid dropping mode requires somewhat complicated system configuration and reactor structure. However, multistage operation can be made such as individual operation of a plurality of droplets for sequential occurrence of a number of reactions. As a result, the degree of freedom of system configuration can be raised.

As driving modes for controlling fluid there are widely used an electrical driving mode which comprises applying a high voltage across the ends of the channel to generate an electric osmosis flow in which the fluid moves and a pressure driving mode which comprises applying pressure from an externally provided pressure source to a fluid to move the fluid. The difference in fluid behavior between the two driving modes is that the flow rate profile in the section of channel shows a flat distribution in the case of electrical driving mode while the flow rate profile in the section of channel shows a hyperbolic distribution indicating that the fluid flows fast at the center of the channel and slowly along the inner wall of the channel in the case of pressure driving mode. Thus, the electrical driving mode is suitable for the purpose of moving the fluid while being kept in the form of sample plug or the like. In the case where the electrical driving mode is performed, it is necessary that the channels be filled with a fluid. Therefore, the continuous flowing mode must be employed. However, fluid control can be conducted by electrical control. Therefore, a comparatively complicated processing which comprises continuously changing the mixing ratio of two solutions to make a concentration gradient with time has been realized. In the case of pressure driving mode, the fluid can be controlled regardless of the electrical properties thereof. Further, secondary effects such as heat generation and electrolysis may not be taken into account. Thus, the pressure driving mode has little effect on the substrate and can be widely used. On the other hand, the pressure driving mode is disadvantageous in that a pressure source must be provided outside the system and the response of operation changes with the magnitude of the dead volume of the pressure system, requiring the automation of complicated procedure.

As a method to be used as fluid controlling method there may be properly selected depending on the purpose. Preferably, the continuous flow mode pressure driving system is employed.

The temperature control of the micromixer which is a mixer of the invention may be accomplished by putting the entire device in a temperature-controlled vessel. Alternatively, a thermal cycle may be formed by heating process by a heater structure such as metallic resistance wire or polysilicon mounted in the device and cooling involving spontaneous cooling. The temperature sensing may be accomplished by detecting the temperature on the basis of the change of resistivity of another metallic resistance wire mounted in the device, which is the same as the heater. In the case where a polysilicon is mounted, a thermocouple is used to detect temperature. Alternatively, a peltiert element may be brought into contact with the reactor to externally heat or cool the mixer. The method to be used may be selected depending on the purpose or the material of the reactor.

Preferred among the aforementioned three kinds of mixers are (1) mixer arranged such that stirring is effected using two or more rotary axes provided in a closed stirring tank and (2) mixer which gives linear jet to perform agitation, more preferably (1) mixer arranged such that stirring is effected using two or more rotary axes provided in a closed stirring tank.

As the device comprising a ripening unit for continuously preparing the silver halide fine grains A there is preferably used the following device.

This fine grain preparation device comprises a mixer for preparation of unripened silver halide fine grains 8 and a ripening unit connected thereto. The fine grain preparation device may further comprise a feed pipe connecting between the mixer and the ripening unit that cannot perform controlled ripening, a solution feed unit for changing conditions such as pH and potential, a feed unit for adding other silver halide fine grain emulsions or a separate mixer for preparing another silver halide fine grain emulsion depending on the purpose. The feed unit and separate mixer are connected to the aforementioned unripened fine grain preparation mixers ripening unit and feed pipe depending on the purpose. The fine grain preparation device may comprise each one of the various components such as unripened fine grain preparation mixer, ripening unit and feed pipe or may comprise a plurality of units having the same function. This device is formed by a structure substantially free of retention zone. This device is formed by either or both of a cylindrical structure free of retention zone and a retention zone having a retention time t of 1 minute or less, preferably 30 seconds or less, more preferably 1 second or less as calculated by the aforementioned equation (1).

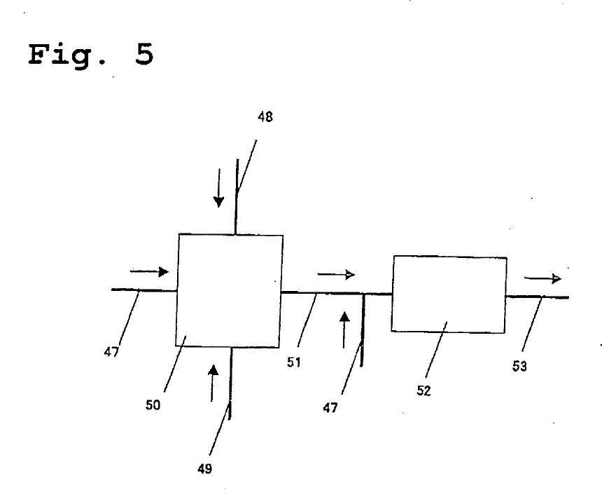

The mixer for preparation of unripened silver halide fine grains B is not specifically limited so far as small size silver halide fine grains B can be continuously prepared by charging a water-soluble silver solution and/or an aqueous solution of alkali halide and optionally an aqueous solution of dispersant into the mixer. However, the aforementioned three kinds of mixers are preferably used. In particular, (1) mixer arranged such that stirring is effected using two or more rotary axes provided in a closed stirring tank is more preferably used. The preferred structure and working mode of the mixer is the same as in the aforementioned case where the mixer is singly used itself. However, the present device is arranged such that the ripening unit is connected to the fine grain emulsion discharge port (for example, 34 in FIG. 2) of the mixer for preparation of unripened silver halide fine grains B. Therefore, in the case where the viscosity of the solution used is high or like cases, pressure loss due to the ripening unit and the liquid feed pipe occurs, occasionally causing insufficient mixing in the mode of single use of the mixer. In this case, when the mixer is singly used, the rise of the equivalent circle diameter of the fine grains B thus prepared, the coefficient of variation in equivalent circle diameter and the percent twinning and the clogging of the mixer with the agglomerated fine grain emulsion can occur. Therefore, in the case where the mixer is used as part of the device of the invention as shown in FIG. 5, the agitation force of the mixer is preferably raised by increasing the rotary speed of the impellor blades or otherwise.

The mixer for preparation of unripened silver halide fine grains B and the ripening unit may be connected to each other via a liquid feed pipe that cannot perform controlled ripening. The term “cannot perform controlled ripening” as used herein is meant to indicate that the pipe is not capable of controlling the temperature of the solution introduced into the pipe and/or changing the retention time in the liquid feed pipe depending on the flow rate of the solution introduced thereinto. The inner diameter of the liquid feed pipe needs to be small enough to cause no retention in the pipe and the capacity of the liquid feed pipe is preferably as small as possible. Preferably, the retention time t′ represented by the following equation (2) is 5 minutes or less, more preferably 2 minutes or less, even more preferably 1 minute or less.

$${t}^{′} = V / {\sum }_{i} {a}_{i} \qquad ( 2 )$$

wherein t′ represents the retention time; V represents the volume of the liquid feed pipe; and a₁ represents the adding amount of the fine grain emulsion or solution introduced into the liquid feed pipe.

The liquid feed pipe preferably has a small inner diameter and a short length to reduce its capacity. However, in the case where the viscosity of the solution used is high, when the inner diameter of the liquid feed pipe is too small, the resulting pressure loss rises, occasionally impeding the feed of the liquid or causing the drop of the mixing efficiency of the mixer 47. The inner diameter of the liquid feed pipe needs to be great enough to cause no extreme rise of pressure loss depending on the flow rate, viscosity and other conditions of the liquid introduced but small enough to cause no retention.

The ripening unit for controlling the size of the fine grains and performing ripening that provides sufficient monodispersibility is not specifically limited so far as it has no retention zone, controls the temperature of the fine grain emulsion introduced, retains the temperature-controlled solution in the device for a predetermined period of time and performs continuous process starting with the introduction of unripened fine grain emulsion into the ripening unit and ending with the discharge of ripened fine grain emulsion. In practice, however, the following unit is preferably used in particular as explained hereinafter.

The ripening unit comprises a liquid feed pipe with temperature control capable of controlling the temperature of the inner solution and a tubular structure capable of rapidly changing the temperature of the inner solution as necessary. The inner diameter of these components need to be small enough to cause no retention but great enough to cause no aforementioned troubles. In the case where the temperature of the solution introduced into the ripening unit drastically deviates from the ripening temperature and needs to be immediately changed to the predetermined ripening temp or the liquid feed pipe with temperature control has a temperature controlling capacity of merely retaining a predetermined temperature, the change to the ripening temperature is made by the tubular structure. The inner capacity of the ripening unit is predetermined such that the retention time t″ represented by the following equation (3) reaches the predetermined ripening time.

$${t}^{″} = V / {\sum }_{i} {a}_{i} \qquad ( 3 )$$

wherein t″ represents the retention time; V represents the inner capacity of the ripening unit; and aᵢ represents the adding amount of the fine grain emulsion or solution introduced into the ripening unit.

An embodiment of the ripening unit will be described hereinafter. The present embodiment of the ripening unit is formed by a heat exchanger stationed in a constant temperature tank and a stationed liquid feed pipe for continuous ripening. The heat exchanger comprises liquid feed pipes having a small inner diameter made of a material having a high heat transfer coefficient dipped in a constant temperature tank and is capable of controlling the transfer of heat of the emulsion passing through the liquid feed pipes at a high efficiency in a short period of time. Further, the liquid feed pipes of the heat exchanger are dipped in constant temperature water which is being circulated efficiently by impellor blades or the like, making it possible to always raise the temperature of the fine grain emulsion passing through the liquid feed pipes to a predetermined value. The use of this heat exchanger makes it assured that the temperature of the fine grains nucleated in the mixer can be raised to a value required for ripening and growth in a short period of time. The term “short time” as used herein is meant to indicate 1 minute or less, preferably 30 seconds or less, more preferably 10 seconds or less. The liquid feed pipe for continuous ripening is adapted to ripen the fine grain emulsion which has been controlled to the predetermined temperature by the heat exchanger at the same temperature for a predetermined period of time. The liquid feed pipe, too, is stationed in the constant temperature tank kept at a predetermined temperature. This constant temperature tank may be used in common with or separately of the heat exchanger. The time between the introduction of the fine grains into the liquid feed pipe and the discharge of the grains from the liquid feed pipe is defined as ripening time. The ripening time depends on the flow rate of the fine grain emulsion and the inner diameter and length of the liquid feed pipe. When the ripening time is too short, the emulsion is left insufficiently monodispered, leaving some small size fine grains behind. On the contrary, when the ripening time is too long, anisotropy in growth of twin appears. Accordingly, the inner diameter and length of the liquid feed pipe needs to be properly adjusted depending on the flow rate and size of the fine grains passing through therethrough. It is further necessary that no retention occur in the liquid feed pipe. When the inner diameter of the liquid feed pipe is too great, some retention zone can occur in the liquid feed pipe. Therefore, the inner diameter of the liquid feed pipe needs to be properly small. The sectional shape of the liquid feed pipe may be any of circle, ellipsoid, rectangle and shapes obtained by flattening these shapes so far as ripening and feed of liquid can be properly conducted. The number of the liquid feed pipes to be provided is not limited to one. The liquid feed pipe may be branched.

The process for the preparation of the emulsion of silver halide tabular grains of the invention will be described hereinafter. The term “silver halide tabular grain” as used herein is meant to indicate a silver halide grain hating two opposing parallel main planes (111) or (100). The tabular grain described in the invention has one twinning planes or two or more parallel twinning planes or a helical dislocation. The term “twinning plane” as used herein is meant to indicate a (111) plane on both sides of which ions on all lattice points are mirror images of each other. The term“helical dislocation” as used herein is meant to indicate a dislocation line around which a helical periodicity occurs with ions on the lattice points. This tabular grain looks triangular, rectangular or hexagonal or has a circular form developed by rounding these forms as viewed in the direction perpendicular to the main plane.

The emulsion of silver halide tabular grains of the invention, if they are silver halide grains having two opposing parallel main planes (111), preferably comprises hexagonal tabular grains 70% or more of which as calculated in terms of projected area have a maximum side length to minimum side length ratio of from 1 to 2, more preferably hexagonal tabular grains 90% or more of which as calculated in terms of projected area have a maximum side length to minimum side length ratio of from 1 to 2, even more preferably tabular grains 90% or more of which as calculated in terms of projected area have a maximum side length to minimum side length ratio of from 1 to 1.5. In the case where the main plane of the tabular grain is in the form of rounded triangle or hexagon, the length of the side of the main plane is defined to be the length of the side of the imaginary triangle or hexagon formed by extending the sides of the rounded triangle or hexagon.

The emulsion of tabular grains of the invention is preferably monodisperse. The coefficient of variation in equivalent circle diameter of all the silver halide grains on projected area is preferably 40% or less, particularly 25% or less. The term “coefficient of variation in equivalent circle diameter” is meant to indicate the value obtained by dividing the standard deviation of distribution of equivalent circle diameter of individual silver halide grains by the average equivalent circle diameter of the silver halide grains.

For the determination of the equivalent circle diameter of tabular grain, the tabular grains are photographed, e.g., by a replica-process transmission electron microscope. The diameter of the circle having the same area as the projected area of the individual grains (equivalent circle diameter) is then determined. In the case where epitaxial deposition makes it impossible to simply calculate the thickness of the grain from the length of the shadow of the replica, calculation may be made from the measurements of the length of the shadow of the replica before epitaxial deposition. Alternatively, the thickness of the grain can be easily determined by photographing the section of the epitaxially coated tabular grain under an electron microscope.

In the invention, supposing that the average silver chloride content in the total silver halide tabular grains is CL mol %, 70% or more of the total silver halide tabular grains as calculated in terms of projected area preferably have a silver chloride content of from 0.7CL to 2.3CL, particularly from 0.8CL to 1.2CL. More preferably, supposing that the average silver iodide content in the total silver halide tabular grains is 1 mol %, 70% or more of the total silver halide tabular grains as calculated in terms of projected area preferably have a silver iodide content of from 0.7I to 1.3I, particularly from 0.8I to 1.2I. In general, the measurement of the silver chloride and silver iodide contents in the various grains can be effectively accomplished by EPMA (Electron Probe Micro Analyzer) method. A sample which has been subjected to dispersion such that the emulsion grains do not come in contact with each other is prepared. The sample thus prepared is then irradiated with electron rays to emit X rays which are then analyzed to make elementary analysis of extremely small region. During this measurement, the sample is preferably cooled to a low temperature to prevent itself from being damaged by electron rays.

The effect of the invention can be remarkably exerted under conditions such that the solutes are supplied into the silver halide tabular grains of the invention at a high rate or under conditions such that the silver halide tabular grains of the invention reach lower supersaturation. In other words, the effect of the invention can be remarkably exerted with tabular grains having a great equivalent circle diameter, a small thickness and a (111) plane as a main plane. The silver halide grains of the invention preferably have a number-average equivalent circle diameter of 1.0 μm or more, more preferably 3.0 μm or more, even more preferably 5.0 μm or more (preferably 20 μm or less). The silver halide grains of the invention preferably have a number-average thickness of 0.2 μm or less, more preferably 0.1 μm or less (preferably 0.001 μm or more).

The halogen formulation of the silver halide tabular grains of the invention may be any of silver chloride, silver chloroiodide, silver bromoiodide, silver bromide, silver bromochloride and silver bromochloroiodide. The silver halide tabular grains of the invention are preferably silver bromochloroiodide tabular grains having an epitaxial protrusion, more preferably silver bromochloroiodide tabular grains having CL of less than 50% and an epitaxial protrusion.

The method for the grow of silver halide fine grains to tabular grains of the invention will be described hereinafter. When silver halide fine grains are added to silver halide tabular grains in a reaction vessel to allow the two components to undergo Oswald ripening that causes the growth of the tabular grains, the resulting emulsion reaches lower supersaturation than the emulsion obtained by the direct introduction of an aqueous solution of silver salt and an aqueous solution of halide into the reaction vessel involving the growth of tabular grains and thus attains raised anisotropy in growth of tabular grains that makes it possible to allow the growth of tabular grains having a higher aspect ratio. The greater the equivalent circle diameter of the fine grains used in the growth of tabular grains is, the lower is the equilibrium solubility thereof. As a result, the emulsion system reaches decreased supersaturation, making it possible to prepare tabular grains having a higher aspect ratio. However, fine grains having too great an equivalent circle diameter for thickness cannot be dissolved due to Ostwald ripening and thus remain undissolved in the system. Further, when the rate at which silver is added is high, large fine grains can be left undissolved in the system more easily than when the rate is low. Therefore, in order to effectively reduce the thickness of tabular grains and prevent the occurrence of residual grains in the system, it is necessary that a monodisperse emulsion of silver halide fine grains having a size controlled for a proper distribution of fine grain size be prepared. In order to prepare tabular grains having an extremely small thickness, it is essential to control the size of fine grains such that the resulting emulsion of silver halide grains is monodisperse within an extremely limited range because fine grains having a remarkably small equivalent circle diameter for thickness are subject to undesirable increase of thickness of tabular grain and fine grains having a great equivalent circle diameter for thickness can remain in the system very easily.

A monodisperse emulsion of silver halide fine grains having a size controlled to an extremely small range desirable for the growth of fine grains can be fairly prepared by the aforementioned process for the preparation of silver halide fine grains of the invention at a high efficiency.

The silver halide fine grains to be used in the growth of tabular grains are prepared by the process for the preparation of emulsion of silver halide fine grains of the invention using a device provided outside the reaction vessel for the growth of tabular grains in such a manner that a desirable grain shape and a desirable concentration can be attained. It is necessary that the silver halide fine grains which have been prepared so as to have a size distribution desirable for the preparation of tabular grains have a reproducibly good and constant form to control the shape of the resulting tabular grains and stabilize the producibility of the tabular grains. To this end, it is desired that the silver halide fine grains be continuously prepared using the aforementioned device substantially free of residence portion and the silver halide fine grains A which have thus been prepared for the growth of tabular grains be charged into the reaction vessel immediately after preparation. The term “immediately after preparation” as used herein is meant to indicate “in 10 minutes, preferably in 3 minutes, more preferably in 1 minute after the preparation of the silver halide fine grains”.

The fine grains to be used in the growth of tabular grains preferably have a number-average equivalent circle diameter falling within a proper range, preferably from 15 nm to 50 nm, more preferably from 20 nm to 40 nm, to inhibit the increase of the thickness of tablet and prevent the occurrence of residual grains.

When the proportion of twin grains in the fine grains to be used in the growth of tabular grains by number is too great, the twin grains grow in the reaction vessel, causing the remaining of tabular grains and multiple twin grains having a shape different from the desired shape derived from the twin fine grains. Therefore, it is desirable that the proportion of twin grains in the fine grains to be used in the growth of tabular grains by number be small. The proportion of twin grains by number is preferably 15% or less, more preferably 10% or less, even more preferably 5% or less, most preferably 1% or less. For the determination of twin grains in the silver halide fine grains by number, the emulsion of fine grains is allowed to grow at a temperature of 40° C. or less, preferably 35° C. or less (preferably 0° C. or more) to an extent such that a definite grain form is developed without causing further nuclei under high supersaturation conditions. The resulting grains are then photographed under a replica process transmission electron microscope. The resulting photographic image was then observed. For the details of this measurement method, reference can be made to JP-A-2-146033. (the term “JP-A” as used herein means an “unexamined published Japanese patent application”)

Ultrafiltration to be used in the invention will be further described hereinafter. Dehydration and desalting techniques by ultrafiltration of the invention are described in Research Disclosure, Vol. 102, paragraph 10298, Vol.131, paragraph 13122. These techniques are also described in U.S. Pat. Nos. 4,334,012, 5,164,092 and 5,242,597, EP795455, EP843206, JP-A-8-278580 and JF-A-11-231449.

The membrane module comprising a membrane for use in the ultrafiltration membrane of the invention incorporated in a vessel there may be in the form of tubular module, hollow yarn module, pleated module, spiral module, flat membrane module or plate-flame module. Preferred among these module forms are hollow yarn module and flat membrane module.

The ultrafiltration membrane of the invention may be made of various materials. Examples of main materials which can be preferably used to constitute the ultrafiltration membrane include polyacrylonitrile, polysulfone, polyimide, polyethersulfone, cellulose acetate, polyvinyl chloride, polyvinyl acetate, polyvinyl alcohol, and ceramic such as aluminum oxide.

One of the properties of the ultrafiltration membrane of the invention is molecular-weight cut-off. The molecular-weight cut-off is the molecular weight which gives a percent inhibition (percentage obtained by dividing the difference in concentration between the liquid supplied and the liquid passed by the concentration of the liquid supplied) of 90% or more. The ultrafiltration membrane of the invention preferably has a molecular-weight cut-off which disallows the passage of silver halide grains but allows the passage of unnecessary salts and dispersed materials. When the molecular-weight cut-off of the ultrafiltration membrane is reduced, the amount of liquid passed through the ultrafiltration membrane is reduced. Thus, the molecular-weight cut-off of the ultrafiltration membrane needs to be optimally predetermined. The useful molecular-weight cut-off of the ultrafiltration membrane is from 1,000 to 1,000,000, preferably from 3,000 to 100,000.

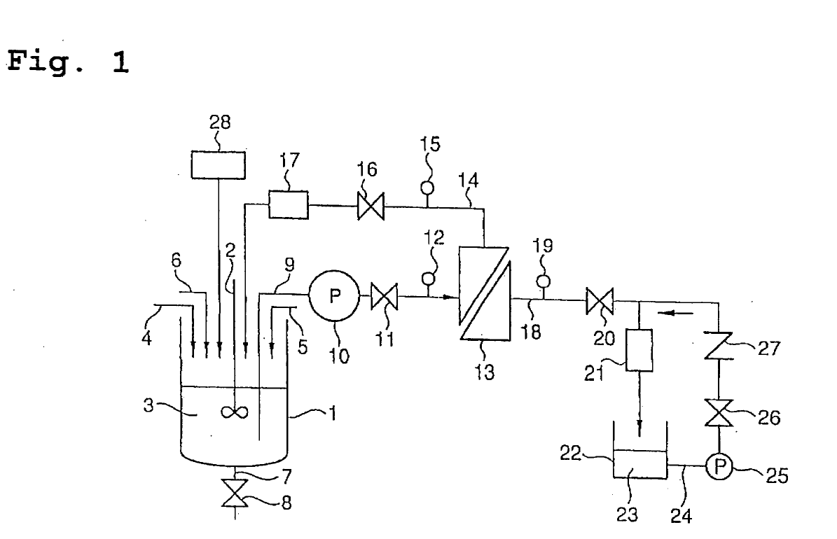

A conceptional diagram illustrating an example of dehydration/desalting of silver halide emulsion using the ultrafiltration process of the invention is shown in FIG. 1. In FIG. 1, the reaction solution containing silver halide grains in a reaction vessel 1 is stirred by an agitator 2, and then fed to an ultrafiltration membrane 13 through a liquid feed pipe 9, a pump 10 and a feed valve 11. The reaction solution containing silver halide grains is then passed through the ultrafiltration membrane so that water and part of salts are discharged through a liquid passage pipe 18, a passage valve 20 and a passage flow meter 21. At this point, a check valve 27 is closed. The remaining reaction solution containing silver halide grains is passed through a liquid reflux pipe 14, a reflux valve 16 and a reflux flow meter 17, and then returned to the reaction vessel 1. Pressure gauges 12 and 15 are provided before the ultrafiltration membrane. A pressure gauge 19 is provided after the ultrafiltration membrane. In order to return the silver halide grains left in the ultrafiltration membrane to the reaction vessel, part of the liquid passed may be fed back to the ultrafiltration module through a reverse washing pipe 24, a reverse washing pump 25, a reverse washing valve 26, the check vale 27, the passage valve 20 and the liquid passage pipe 18 after the termination of ultrafiltration so that the silver halide grains adsorbed to the ultrafiltration membrane can be returned to the reaction vessel through the liquid flux pipe 14, the reflux valve 16 and the reflux flow meter 17. As the aqueous solution for reverse washing there may be used water, an aqueous solution obtained by diluting the liquid passed with water or an aqueous solution having an adjusted pBr value instead of the liquid passed.

The amount of the liquid passed and fed back through the ultrafiltration membrane can be properly controlled by adjusting the reflux valve and the passage valve. In order to raise the flow rate of the liquid, the flow rate through the pump may be raised. At the same time, the reflux valve may be throttled to raise the reflux flow rate, raising the feed pressure. In order to raise the passed amount of liquid, it is preferred that two or more ultrafiltration modules be connected to each other in parallel or in series to raise the area of the membrane.

In order to effect the ultrafiltration process of the invention, gelatin is preferably used as the dispersant to be charged in the reaction vessel. The molecular weight of the gelatin to be directly charged in the reaction vessel is not limited. The higher the gelatin concentration is, the higher is the gelatin viscosity and the lower is the amount of the liquid passed through the ultrafiltration membrane. Thus, the gelatin concentration needs to be controlled.

As the gelatin to be used in the mixer there may be used a low molecular gelatin which can pass through the ultrafiltration membrane. Such a gelatin can pass through the ultrafiltration membrane, making it possible to prevent the rise of the concentration of the gelatin in the reaction vessel. The gelatin to be used in the mixer may be enzymatically decomposed or otherwise processed to have a reduced molecular weight and hence a reduced viscosity. The gelatin thus processed preferably has an average molecular weight of from 5,000 to 30,000. The effect of the gelatin on the thickness of the tabular grain can be changed in various ways by chemical modification of the gelatin. In order to obtain silver halide thin tabular grains, oxidation, succination or trimellitation may be preferably effected.

It is also preferred that ultrafiltration of the invention be effected in the stage prior to the growth by fine grains. The formation of tabular grains involves a step of raising the temperature of the reactive vessel to ripen the reaction solution after the preparation of grains which will become nuclei. When this step is effected, tabular grains which will grow to fine grains can be formed. In the invention, ultrafiltration during this ripening step is effected to cause dehydration and desalting. This step is advantageous in that the production of emulsion is scaled up. Taking the scaling-up of the production of emulsion into account, when the concentration of the water-soluble silver solution and the aqueous solution of alkali halide is merely raised during nucleation, the nuclei thus produced are agglomerated, deteriorating the distribution of grain size. When the production of the emulsion at an optimum concentration of the solution of water-soluble silver and the aqueous solution of alkali halide is followed by ultrafiltration involving dehydration and desalting, a large amount of nuclei can be formed without deteriorating the distribution of grain size.

In the invention, ultrafiltration may be effected in all steps, including the aforementioned steps, but is preferably effected during the addition of silver halide fine grains. The ultrafiltration during the addition of silver halide fine grains means that ultrafiltration is effected at the same time with the addition of silver halide fine grains. In this case, ultrafiltration may be effected throughout the whole or part of duration of addition of silver halide fine grains. Ultrafiltration may be batchwise effected intermittently.

The emulsion prepared according to the preparation process preferably comprises tabular grains 50% or more, more preferably 90% or more of which have an epitaxial junction on at least one of six top portions of hexagon as calculated in terms of projected area. The term “top portion” as used herein is meant to indicate the fan shape formed by one top as center and two sides constituting the top as viewed perpendicularly to the main plane of the tabular grain wherein the radius of the fan shape is one third of the shorter one of the two sides. In the case where the main plane of the tabular grain is a rounded triangle or hexagon, the tops and sides of the main plane are those of the imaginary triangle or hexagon formed by extending these sides. In general, besides the aforementioned epitaxial junction, an epitaxial junction is formed on sides other than the main plane or tops of the tabular grain. The judgment of preferred epitaxial emulsion of the invention can be accomplished as follows. In some detail, 100 or more grains are arbitrarily extracted from a replica process-transmission electron microscope of tabular grain. These grains are then classified into three groups, i.e., grains having an epitaxial junction on one or more top portions, grains having an epitaxial junction only on the sides and main plane and grains having no epitaxial junction. An emulsion comprising grains having an epitaxial junction on one or more top portions in a proportion of 50% or more, preferably 90% or more of the total projected area corresponds to preferred epitaxial emulsion of the invention.

The epitaxial portion is made of silver chloride, silver bromochloride or silver bromochloroiodide. The epitaxial portion preferably has a silver chloride content of 1 mol % higher, more preferably 10 mol % higher than that of the host tabular grain. However, the epitaxial portion preferably has a silver chloride content of 50 mol % or less. The epitaxial portion preferably has a silver bromide content of 30 mol % or more, particularly 50 mol % or more. The epitaxial portion preferably has a silver bromide content of from 1 mol % to 20 mol %. The epitaxial portion preferably has a silver content of from 1 mol % to 10 mol %, more preferably from 2 mol % to 7 mol % of that of the host tabular grain.

The emulsion prepared according to the invention preferably comprises tabular grains having at least one dislocation line on the epitaxial portion in a proportion of 70% or more, more preferably 80% or more of the total projected area of grains. The emulsion of the invention comprises tabular grains having at least one networked dislocation line on the epitaxial portion in a proportion of 70% or more, more preferably 80% or more of the total projected area of grains. The term “networked dislocation line” as used herein is meant to indicate a dislocation line having a plurality of innumerable dislocation lines crossing each other. The tabular grain having an epitaxial junction on two or more top portions does not necessarily need to have a dislocation line on each of the epitaxial portions. Any tabular grain having one, preferably networked, dislocation line on at least one epitaxial portion connected to top portion corresponds to preferred epitaxial emulsion of the invention. Preferably, 70% of the epitaxial portions on top portion have networked dislocation lines. In the invention, it is preferred that the tabular grains have no dislocation line on the portion other than epitaxial portion in a proportion of 70% or more of the total projected area. The dislocation line provides preferential sites for epitaxial deposition and thus inhibits the formation of the epitaxial tabular grain of the invention. Preferably, the tabular grains of the invention have no dislocation line in a proportion of 70% or more of the total projected area. In this case, the epitaxially deposited sites are excluded. Most preferably, the tabular grains of the invention have no dislocation line in a proportion of 90% or more of the total projected area. The dislocation line on the tabular grain can be observed by a direct method using a transmission electron microscope at low temperature as described in J. F. Hamilton, “Phot. Sci. Eng., 11, 57, (1967) and T. Shiozawa, “J. Soc. Phot. Sci. Japan”, 35, 213, (1972) In some detail, silver halide grains are withdrawn from the emulsion so carefully that no pressure is applied to an extent such that dislocation lines are formed on the grains. The silver halide grains thus withdrawn are put on the mesh for observation under electron microscope. The silver halide grains are then observed by a transmission process while being cooled such that any damage by electron rays (e.g., print out) can be prevented. The greater the thickness of the grain is, the more difficultly can be transmitted electron rays by the grain. Therefore, a high voltage type electron microscope (200 kV or more per 0.25 μm of thickness of grain) is preferably used to allow sharper observation. From the photograph of the grains thus obtained can be determined the position and number of dislocation lines on the various grains as viewed perpendicularly to the main plane The emulsion of the invention preferably comprises tabular grains having an epitaxial junction which is not formed in a terrace-like arrangement on the main plane of the top portion of the host tabular grain but protrudes from the top of the host tabular grain towards the side of the host tabular grain in a proportion of 70% or more, more preferably 80% or more of the total projected area. The distinction between the tabular grain having an epitaxial junction which protrudes from the top of the main plane towards the side of the host tabular grain and the tabular grain having an epitaxial junction which is formed in a terrace-like arrangement on the main plane of the top portion of the host tabular grain is carried out as follows. In some detail, 100 or more grains are extracted from a replica process electron microphotograph of tabular grains. A grain having a portion which protrudes towards the side but does not overlap the top portion in a proportion of 60% or more of the total projected area of the epitaxial portion is defined as tabular grain having an epitaxial junction which protrudes towards the side of the host tabular grain. The dislocation line disappears due to the rearrangement of epitaxial deposition unless the emulsion which has undergone epitaxial deposition is controlled to keep this shape.

The preferred emulsion of epitaxial tabular grains of the invention satisfying the aforementioned requirements can have a reduced pBr value. The term “pBr” as used herein is meant to indicate the logarithm of the reciprocal of the bromine ion concentration. Since the pBr value of the emulsion of the invention can be lowered to 3.5 or less, the preservability of the emulsion of the invention can be remarkably improved. The process for the preparation of the aforementioned preferred epitaxial emulsion of the invention will be described in detail with reference to the preparation of host tabular grain and the preparation of epitaxial portion. Firstly, the host tabular grain necessary for the preparation of the epitaxial emulsion of the invention will be described in detail. Referring to the distribution of silver iodide in the host tabular grain of the invention, the host tabular grain of the invention is preferably a multiple structure grain having a double or higher structure. The term “structure concerning the distribution of silver iodide” as used herein is meant to indicate that there is a silver iodide content difference of 0.5 mol % or more, preferably 1 mol % or more between structures. The term “outermost layer in host tabular grain” as used herein is meant to indicate the lamellar phase disposed most outside the multiple structure concerning the distribution of silver iodide.

The structure concerning the distribution of silver iodide can be essentially determined by calculating from the formulation at the process for the preparation of grain. It is likely that the silver iodide content on the interface of structures can change suddenly or slowly. In order to confirm the manner of change, it is necessary that the measurement precision in analysis be considered. The aforementioned EPMA method is useful. The use of this method makes it possible to analyze the distribution of silver iodide in the grain as viewed perpendicularly to the main plane of tabular grain. When a sample obtained by solidifying the aforementioned sample and cutting the sample thus solidified into an ultrathin specimen using a microtome is used, the distribution of silver iodide in the section of tabular grain can be analyzed as well.

In the invention, the host tabular grain preferably has an outermost layer silver iodide content of 10 mol % or more. The amount of the outermost layer is preferably 20% or less, more preferably from 5% to 20% based on the total amount of silver. The silver iodide content of the outermost layer is from 15 mol % to 30 mol %. The term “proportion of outermost layer” as used herein is meant to indicate the ratio of the amount of silver used to prepare the outermost layer to the amount of silver used to obtain the final grain at the step of preparing the host tabular grain. The term “silver iodide content” as used herein is meant to indicate the percent molar ratio of the amount of silver iodide used to prepare the outermost layer to the amount of silver used to prepare the outermost layer. The distribution of silver iodide in the outermost layer may be uniform or ununiform. In the case where the distribution of silver iodide in the outermost layer is ununiform, the amount of silver iodide is defined by the average value of the amount of silver iodide in the outermost layer. More preferably, the proportion of the outermost layer is from 10% to 15% based on the total amount of silver and the silver iodide content of the outermost layer is from 15 mol % to 25 mol %.

In the invention, it is particularly preferred that 75% or less of all the sides connecting the opposing main planes (111) of the host tabular grain be formed by (111) planes.

The term “75% or less of all the sides is formed by (111) planes” as used herein is meant to indicate that there are present crystallographic planes other than (111) plane in a proportion of higher than 25% of all the sides. These planes are normally interpreted as (100) planes but may include other planes, i.e., (110) plane or planes with a higher index. In the invention, when 70% or less of all the sides is formed by (111) planes, the desired effect can be remarkably exerted.

Whether or not 75% or less of all the sides is formed by (111) planes can be easily judged by the shadowed carbon replica process electron microphotograph of the tabular grain. In general, when 75% or more of all the sides is formed by (111) planes, the six sides connecting directly to (111) planes in a hexagonal tabular grain are connected to (111) main planes alternately at an acute angle and at an obtuse angle. On the contrary, when 75% or less of all the sides is formed by (111) planes, the six sides connecting directly to (111) main planes in a hexagonal tabular grain are all connected to (111) main planes at an obtuse angle. By shadowing the sample at an angle of 50° or less, it can be judged to see which the side is connected to the main plane at an obtuse angle or at an acute angle. The sample is preferably shadowed at an angle of from 10° to 30°, making it easy to judge which the side is connected to the main plane at an obtuse angle or at an acute angle.

Further, as the method for determining the ratio of (111) planes to (100) planes there is effectively used a method involving the use of adsorption of sensitizing dye. By using the method described in “Journal of The Chemical Society of Japan”, 1984, Vol. 6, pp. 942-947, the ratio of (111) planes to (100) planes can be quantitatively determined. From the aforementioned ratio and the previously described equivalent circle diameter of tabular grain and thickness of tabular grain can be calculated the proportion of (111) planes in all the sides. In this calculation, the supposition is made by the aforementioned equivalent circle diameter and thickness that the tabular grain is a column. This supposition makes it possible to determine the proportion of the sides in the total surface area. The value obtained by dividing the proportion of (100) planes determined by the aforementioned sensitizing dye adsorption method by the aforementioned proportion of sides and multiplying the quotient by 100 is the proportion of (100) planes in all the sides. The subtraction of this value from 100 gives the proportion of (111) planes in all the sides. In the invention, the proportion of (111) planes in all the sides is more preferably 65% or less.

The method for making 75% or less of all the sides of a host tabular grain emulsion (111) planes will be described hereinafter. Most normally, the proportion of (111) planes in the sides of a host tabular grain can be determined by pBr during the preparation of the tabular grain emulsion. Preferably, the addition of 30% or more of the amount of silver required to form the outermost layer is conducted so as to give pBr such that the proportion of (111) planes in the sides decreases, that is, the proportion of (100) planes in the sides increases. More preferably, the addition of 50% or more of the amount of silver required to form the outermost layer is conducted so as to give pBr such that the proportion of (111) planes in the sides decreases.

Another possible method comprises predetermining pBr such that the proportion of (100) planes in the sides increases after the addition of the total required amount of silver, and then ripening the emulsion to increase the proportion of (100)planes in the sides.

The pBr value at which the proportion of (100) planes in the sides increases can vary widely depending on the temperature and pH value of the system, the kind and concentration of protective colloid such as gelatin, the presence or absence, kind and concentration of silver halide solvent, etc. In general, the pBr value is preferably from 2.0 to 5, more preferably from 2.5 to 4.5. However, as mentioned above, this pBr value can easily vary due to the presence of silver halide solvent, etc. Examples of the silver halide solvent employable herein include (a) organic thioethers as disclosed in U.S. Pat. Nos. 3,271,157, 3,531,286 and 3,574,628, JP-A-54-1019 and JP-A-54-158917, (b) thiourea derivatives as disclosed in JP-A-53-82408, JP-A-55-77737 and JP-A-55-2982, (c) silver halide solvents having thiocarbonyl group interposed between oxygen or sulfur atom and nitrogen atom as disclosed in JP-A-53-144319, (d) imidazoles as disclosed in JP-A-54-100717, (e) sulfites, (f) ammonia, and (g) thiocyanates.

Particularly preferred examples of solvent include thiocyanates, ammonia and tetramethylthiourea. Though depending on the kind of the solvent used, the amount of the solvent to be used is preferably from 1×10⁻⁴ mol to 1×10⁻² mol per mol of silver halide if the solvent is a thiocyanate.

For the method for varying the index of the sides of the tabular grain emulsion, reference can be made to EP 515894A1, etc. Alternatively, the polyalkylene oxide compounds as disclosed in U.S. Pat. No. 5,252,453 may be used. As a useful means there may be used a plane index modifier as disclosed in U.S. Pat. Nos. 4,680,254, 4,680,255, 4,680,256 and 4,684,607. An ordinary photographic spectral sensitizing dye may be similarly used as a plane index modifier.

The host tabular grain preferably has no dislocation line. The combined use of the nucleation, ripening and growth steps described in detail above makes it possible to eliminate dislocation line.

The epitaxial junction required to prepare the epitaxial emulsion will be described in detail hereinafter. The epitaxial deposition may be effected immediately after the formation of host tabular grain or after ordinary desalting after the formation of host tabular grain. The epitaxial emulsion preferably comprises a gelatin having a high molecular component having a molecular weight of about 2,000,000 or more in a proportion of from 5% to 30%, more preferably from 5% to 15%, and a low molecular component having a molecular weight of about 100,000 or less in a proportion of 55% or less, more preferably 50% or less, in the molecular weight distribution measured according to PAGI process prior to epitaxial deposition. The high molecular gelatin is incorporated in an amount of 10% by weight or more, preferably 30% by weight or more, more preferably 50% by weight or more during epitaxial junction. Even when this gelatin is added by the spreading, the resulting effect is still present but small.

The gelatin to be used herein may be subjected to the following various modification treatments. Examples of these modified gelatins include phthalated gelatin, succinated gelatin, trimellitated gelatin and pyromellitated gelatin having modified amino group, esterified gelatin and amidated gelatin having modified carboxyl group, formylated gelatin having modified imidazole group, oxidized gelatin having a reduced number of methionine groups, and reduced gelatin having an increased number of methionine groups.

On the other hand, other hydrophilic colloids may be used.

Examples of the other hydrophilic colloids employable herein include various synthetic hydrophilic polymer materials such as protein (e.g., gelatin derivative, graft polymer of gelatin with other polymers, albumin, casein); sugar derivatives such as cellulose derivatives (e.g., hydroxyethyl cellulose, carboxymethyl cellulose, cellulose sulfuric acid esters), sodium alginate and starch derivative; and homopolymers or copolymers (e.g., polyvinyl alcohols, polyvinyl alcohol partial acetal, poly-N-vinylpyrrolidone, polyacrylic acids, polymethacrylic acids, polyacrylamides, polyvinyl imidazoles, polyvinyl pyrazoles). As the gelatin there may be used an acid-treated gelatin or enzymatically-treated gelatin as described in “Bull. Soc. Sci. Photo. Japan”, No. 16, page 30, 1966 besides lime-treated gelatin. Alternatively, hydrolyzate or enzymatic decomposition of gelatin may be used.

In order to prepare the epitaxial emulsion, pH, pAg, and kind, concentration and viscosity of gelatin are predetermined. The pH value is particularly important and is preferably from 4 to 5.5, particularly from 4.5 to 5. By predetermining the pH value to the above defined range, epitaxial deposition can be effected uniformly from grain to grain, making it possible to exert the effect of the invention remarkably.

As an agent for indicating the site of epitaxial junction there may be used a sensitizing dye. By predetermining the amount and kind of the dye used, the position of epitaxial deposition can be controlled. The dye is preferably added in an amount of from 50% to 90% of the saturated spread. Examples of the dye employable herein include cyanine dyes, melocyanine dyes, composite cyanine dyes, composite melocyanine dyes, holopolar cyanine dyes, hemicyanine dyes, styryl dyes, and hemioxonol dyes. Particularly useful among these dyes are those belonging to cyanine dye. Any of nuclei commonly used for cyanine dyes can be applied to these dyes as basic heterocyclic nuclei. Examples of these nuclei employable herein include pyrroline nuclei, oxazoline nuclei, thiozoline nuclei, pyrrole nuclei, oxazole nuclei, thiazole nuclei, selenazole nuclei, imidazole nuclei, tetrazole nuclei, pyridine nuclei, nuclei having alicyclic hydrocarbon rings fused to these nuclei, and nuclei having aromatic hydrocarbon rings fused to these nuclei, e.g., indoleine nuclei, benzoindolenine nuclei, indole nuclei, benzoxazole nuclei, naphthoxazole nuclei, benzothiazole nuclei, naphthothiazole nuclei, benzoselenazole nuclei, benzoimidazole nuclei, quinoline nuclei. These nuclei may have substituents on carbon atoms.

These sensitizing dyes may be used singly or in combination. These combinations of sensitizing dyes are used particularly for supersensitizing purpose. Representative examples of these combinations include those disclosed in U.S. Pat. Nos. 2,688,545, 2,977,229, 3,397,060, 3,522,052, 3,527,641, 3,617,293, 3,628,964, 3,666,480, 3,672,898, 3,679,428, 3,703,377, 3,769,301, 3,814,609, 3,837,862 and 4,026,707, British Patents 1,344,281 and 1,507,803, JP-B-43-4936, JP-B-53-12375, JP-A-52-110618, and JP-A-52-109925.

A dye which has no spectral sensitizing action itself or a material which does not substantially absorb visible light but exhibits supersentizing action may be added at the same time with or separately of the sensitizing dye.

During the adsorption of sensitizing dye, it is preferred from the standpoint of preparation of epitaxial emulsion that the silver iodide content of the extreme surface layer of the outermost layer of the host tabular grain be higher than that of the outermost layer. The addition of the sensitizing dye is followed by the addition of iodine ion. In the invention, it is most preferably practiced to add the aforementioned emulsion of silver iodide fine grains, raising the silver iodide content of the surface of the host tabular grain. In this manner, the distribution of silver iodide content from grain to grain can be uniformalized, making it possible to uniformalize the adsorption of sensitizing dye. This makes it possible to prepare the epitaxial emulsion of the invention. The added amount of these iodine ions or silver iodide is preferably from 1×10⁻⁴ to 1×10⁻² mol, particularly from 1×10⁻³ to 5×10⁻³ mol per mol of silver in the host tabular grain.

The formation of the epitaxial portion may be accomplished by the simultaneous or separate addition of a solution containing halogen ions and a solution containing AgNO₃. In some detail, silver chloride fine grains, silver bromide fine grains and silver iodide fine grains having a smaller diameter than the host tabular grain may be properly added singly or in admixture. In the case where the solution of AgNO₃ is used, the addition time is preferably from 30 seconds to 10 minutes, particularly from 1 minute to 5 minutes. In order to form the epitaxial emulsion, the concentration of the silver nitrate solution to be added is preferably 1.5 mol/l or less, particularly 0.5 mol/l or less. During this procedure, it is necessary that agitation in the system be effected efficiently. The viscosity of the system is preferably low.

The content of silver in the epitaxial portion is preferably from 1 mol % to 10 mol %, more preferably from 2 mol % to 7 mol % of the silver content in the host tabular grain. When the content of silver in the epitaxial portion is too small, the desired epitaxial emulsion cannot be prepared. On the contrary, when the content of silver in the epitaxial portion is too great, the resulting epitaxial emulsion is unstable.

The pBr value during the formation of the epitaxial portion is preferably 3.5 or more, particularly 4.0 or more. The formation of the epitaxial portion is preferably effected at a temperature of from 35° C. to 45° C. During the formation of the epitaxial portion, the epitaxial portion is preferably doped with a hexacyano metal complex.

Preferred among hexacyano metal complexes are those containing iron, ruthenium, osmium, cobalt, rhodium, iridium or chromium. The added amount of the metal complex is preferably from 10⁻⁹ to 10⁻² mol, more preferably from 10⁻⁸ to 10⁻⁴ mol per mol of silver halide, The metal complex may be added in the form of solution in water or an organic solvent. The organic solvent is preferably miscible with water. Examples of the organic solvent include alcohols, ethers, glycols, ketones, esters, and amides.

Particularly preferred examples of the metal complex include hexacyano metal complexes represented by the following general formula (I). The use of an emulsion comprising such a hexacyano metal complex makes it possible to obtain a high sensitivity photographic light-sensitive material. Further, an effect of inhibiting the occurrence of fogging even after. prolonged storage of the photographic light-sensitive material can be exerted.

[M(CN)₆]ⁿ⁻ (I)

wherein M represents iron, ruthenium, osmium, cobalt, rhodium, iridium or chromium; and n represents an integer of 3 or 4.

Specific examples of these hexacyano metal complexes will be given below.

[Fe(CN)₆]⁴⁻ (I-1)

[Fe(CN)₆]³⁻ (I-2)

[Ru(CN)₆]⁴⁻ (I-3)

[Os(CN)₆]⁴⁻ (I-4)

[Co(CN)₆]³⁻ (I-5)

[Rh(CN)₆]³⁻ (I-6)

[Ir(CN)₆]³⁻ (I-7)

[Cr(CN)₆]⁴⁻ (I-8)

As the counter cation of hexacyano metal complex there is preferably used one which is miscible with water and suitable for precipitation of silver halide emulsion. Examples of the counter ions employable herein include alkaline metal ions such as sodium ion, potassium ion, rubidium ion, cesium ion and lithium ion, ammonium ion, and alkyl ammonium ion.

To the emulsion is preferably added the aforementioned sensitizing dye and/or the fog inhibitor as described later and/or the stabilizer as described later after epitaxial deposition.

Thereafter, the pBr value of the emulsion is preferably lowered. The preferred epitaxial emulsion can have a lowered pBr value and thus can exert a remarkable effect on preservability and processability. The pBr value of the epitaxial emulsion is preferably lowered to 3.5 or less at 40° C. The pBr value of the epitaxial emulsion is more preferably 3.0 or less, particularly 2.5 or less at 40° C. The reduction of the pBr value of the emulsion is essentially carried out by the addition of bromine ion such as KBr and NaBr.

Epitaxial deposition is normally followed by rinsing.

The rinsing temperature can be predetermined depending on the purpose but is preferably predetermined to be from 5° C. to 50° C. The pH value during rinsing can be predetermined depending on the purpose but is preferably predetermined to be from 2 to 10, more preferably from 3 to 8. The pAg value during rinsing can be predetermined depending on the purpose but is preferably predetermined to be from 5 to 10. The rinsing method is selected from the group consisting of noodle rinsing, dialysis using semipermeable membrane, centrifugal separation, coagulation and ion exchange. Coagulation is selected from the group consisting of method using a sulfate, method using an organic solvent, method using a water-soluble polymer and method using a gelatin derivative.

The epitaxial deposition is preferably followed by chemical sensitization. One of chemical sensitization methods which can be preferably effected in the invention is one or combination of chalcogen sensitization and noble metal sensitization. As described in T. H. James, “The Theory of the Photographic Process”, 4th ed., Macmillan, 1977, pp. 67-76, the chemical sensitization may be effected using an active gelatin. As described in Research Disclosure, Vol. 120, April 1974, 12008 Research Disclosure, Vol. 34, June 1975, 13452, U.S. Pat. Nos. 2,642,361, 3,297,446, 3,772,031, 3,857,711, 3,901,714, 4,266,018 and 3,904,415, and British Patent 1,315,755, sulfur, selenium, tellurium, gold, platinum, palladium, iridium and other sensitizers may be used singly or in combination at pAg of from 5 to 10, pH of from 5 to 8 and a temperature of from 30° C. to 80° C. Noble metal sensitization can be effected with a salt of noble metal such as gold, platinum, palladium and iridium. In particular, gold sensitization and palladium sensitization are preferably effected singly or in combination. Gold sensitization may be effected with a known compound such as chloroauric acid, potassium chloroaurate, potassium aurithiocyanate, gold sulfate and gold selenide. The term “palladium compound” as used herein is meant to indicate a divalent or tetravalent palladium salt. The preferred palladium compound is represented by R₂PdX₆ or R₂PdX₄ wherein R represents a hydrogen atom, alkaline metal atom or ammonium group and X represents a halogen atom such as chlorine, bromine and iodine.

Specific preferred examples of the palladium compound employable herein include K₂PdCl₄, (NH₄)PdCl₆, Na₂PdCl₄, (NH₄)₂PdCl₄, Li₂PdCl₄, Na₂PdCl₆ and K₂PdBr₄. The gold compound and the palladium compound are preferably used in combination with thiocyanates or selenocyanates.

As sulfur sensitizers there may be used hypo, thiourea-based compounds, rhodanine-based compounds and sulfur-containing compounds described in U.S. Pat. Nos. 3,857,711, 4,266,018 and 4,054,457. Chemical sensitization may be effected in the presence of a so-called chemical sensitization auxiliary. As a useful chemical sensitization auxiliary there may be used a compound known to inhibit fogging during chemical sensitization and increase sensitivity such as azaindene, azapyridazine and azapyrimidine. Examples of the chemical sensitization auxiliary/modifier include those described in U.S. Pat. Nos. 2,131,038, 3,411,914 and 3,554,757, JP-A-58-126526, and Duffin, “Chemistry of Photographic Emulsion”, pp. 138-143.

The emulsion of the invention is preferably subjected to gold sensitization as well. The amount of the gold sensitizer to be used is preferably from 1×10⁻⁴ to 1×10⁻⁷ mol, more preferably from 1×10⁻⁵ to 5×10⁻⁷ mol per mol of silver halide. The amount of the palladium compound to be used is preferably from 1×10⁻³ to 5×10⁻⁷ mol per mol of silver halide. The amount of the thiocyan compound or selenocyan compound to be used is preferably from 5×10⁻² to 1×10⁻⁶ mol per mol of silver halide.

The amount of the sulfur sensitizer to be used for the silver halide grains of the invention is preferably from 1×10⁻⁴ to 1×10⁻⁷ mol, more preferably from 1×10⁻⁵ to 5×10⁻⁷ mol per mol of silver halide.

The sensitization method which is preferably effected for the emulsion of the invention is selenium sensitization. Selenium sensitization may be effected with a known unstable selenium compound. Specific examples of these unstable selenium compounds include selenium compounds such as colloidal metallic selenium, selenoureas (e.g., N,N-dimethylselnourea, N,N-diethylselenourea), selenoketones and selenoamides. Selenium sensitization may be preferably effected in combination with either or both of sulfur sensitization and noble metal sensitization.

Tellurium sensitization maybe effected with an unstable tellurium compound as disclosed in JP-A-4-224595, JP-A-4-271341, JP-A-4-333043, JP-A-5-303157, JP-A-6-27573, JP-A-6-175258, JP-A-6-180478, JP-A-6-208184, JP-A-6-208186, JP-A-6-317867, JP-A-7-140579, JP-A-7-301879, and JP-A-7-301880.

Specific examples of the unstable tellurium compounds include phosphine tellurides (e.g., normal butyl-diisopropyl phosphine telluride, triisobutyl phosphine telluride, trinormal butoxy phosphine telluride, triisopropyl phosphine telluride), diacyl (di)tellurides (e.g., bis(diphenylcarbamoyl)ditelluride, bis(N-phenyl-N-methylcarbamoyl)ditelluride, bis(N-phenyl-N-methylcarbamoyl)telluride, bis(N-phenyl-N-benzylcarbamoyl)telluride, bis(ethoxycarbonyl)telluride, telluroureas (e.g.; N,N′-dimethylethylenetellurourea), telluroamides, and telluroesters. Preferred among these unstable tellurium compounds are phosphine tellurides and diacyl (di) tellurides.

The photographic emulsion Lo be used in the invention may comprise various compounds incorporated therein for the purpose of inhibiting fogging during the preparation, storage or photographic processing of photographic light-sensitive material or stabilizing photographic properties. In some detail, many compounds known as fog inhibitor or stabilizer such as thiazoles (e.g., benzothiazolium salts, nitroimidazoles, nitrobenzimidazoles, chlorobenzimidazoles, bromobenzimidazoles, mercaptothiazoles, mercapto-benzothiazoles, mercaptobenzimidazoles, mercaptothiadiazoles, aminotriazoles, benzotriazoles, nitrobenzotriazoles, mercaptotetrazoles (particularly 1-phenyl-5-mercaptotetrazole)), mercaptopyrimidines, mercaptotriazines, thioketo compounds (e.g., oxadolinethione), azaindenes (e.g., triazaindenes, tetraazaindenes (particularly 4-hydroxy-substituted (1,3,3a,7)tetraazaindenes)) and petanazaindenes may be added. For example, compounds as disclosed in U.S. Pat. Nos. 3,954,474 and 3,982,947, and JP-B-52-28660 may be used. One of the preferred compounds is a compound disclosed in JP-A-63-212932. The fog inhibitor and stabilizer may be added at any time, e.g., before, during and after the formation of grains, during the rinsing step, during dispersion after rinsing, during epitaxial formation, before,during and after chemical sensitization, before coating, depending on the purpose. The fog inhibitor and stabilizer .may be used for many purposes such as controlling the crystal habit of grains, reducing the grain size, decreasing the solubility of grains, controlling chemical sensitization and controlling the arrangement of dyes besides being added during the preparation of the emulsion to exert its inherent effect of inhibiting fogging and stabilizing photographic properties.

The presence of salt of metallic ions during the preparation of the emulsion of the invention, e.g., during the formation of grains, during the epitaxial formation, during the desalting step, during chemical sensitization, before coating is desirable depending on the purpose. In order to dope the grains with these salts, these salts are preferably added during the formation of grains. In order to modify the surface of the grains with these salts or use these salts as chemical sensitizer, these salts are preferably added after the formation of grains or before the termination of chemical sensitization. In the case of doping, the grain may be doped with these salts entirely or only in the core or shell thereof. For example, Mg, Ca, Sr, Ba, Al, Sc, Y, La, Cr, Mn, Fe, Co, Ni, Cu, Zn, Ga, Ru, Rh, Pd, Re, Os, Ir, Pt, Au, Cd, Hg, Tl, In, Sn, Pb, and Bi may be used. These metals may be added in any salt form which can be dissolved in the emulsion during the formation of grains such as ammonium salt, acetate, nitrate, sulfate, phosphate, hydroxide, hexacoordinate complex and tetracoordinate complex. Examples of these salts include CdBr₂, CdCl₂, Cd(NO₃)₂, Pb(NO₃)₂, Pb(CH₃COO)₂, K₃[Fe(CN)₆], (NH₄)₄[Fe(CN)₆], K₃IrCl₆, (NH₄)₃RhCl₆, and K₄Ru(CN)₆. The ligand of these coordination compounds may be selected from the group consisting of halo, aco, cyano, cyanate, thiocyanate, nitrosil, thionitrosil, oxo and carbonyl. These metallic compounds may be used singly or in combination of two or more thereof.

These metallic compounds may be added in the form of solution in water or a proper organic solvent such as methanol and acetone. In order to stabilize the solution, a method involving the addition of an aqueous solution of hydrogen halide (e.g., HCl, HBr) or alkali halide (e.g., KCl, NaCl, KBr, NaBr) may be employed. If necessary, an acid or alkali may be added. These metallic compounds may be put in the reaction vessel before the formation of grains or added during the formation of grains. Alternatively, these metallic compounds may be continuously added to a water-soluble silver salt (e.g., AgNO₃) or an aqueous solution of alkali halide (e.g., NaCl, KBr, KI) during the formation of silver halide grains. Alternatively, a solution prepared separately of water-soluble silver salt or alkali halide may be continuously added at any proper time during the formation of grains. Various addition methods are preferably used in combination.

The silver halide photographic emulsion of the invention is preferably subjected to reduction sensitization during the formation of grains, after the formation of grains and before the chemical sensitization, during the chemical sensitization or after the chemical sensitization.

The reduction sensitization can be selected from the group consisting of method involving the addition of a reduction sensitizer to a silver halide emulsion, method called silver ripening involving the growth or ripening in an atmosphere having pAg as low as 1 to 7 and method called high pH ripening involving the growth or ripening in an atmosphere having pH as high as 8 to 11. Two or more of these methods may be used in combination.

The method involving the addition of a reduction sensitizer is advantageous in that the level of-reduction sensitization can be closely adjusted.

Known examples of the reduction sensitizer include stannous salts, ascorbic acid and derivatives thereof, amines, polyamines, hydrazine derivatives, formamidinesulfinic acid, silane compounds, and borane compounds. The reduction sensitizer to be used in the invention may be selected from these known reduction sensitizers. Two or more of such compounds may be used in combination. Preferred examples of reduction sensitizers include stannous chloride, thiourea dioxide, dimethylamine borane, and ascorbic acid and derivatives thereof. The amount of the reduction sensitizer to be added depends on the conditions of preparation of emulsion and thus needs to be properly predetermined but is preferably from 10⁻⁷ to 10⁻³ mol per mol of silver halide.

The reduction sensitizer is added in the form of solution in water or an organic solvent such as alcohol, glycol, ketone, ester and amide during the formation of grains. The reduction sensitizer may be previously put in the reaction vessel but is preferably added at any time during the growth of grains. Alternatively, the reduction sensitizer may be added in admixture with an aqueous solution of water-soluble silver salt or water-soluble alkali halide to cause the precipitation of silver halide grains. The solution of reduction sensitizer may be added batchwise or continuously for a long period of time during the growth of grains to advantage.

During the preparation of the emulsion of the invention, an oxidizer for silver is preferably used. The term “oxidizer for silver” as used herein is meant to indicate a compound which acts on metallic silver to convert it to silver ion A particularly useful oxidizer for silver is a compound capable of converting very fine silver grain by-produced during the formation and chemical sensitization of silver halide grains to silver ion. The silver ion thus produced may form a difficultly water-soluble silver salt such as silver halide, silver sulfide and silver selenide or a water-soluble silver salt such as silver nitrate. The oxidizer for silver may be either an inorganic material or organic material. Examples of the inorganic oxidizer include ozone, hydrogen peroxide and adducts thereof (e.g., NaBO₂.H₂O₂.3H₂O, 2NaCO₃.3H₂O₂, Na₄P₂O₇.2H₂O₂, 2Na₂SO₄.H₂O₂.2H₂O), peroxyacetates (e.g., K₂S₂O₈, K₂C₂O₆, K₂P₂O₈), peroxy complex compounds (e.g., K₂[Ti(O₂)C₂O₄].3H₂O, 4K₂SO₄.Ti(O₂) OH.SO₄.2H₂O, Na₃[VO(O₂)(C₂H₄)₂].6H₂O), oxyacid salts such as permanganates (e.g., KnO₄) and chromates (e.g., K₂Cr₂O₇), halogen elements such as iodine and bromine, perhalogenates (e.g., potassium periodate), metal salts having a high valency (e.g., potassium hexacyanoferrate), and thiosuflonates.

Examples of the organic oxidizer include quinones such as p-quinone, organic peroxides such as peracetic acid and perbenzoic acid, and compounds capable of releasing active halogen (e.g., N-bromosuccinimide, chloramine T, Chloramine B).

Preferred examples of the oxidizer employable herein include ozone, hydrogen peroxide and adducts thereof, halogen elements, inorganic oxidizers of thiosalfonate, and organic oxidizers of quinones, In a preferred embodiment, the aforementioned reduction sensitization is effected in combination with the use of the oxidizer for silver. The reduction sensitization may be effected before and/or after the use of the oxidizer. This process may be effected during the formation of grains or during the chemical sensitization.

The photographic light-sensitive material prepared from the silver halide emulsion obtained according to the invention comprises at least one blue-sensitive silver halide emulsion layer, at least one green-sensitive silver halide emulsion layer and at least one red-sensitive silver halide emulsion layer provided on a support. At least one of the blue-sensitive layer, the green-sensitive layer and the red-sensitive layer may be formed by two or more layers having different sensitivities. The number and order of arrangement of the silver halide emulsion layers and light insensitive layers are not specifically limited. A representative example of the photographic light-sensitive material is a silver halide photographic material comprising at least one color-sensitive layer composed of a plurality of silver halide emulsion layers having substantially the same color sensitivity but different sensitivities provided on a support. The light-sensitive layer is a unit light-sensitive layer sensitive to any of blue light, green light and red light. Referring to the arrangement of unit light-sensitive layer in a multiple-layer silver halide color photographic material, the red-sensitive layer, the green-sensitive layer and the blue-sensitive layer are generally arranged in this order from the support. However, even when the order of arrangement of these layers is reversed depending on the purpose, the arrangement may be such that layers having the same color sensitivity have a light-sensitive layer having a different sensitivity provided interposed therebetween.

The aforementioned silver halide light-sensitive layers may have a light-insensitive layer such as interlayer provided interposed therebetween, as an outermost layer or as a lowermost layer.

The aforementioned interlayer may comprise a coupler or DIR compound as disclosed in JP-A-61-43748, JP-A-59-113438, JP-A-59-113440, JP-A-61-20037 and JP-A-61-20038 incorporated therein. The interlayer may comprise a color stain inhibitor incorporated therein as effected as usual,

As the plurality of silver halide emulsion layers constituting the various unit light-sensitive layers there are preferably used a two-layer constitution containing a high sensitivity emulsion layer and a low sensitivity emulsion layer as described in West German Patent 1,121,470 and British Patent 923,045. In general, these silver halide emulsion layers are preferably arranged such that the sensitivity decreases towards the support. Further, the various silver halide emulsion layers may have a light-insensitive layer provided interposed therebetween. As described in JP-A-57-112751, JP-A-62-200350, JP-A-62-206541 and JP-A-62-206543, the low sensitivity emulsion layer may be provided remote from the support while the high sensitivity emulsion layer may be provided close to the support.

By way of example, a low sensitivity blue-sensitive layer (BL), a high sensitivity blue-sensitive layer (BH), a high sensitivity green-sensitive layer (GL), a high sensitivity red-sensitive layer (RH) and a low sensitivity red-sensitive layer (RL) may be arranged in this order from the side remotest from the support. Alternatively, BH, BL, GL, GH, RH and RL may be arranged in this order from the side remotest from the support. Further, BH, BL, GH, GL, RL and RH may be arranged in this order from the side remotest from the support.

As described in JP-B-55-34932, a blue-sensitive layer, GH, RH, GL and RL may be arranged in this order from the side remotest from the support.

As described in JP-A-56-25738 and JP-A-62-63936, a blue-sensitive layer, GL, RL, GH and RH may be arranged in this order from the side remotest from the support,

As described in JP-B-49-15495, the silver halide photographic material may comprise an upper layer made of a silver halide emulsion layer having a highest sensitivity, a middle layer made of a silver halide emulsion layer having a sensitivity lower than that of the upper layer and a lower layer made of a silver halide emulsion layer having a sensitivity lower than that of the middle layer to make a three-layer arrangement such that the sensitivity decreases gradually towards the support. Even in the case where the silver halide photographic material is composed of three layers having different sensitivities, a middle sensitivity emulsion layer; a high sensitivity emulsion layer and a low sensitivity emulsion layer may be arranged in the same color sensitivity layer in this order from the side remote from the support as described in JP-A-59-202464.

Besides these arrangements, a high sensitivity emulsion layer, a low sensitivity emulsion layer, and a middle sensitivity emulsion layer may be arranged in this order. Alternatively, a low sensitivity emulsion layer, a middle sensitivity emulsion layer, and a high sensitivity emulsion layer may be arranged in this order.

In the case of arrangement of four or more layers, the arrangement of layers may be varied as mentioned above.

As mentioned above, various layer configurations and arrangements may be selected depending on the purpose of the photographic light-sensitive material.

The photographic light-sensitive material according to the invention may comprise various aforementioned additives incorporated therein. Besides these additives, various additives may be used depending on the purpose.

For the details of these additives, reference can be made to Research Disclosure Item 17643 (December 1978), Item 18716 (November 1979) and Item 308119 (December 1989). The locations where the additives are described in each of those references are listed below.

| Kinds of Additives | RD-17643 | RD-18716 | RD-308119 |
|---|---|---|---|
| 1. Chemical | p. 23 | p. 648, | p. 996 |
| sensitizer | | right | |
| | | column | |
| 2. Sensitivity | | p. 648, | |
| increasing agent | | right | |
| | | column | |
| 3. Spectral | pp. 23-24 | p. 648, | p. 996, |
| sensitizer and | | right | right |
| Supersensitizer | | column, | column, |
| | | to p. 649, | to p. 998, |
| | | right | right |
| | | column | column |
| 4. Brightening | p. 24 | p. 647, | p. 998, |
| agent | | right | right |
| | | column | column |
| 5. Antifoggant | pp. 24-25 | p. 649, | p. 998, |
| and Stabilizer | | right | right |
| | | column | column |
| | | | to p. 1000, |
| | | | right |
| | | | column |
| 6. Light absorbent, | pp. 25-26 | p. 649, | p. 1003, |
| Filter dye, | | right | left |
| UV absorbent | | column, | column |
| | | to p. 650, | to p. 1003, |
| | | left | right |
| | | column | column |
| 7. Stain inhibitor | p. 25, | p. 650, | p. 1002, |
| | right | left | right |
| | column | column | column |
| | | to right | |
| | | column | |
| 8. Dye image | p. 25 | | p. 1002, |
| stabilizer | | | right |
| | | | column |
| 9. Hardener | p. 26 | p. 651, | p. 1004, |
| | | left | right |
| | | column | column |
| | | | to p. 1005, |
| | | | left |
| | | | column |
| 10. Binder | p. 26 | p. 651, | p. 1003, |
| | | left | left right |
| | | column | column |
| | | | to p. 1004, |
| | | | right |
| | | | column |
| 11. Plasticizer, | p. 27 | p. 650, | p. 1006, |
| Lubricant | | right | left |
| | | column | column |
| | | | to right |
| | | | column |
| 12. Coating aid, | pp. 26-27 | p. 650, | p. 1005, |
| Surfactant | | right | left |
| | | column | column |
| | | | to p. 1006, |
| | | | left |
| | | | column |
| 13. Antistatic agent | p. 27 | p. 650, | p. 1006, |
| | | right | right |
| | | column | column |
| | | | to p. 1007, |
| | | | left |
| | | | column |
| 14. Matting agent | | | p. 1008, |
| | | | left |
| | | | column |
| | | | to p. 1009, |
| | | | left |
| | | | column |

In order to inhibit the deterioration of the photographic properties by formaldehyde gas, the photographic light-sensitive material preferably comprises a compound incorporated therein capable of reacting with and fixing formaldehyde as disclosed in U.S. Pat. Nos. 4,411,987 and 4,435,503.

The color photographic light-sensitive material may comprise various color couplers incorporated therein. Specific examples of these color couplers are described in the above cited Research Disclosure No. 17643, VII-C to G, and patents cited in No. 307105, VII-C to G.

Preferred examples of yellow couplers employable herein include those disclosed in U.S. Pat. Nos. 3,933,501, 4,022,620, 4,326,024, 4,401,752 and 4,248,961, JP-B-58-10739, British Patents 1,425,020 and 1,476,760, U.S. Pat. Nos. 3,973,968, 4,314,023 and 4,511,649, and EP 249,473A.

Preferred examples of magenta couplers employable herein include 5-pyrazolone-based and pyrazoloazole-based compounds. Particularly preferred examples of these compounds include those disclosed in U.S. Pat. Nos. 4,310,619 and 4,351,897, EP 73,636, U.S. Pat. Nos. 3,061,432 and 3,725,067, Research Disclosure No. 24220 (June 1984), JP-A-60-33552, Research Disclosure No. 24230 (June 1984), JP-A-60-43659, JP-A-61-72238, JP-A-60-35730, JP-A-55-118034, JP-A-60-185951, U.S. Pat. Nos. 4,500,630, 4,540,654 and 4,556,630, and WO88/04795.

Examples of cyan couplers employable herein include phenol-based and naphthol-based couplers. Preferred examples of these couplers include those described in U.S. Pat. Nos. 4,052,212, 4,146,396, 4,228,233, 4,296,200, 2,369,929, 2,801,171, 2,772,162, 2,895,826, 3,772,002, 3,758,308, 4,334,011 and 4,327,173, West German Patent Application (OLS) No. 3,329,729, EP 121,365A, EP 249,453A, U.S. Pat. Nos. 3,446,622, 4,333,999, 4,775,616, 4,451,559, 4,427,767, 4,690,889, 4,254,212 and 4,296,199, and JP-A-61-42658.

Representative examples of polymerized dye-forming couplers include those disclosed in U.S. Pat. Nos. 3,451,820, 9,080,211, 4,367,282, 4,409,320 and 4,576,910, British Patent 2,102,137, and EP 341,188A.

Examples of couplets capable of giving a color forming dye having a proper dispersibility include those disclosed in U.S. Pat. No. 4,366,237, British Patent 2,125,570, EP 96,570, and West German Patent Application (OLS) No. 3,234,533.

Preferred examples of colored couplers for correcting unnecessary absorption of color forming dye include those disclosed in Research Disclosure No. 17643, VII-G, Research Disclosure No. 307105, VII-G, U.S. Pat. No. 4,163,670, JP-B-57-39413, U.S. Pat. Nos. 4,004,929 and 4,138,258, and British Patent 1,146,368. It is also preferred to use couplers which correct unnecessary absorption of color forming dye by a fluorescent dye released during coupling as disclosed in U.S. Pat. No. 4,774,181 and couplers having as coupling-off group a dye precursor group capable of reacting with a developing agent to form a dye as disclosed in U.S. Pat. No. 4,777,120.

Compounds capable of releasing a photographically useful residual during coupling can be preferably used in the invention. Preferred examples of DIR couplers capable of releasing a development inhibitor include those disclosed in the patents cited in the above cited RD17643, VII-F and RD307105, VII-F, and. JP-A-57-151944, JP-A-57-154234, JP-A-60-184248, JP-A-63-37346, JP-A-63-37350, and U.S. Pat. Nos. 4,248,962 and 4,782,012.

Preferred examples of couplers capable of releasing imagewise a nucleating agent or development accelerator during development include those disclosed in British Patents 2,097,140 and 2,131,188, JP-A-59-157638, and JP-A-59-170840. Further, compounds capable of undergoing redox reaction with an oxidation product of a developing agent to release a fogging agent, a development accelerator, a silver halide solvent or the like as disclosed in JP-A-60-107029, JP-A-60-252340, JP-A-1-44940 and JP-A-1-45687 can be preferably used.

Other examples of compounds which can be incorporated in the photographic light-sensitive material of the invention include competitive couplers as disclosed in U.S. Pat. No. 4,130,427, multiequivalent couplers as disclosed in U.S. Pat. Nos. 4,283,472, 4,338,393 and 4,310,618, DIR redox compound-releasing couplers, DIR coupler-releasing couplers, DIR coupler-releasing redox compounds and DIR redox-releasing redox compounds as disclosed in JP-A-60-185950 and JP-A-62-24252, couplers capable of releasing a dye which restores its original color after coupling off as disclosed in EP 173,302A and EP 313,308A, bleach accelerator-releasing couplers as disclosed in RD No. 11449, RD No. 24241 and JP-A-61-201247, ligand-releasing couplers as disclosed in U.S. Pat. No. 4,555,477, leuco dye-releasing couplers as disclosed in JP-A-63-75747, and couplers capable of releasing a fluorescent dye as disclosed in U.S. Pat. No. 4,774,181.

The couplers to be used can be incorporated in the photographic light-sensitive material by any known dispersion method.

Examples of high boiling solvents to be used in oil-in-water dispersion method include those as disclosed in U.S. Pat. No. 2,322,027.

Specific examples of high boiling organic solvents having a boiling point of 175° C. or more at ordinary pressure to be used in oil-in-water dispersion method include phthalic acid esters (e.g., dibutyl phthalate, dicyclohexyl phthalate, di-2-ethylhexyl phthalate, decyl phthalate, bis(2,4-di-tert-amylphenyl)phthalate, bis(2,4-di-tert-amylphenyl)isophthalate, bis(1,1-diethylpropyl)phthalate), phosphoric or phosphonic acid esters (e.g., triphenyl phosphate, tricresyl phosphate, 2-ethylhexyldiphenyl phosphate, tricyclohexyl phosphate, tri-2-ethylhexyl phosphate, tridecyl phosphate, tributoxyethyl phosphate, trichloropropyl phosphate, di-2-ethylhexylphenyl phosphate), benzoic acid esters (e.g., 2-ethylhexyl benzoate, dodecyl benzoate, 2-ethylhexyl-p-hydroxy benzoate), amides (e.g., N,N-diethyldodecamide, N,N-diethyllaurylamide, N-tetradecylpyrrolidone), alcohols or phenols (e g., isostearyl alcohol, 2,4-di-tert-amylphenol), aliphatic carboxylic acid esters (e.g.; bis(2-ethylhexyl)sebacate, dioctyl azelate, glycerol tributylate, isostearyl lactate, trioctyl citrate), aniline derivatives (e.g, N,N-dibutyl-2-butoxy-5-tert-octylaniline), and hydrocarbons (e.g., paraffin, dodecylbenzene, diisopropyl naphthalene). As a co-solvent there may be used an organic solvent having a boiling point of about 30° C. or more, preferably from about 50° C. to about 160° C. Representative examples of such a co-solvent employable herein include ethyl acetate, butyl acetate, ethyl propionate, methyl ethyl ketone, cyclohexanone, 2-ethoxyethyl acetate, and dlimethyl formamide.

Specific examples of the procedure and effect of latex dispersion and impregnation latexes include those disclosed in U.S. Pat. No. 4,199,363, and West German Patent Application (OLS) Nos. 2,541,274 and 2,541,230.

The color photographic light-sensitive material of the invention preferably comprises various preservatives or mildew-proofing agents such as phenethyl alcohol and 1,2-benzidothiazoline-3-one, n-butyl-p-hydroxybenzoate, phenol, 4-chloro-3,5-dimethylphenol, 2-phenoxyethanol and 2-(4-thiazolyl)benzoimidazole as disclosed in JP-A-63-257747, JP-A-62-272248 and JP-A-1-80941.

The invention can be applied to various photographic light-sensitive materials, preferably to various color photographic light-sensitive materials. Representative examples of these color photographic light-sensitive materials include color negative films for motion picture, color reversal films for slide or television, color paper, color positive films, and color reversal paper. The invention can be preferably used in color duplication films as well.

Proper support materials which can be used in the invention are disclosed in the above cited RD. No. 17643, page 28, RD. No. 18716, right column on page 647—left column on page 648, and RD. No. 307105, page 879.

In the photographic light-sensitive material of the invention, the total thickness of all the hydrophilic colloidal layers on the emulsion side is preferably 28 μm or less, more preferably 23 μm or less, even more preferably 18 μm or less, particularly 16 μm or less. The photographic light-sensitive material of the invention also preferably exhibits a film swelling rate T_{1/2} of 30 seconds or less, more preferably 20 seconds or less. The term “thickness” as used herein is meant to indicate the thickness of the film which has been conditioned at 25° C. and a relative humidity of 55% for 2 days.

The film swelling rate T_{1/2} can be measured by any method known in the art. For the measurement of film swelling rate T_{1/2}, a swellometer of the type disclosed in A. Green et al, “Photographic Science & Engineering”, vol. 19, No. 2, pp. 124-129 can be used. T_{1/2} is defined by the time required to reach 1/2 of the saturated film thickness wherein the saturated film thickness is 90% of the maximum wet thickness reached after 3 minutes and 15 seconds of processing with the color developer at 30° C.

The film swelling rate T_{1/2} can be adjusted by adding a hardener to gelatin as a binder or changing the aging conditions after coating.

The photographic light-sensitive material according to the invention preferably comprises a hydrophilic colloidal layer (referred to as “back layer”) having a total dried thickness of from 2 μm to 20 μm provided on the side thereof opposite the emulsion layer. The back layer preferably comprises the aforementioned light-absorbing agent, filter dye, ultraviolet absorber, antistatic agent, hardener, binder, plasticizer, lubricant, coating aid and surface active agent incorporated therein. The back layer preferably exhibits a percent swelling of from 150% to 500%.

The color photographic light-sensitive material according to the invention can be subjected to development according to ordinary method disclosed in the above cited RD. No. 17643, pp. 28-29, RD. No. 18716, left column to right column on page 651 and RD. No. 307105, pp. 880-881.

The color developer to be used in the development of the photographic light-sensitive material of the invention is preferably an alkaline aqueous solution containing an aromatic primary amine-based color developing agent as a main component. As such a color developing agent there nay be used an aminophenol-based compound, preferably a p-phenylenediamine-based compound. Representative examples of such a compound include 3-methyl-4-amino-N, N-diethylaniline, 3-methyl-4-amino-N-ethyl-N-β-hydroxy-ethylaniline, 3-methyl-4-amino-N-ethyl-N-β-methane-sulfonamideethylaniline, 3-methyl-4-amino-N-ethyl-β-methoxyethylaniline, and sulfate, hydrochloride and p-toluenesulfonate thereof. Particularly preferred among these compounds is sulfate of 3-methyl-4-amino-N-ethyl-N-β-hydroxyethylaniline. These compounds may be used in combination of two or more of them according to need.

The color developer normally comprises a pH buffer such as carbonate, borate and phosphate of alkaline metal or a development inhibitor or fog inhibitor such as chloride, bromide, iodide, benzimidazole, benzothiazole and mercapto compound incorporated therein. If necessary, various preservatives such as hydroxylamine, diethyl hydroxylamine, sulfite, hydrazine (e.g., N,N-biscarboxymethylhydrazine), phenylsemicarbazide, triethanolamine and catecholsulfonate, organic solvents such as ethylene glycol and diethylene glycol, development accelerators such as benzyl alcohol polyethylene glycol, quaternary ammonium salt and amine, dye-forming coupler, competitive coupler, auxiliary developing agents such as 1-phenyl-3-pyrazolidone, tackifiers, and various chelating agents such as aminopolycarboxylic acid, aminopolyphosphonic acid, alkylphosphonic acid and phosphonocarboxylic acid may be used. Representative examples of the chelating agent employable herein include ethylenediaminetetraacetic acid, nitriletriacetic acid, diethylenetriaminepentaacetic acid, cyclohexanediaminetetraacetic acid, hydroxyethyliminodiacetic acid, 1-hydroxyethylidene-1, 1-diphosphonic acid, nitrilo-N,N,N-trimethylenephosphonic acid, ethylenediamine-N,N,N,N-tetramethylenephosphonic acid, ethylenediamine-di(o-hydroxyphenlacetic acid), and salts thereof.

In the case where reversal processing is conducted, color development is normally preceded by black-and-white development. The black-and-white developer may comprise known black-and-white developing agents such as dibydroxybenzenes (e.g, hydroquinone), 3-pyrazolidones (e.g., 1-phenyl-3-pyrazolidone) and aminophenols (e.g., N-methyl-p-aminophenol) incorporated therein singly or in combination. These color developers and black-and-white developers each normally have a pH value of from 9 to 12. Though depending on the color photographic light-sensitive material to be processed, the replenishment rate of these developers is normally 3 l (hereinafter occasionally represented by “L”) or less per m₂ of photographic light-sensitive material. By reducing the concentration of bromide ions in the, replenisher, the replenishment rate of these developers can be predetermined to be 500 ml (hereinafter occasionally represented by “mL”) or less. In the case where the replenishment rate of these developers is reduced, the contact area of the processing solution with air is preferably reduced to inhibit the evaporation and air oxidation of the processing solution.

The contact area of the photographic processing solution with air can be represented by the percent opening defined below.

Percent opening=[Contact area (cm²) of processing solution with air]/[Volume (cm³) of processing solution]

The aforementioned percent opening is preferably 0.1 or less, more preferably from 0.001 to 0.05. As a method for reducing the percent opening there may be used a method involving the provision of a shield such as floating cover on the surface of the processing solution in the processing tank. Other examples of such a method include a method involving the use of a mobile cover as disclosed in JP-A-1-82033, and a slit development method as disclosed in JP-A-63-216050. The reduction of percent opening is preferably effected not only in both the color development and black-and-white development steps but also in all the subsequent steps such as bleach, blix, fixing, rinsing and stabilization. Alternatively, a device for inhibiting the accumulation of bromide ions in the developer may be used to reduce the replenishment rate of the developers.

The color development time is normally predetermined to be from 2 to 5 minutes but may be further reduced by effecting the color development with a color developing agent having a high concentration at a high temperature and a pH value.

The photographic emulsion which has been subjected to color development is normally subjected to bleach. Bleach may be effected simultaneously with or separately of fixing (The former processing is called blix). In order to further expedite the processing, bleach may be followed by blix. Alternatively, processing may be effected in a blix bath comprising two continuous baths. Fixing may be preceded by blix. Further, blix may be followed by bleach. These processings may be arbitrarily effected depending on the purpose. Examples of bleaching agents employable herein include compounds of polyvalent metal such as iron (III), peroxides (in particular, sodium persulfate is suitable for color negative film for motion picture), quinones, and nitro compounds. Representative examples of bleaching agents employable herein include organic complex salts of iron (III) such as complexes of iron (III) with ethylenediaminetetraacetic acid, diethylenetriaminepentaacetic acid, cyclohexanediamine tetraacetic acid, methyliminodiacetic acid, aminopolycarboxylic acids (e.g., 1,3-diamino propanetetraacetic acid, glycoletherdiamine-tetraacetic acid), citric acid, tartaric acid and malic acid. Preferred among these complexes are complexes of iron (III) with aminopolycarboxylic acid such as ethylenediamine tetraacetic acid and 1,3-diaminopropanetetraacetic acid. Further, complexes of iron (III) with aminopolycarboxylic acid are particularly useful in the bleaching solution as well as the blix solution. The bleaching solution or blix solution comprising these complexes of iron (III) with aminopolycarboxylic acid normally has a pH value of from 4.0 to 8. In order to expedite the processing, the pH value of the bleaching solution or blix solution may be even lower.

The bleaching solution, the blix solution and its prebath may comprise a bleach accelerator incorporated therein as necessary. Specific examples of useful bleach accelerators include compounds having mercapto group or disulfide group as disclosed in U.S. Pat. No. 3,893,858, West German Patents 1,290,812 and 2,059,988, JP-A-53-32736, JP-A-53-57831, JP-A-53-37418, JP-A-53-72623, JP-A-53-95630, JP-A-53-95631, JP-A-53-104232, JP-A-53-124424, JP-A-53-141623 and JP-A-53-18426, and Research Disclosure No. 17129 (July 1978), thiazolidine derivatives as disclosed in JP-A-51-140129, thiourea derivatives as disclosed in JP-B-45-8506, JP-A-52-20832, JP-A-53-32735, and U.S. Pat. No. 3,706,561, iodides as disclosed in West German Patent 1,127,715 and JP-A-58-16235, polyoxyethylene compounds as disclosed in West German Patents 966,410 and 2,748,430, polyamine compounds as disclosed in JP-B-45-8836, compounds as disclosed in JP-A-49-40943, JP-A-49-59644, JP-A-53-94927, JP-A-54-35727, JP-A-55-26506 and JP-A-58-163940, and bromide ion. Preferred among these compounds are compounds having mercapto group or disulfide group because they exert a great bleach accelerating effect. Particularly preferred examples of these compounds include compounds as disclosed in U.S. Pat. No. 3,893,858, West German Patent 1,290,812, and JP-A-53-95630. Further, compounds as disclosed in U.S. Pat. No. 4,552,884 are desirable. These bleach accelerators may be incorporated in the photographic light-sensitive material. These bleach accelerators are useful particularly when a color photographic light-sensitive material for picture taking is subjected to blix.

The bleaching solution or blix solution preferably comprises an organic acid incorporated therein besides the aforementioned compounds for the purpose of inhibiting bleach stain. A particularly preferred organic acid is a compound having an acid dissociation constant (pKa) of from 2 to 5. Specific examples of such an organic acid include acetic acid, propionic acid, and hydroxyacetic acid.

Examples of fixing agents to be incorporated in the fixing solution or blix solution include thiosulfates, thiocyanates, thioether-based compounds, thioureas, and iodides (to be used in a large amount). Among these fixing agents, thiocyanates are normally used. In particular, ammonium thiosulfate is most widely used. These thiosulfates are used in combination with thiocyanates, thioether-based compounds or thioureas. As a preservative for fixing solution or blix solution there may be used a sulfite, a bisulfite, a carbonylbisulfurous acid adduct or a sulfinic acid compound as disclosed in EP294,769A. Further, the fixing solution or blix solution preferably comprises various aminopolycarboxylic acids or organic phosphonic acids incorporated therein for the purpose of stabilizing the processing solution.

In the invention, the fixing solution or blix solution preferably comprises a compound having pKa of from 6.0 to 9.0, preferably imidazole such as imidazole, 1-methylimidazole, 1-ethylimidazole and 2-methylimidazole, incorporated therein in an amount of from 0.1 to 10 mols/L for the purpose of adjusting the pH value thereof.

The total desilvering time is preferably as short as possible so far as no defective desilvering occurs. The total desilvering time is preferably from 1 to 3 minutes, more preferably from 1 to 2 minutes. The processing temperature is from 25° C. to 50° C., preferably from 35° C. to 45° C. When desilvering is effected within a desirable temperature range, the desilvering rate can be raised and the occurrence of stain after processing can be effectively inhibited.

In the desilvering step, it is preferred that agitation be intensified as much as possible. Examples of method for intensifying agitation include a method which comprises causing a jet of processing solution to collide with the emulsion surface of the photographic light-sensitive material as disclosed in JP-A-62-183460, and a method involving the enhancement of stirring effect using a rotary means as disclosed in JP-A-62-183461. Further examples of method for intensifying agitation include a method which comprises moving the photographic light-sensitive material while the emulsion surface thereof being in contact with a wiper blade provided in the processing solution to make the emulsion surface turbulent, raising the stirring effect, and a method involving the increase of the circulating flow rate of the entire processing solution. Such an agitation intensifying method is useful all in the bleaching solution, blix solution and fixing solution. It is thought that the intensification of agitation makes it possible to speed up the supply of the bleaching agent and fixing agent into the emulsion layer, resulting in the enhancement of the desilvering rate. The aforementioned agitation intensifying device is more effective with the use of bleach accelerator. In this case, the effect of accelerating bleach can be remarkably enhanced. Further, the effect of inhibiting fixing can be eliminated by the use of bleach accelerator.

The automatic developing machine Lo be used in the development of the photographic light-sensitive material of the invention preferably has a photographic light-sensitive material conveying unit as disclosed in JP-A-60-191257, JP-A-60-191258; and JP-A-60-191259. As described in the above cited JP-A-60-191257, such a conveying unit can remarkably eliminate the carriage of the processing solution to the processing bath from its prebath, exerting a great effect of inhibiting the deterioration of the properties of the processing solution. This effect is particularly useful to reduce the processing time or replenishment rate of processing solution at the various steps.

The silver halide color photographic material according to the invention is normally subjected to rinsing and/or stabilization after desilvering. The amount of washing water to be used in the rinsing step can be widely predetermined according to the properties (due to materials used such as coupler) and purpose of the photographic light-sensitive material, temperature of washing water, number of rinsing tanks (number of stages), replenishment process (countercurrent or concurrent) and other various conditions. The relationship between the number of rinsing tanks and the amount of water to be used in the multistage countercurrent process can be determined by the method disclosed in “Journal of the Society of Motion Picture and Television Engineers”, vol. 64, pp. 248-253, May 1955.

The multiple countercurrent process disclosed in the aforementioned references makes it possible to drastically reduce the amount of the washing water to be used but is disadvantageous in that the rise of retention time of water in the tank causes proliferation of bacteria that produce suspended materials which are then attached to the photographic light-sensitive material. In order to solve this problem in the processing of the color photographic light-sensitive material of the invention, a method involving the elimination of calcium ions or magnesium ions as disclosed in JP-A-62-288838 may be used. Alternatively, chlorine-based sterilizers such as isothiazolone compound, thiabendazole and chlorinated sodium isocyanurate as disclosed in JP-A-57-8542 and sterilizers such as benzotriazole as disclosed in Hiroshi Horiguchi, “Bokin Bobaizai no Kagaku (Chemistry of Bactericides and Mildew-proofing Agents)”, 1986, Sankyo Shuppan, “Biseibutsu no Mekkin, Sakkin, Boubai Gijutsu (Technique of Sterilization of Microorganism)”, compiled by The Society of Hygienic Technique, 1982, Kogyo Gijutsukai, and “Bokin Bobaizai Jiten (Dictionary of Bactericides and Mildew-proofing Agents)”, compiled by Nihon Bokin Bobai Gakkai, 1986 may be used.

The rinsing water to be used in the processing of the photographic light-sensitive material according to the invention has a pH value of from 4 to 9, preferably from 5 to 8. The rinsing water temperature and rinsing time, too, can be widely predetermined according to the properties and purpose of the photographic light-sensitive material. In general, however, rinsing may be effected at a temperature of from 15° C. to 45° C. for 20 seconds to 10 minutes, preferably at a temperature Of from 25° C. to 40° C. for 30 seconds to 5 minutes. Further, the photographic light-sensitive material of the invention may be processed directly with a stabilizer instead of rinsing. For the stabilization, any of known methods as disclosed in JP-A-57-8543, JP-A-58-14834 and JP-A-60-220345 can be used.

Further, the aforementioned rinsing may be followed by stabilization. Examples of such a stabilization bath include stabilization bath containing a dye stabilizer and a surface active agent used as final bath for color photographic light-sensitive material for picture taking. Examples of the dye stabilizer include aldehydes such as formalin and glutaraldehyde, N-methylol compounds, hexamethylenetetramine, and aldehyde-sulfurous acid adducts. This stabilization bath, too, may comprise various chelating agents or mildewproofing agents incorporated therein.

The overflow solution produced with the replenishment of the rinsing solution and/or stabilizer can be re-used at other steps such as desilvering step.

For example, in the case where the aforementioned various processing solutions are concentrated by evaporation in the processing using an automatic developing machine, it is preferred that water be added to correct for concentration.

The silver halide color photographic light-sensitive material according to the invention may comprise a color developing agent incorporated therein for the purpose of simplifying and speeding up the processing. To this end, the color developing agent is preferably used in the form of various precursors. Examples of these compounds include indoaniline-based compounds as disclosed in U.S. Pat. No. 3,342,597, Schiff's base type compounds as disclosed in Research Disclosure Nos. 14,850 and 15,159, aldol compounds as described in Research Disclosure No. 13,924, metal complexes as disclosed in U.S. Pat. No. 3,719,492, and urethane-based compounds as disclosed in JP-A-53-135628.

The silver halide color photographic light-sensitive material according to the invention may comprise various 1-phenyl-3-pyrazolidones incorporated therein as necessary for the purpose of accelerating color development. Representative examples of these compounds include those disclosed in JP-A-56-64339, JP-A-57-144547, and JP-A-58-115438.

The various processing solutions according to the invention are used at a temperature of from 10° C. to 50° C. In general, the normal processing temperature is from 33° C. to 38° C. However, the processing temperature maybe raised to accelerate processing and hence reduce processing time. On the contrary, the processing temperature may be lowered to improve the image quality or the stability of the processing solution.

The photographic light-sensitive material according to the invention can be applied also to heat-developable photographic light-sensitive material as disclosed in U.S. Pat. No. 4,500,626, J-A-60-133449, JP-A-59-218443, JP-A-61-238056, and EP 210660A2.

The photographic light-sensitive material according to the invention can exert its effect more easily when applied to film units with lens as disclosed in JP-B-2-32615, JP-UM-B-3-39784.

The use of the preparation process of the invention made it possible to effectively prepare monodisperse silver halide fine grains having a controlled size. At the same time, the use of this preparation process made it possible to prepare a high sensitivity emulsion of large size silver halide tabular grains which are foggable to the same extent as ever without increasing the thickness of the tabular grains.

The invention will be further described in the following examples. However, the invention is not limited to these examples.

### EXAMPLE 1

The process for the preparation of the emulsion of fine grains of the invention will be further described hereinafter.

(Preparation of Emulsion A)

1,000 mL of an aqueous solution of AgNO₃ (137 g) and an aqueous solution of KBr in an amount equimolecular with AgNO₃ and a low molecular oxidized gelatin having an average molecular weight of 15,000 (200 g) (containing 3 mol % of KI) were charged in a mixer comprising a closed agitation tank agitated by two or more rotary axes as shown in FIG. 2 at a rate of 1.9 g/min and 1.4 g/min, respectively, to prepare unripened silver halide fine grains. The two aqueous solutions each had a temperature of 25° C. Referring to the rotary speed of the mixer, the upper impellor blade was rotated at a rate of 10,000 rpm while the lower impellor blade was rotated at a rate of 6,500 rpm. The agitation tank of the mixer had a capacity of 0.1 mL. The unripened fine grains were transferred through a transferring pipe (inner diameter: 2 mm; total length: 0.3 m) which had been controlled no to ripen the grains into a ripening device of the invention where they were then subjected to continuous ripening at 50° C. for 5 minutes. As the feed pipe in the ripening device (pipe line) there was used one having an inner diameter of 3 mm made of Teflon. The resulting ripened fine grains had a number-average equivalent circle diameter of 26 nm, coefficient of variation in equivalent circle diameter of 10% and a percent twinning of 6%.

(Preparation of Emulsion B)

The unripened fine grains which had been prepared using a mixer under the aforementioned conditions were examined. As a result, the unripened fine grains had a number-average equivalent circle diameter of 17 nm, coefficient of variation in equivalent circle diameter of 36% and a percent twinning of 6%.

(Preparation of Emulsion C)

985 mL of an aqueous solution containing 1.2 g of KBr and 10 g of a gelatin having an average molecular weight of 100,000 was vigorously stirred while being kept at 40° C. The temperature of the aqueous solution was then lowered to 30° C. To the aqueous solution was then added 1.52 mL of Emulsion B. Thereafter, to the mixture were then added 3.5 mL of an aqueous solution of AgNO₃ (0.15 g) and 3.5 mL of an aqueous solution of KBr (0.14 g) by a double jet process. The resulting fine grains had an average equivalent circle diameter of 26 nm, coefficient of variation in equivalent circle diameter of 25% and a percent twinning of 6%.

The results are set forth in Table 1. As can be seen in the results of Table 1, the use of continuous mixers and ripening devices of the invention makes it possible to obtain drastically monodispersed fine grains as compared with the single use of a mixer. The fine grains of the invention are monodisperse also as compared with Emulsion C, which was obtained by subjecting Emulsion B to critical growth up to the same size as that of the fine grains of the invention.

TABLE 1

| | | Number- | | | |
|---|---|---|---|---|---|
| | | average | % Coefficient of | | |
| | | equivalent | variation in | | |
| | Continuous | circle diameter | equivalent circle | | |
| Emulsion | ripening | (nm) | diameter | % Twinning | Remarks |
| A | Presence | 26 | 10 | 6 | Invention |
| B | Absence | 17 | 36 | 6 | Comparison |
| C | Absence | 26 | 25 | 6 | Comparison |

(Preparation of Emulsion D)

934 mL of an aqueous solution containing 0.9 g of KBr and 1.68 g of a gelatin having an average molecular weight of 20,000 was vigorously stirred while being kept at 5° C. Thereafter, to the aqueous solution were then added 320 mL of an aqueous solution of AgNO₃ (1.2 g) and 320 mL of an aqueous solution of KBr (0.53 g) in 4 minutes by a double jet process. The mixture was stirred for 90 minutes. The stirring was then suspended. The resulting fine grains had an average equivalent circle diameter of 26 nm and coefficient of variation in equivalent circle diameter of 16%.

(Preparation of Emulsion E)

Fine grains were formed in the same manner as Emulsion D except that the emulsion was stirred at 20° C. for 90 minutes. The resulting fine grains had a number-average equivalent circle diameter of 34 nm and coefficient of variation in equivalent circle diameter of 10%.

The results are set forth in Table 2. In the case where batchwise preparation is effected, when nucleation and ripening are effected at 5° C., fine grains having the same size as in the continuous process of the invention are obtained. However, the low temperature process renders the emulsion monodisperse slowly and thus cannot give an emulsion which is not so monodisperse as Emulsion A, which is a monodisperse fine grain emulsion of the invention. In the case where nucleation is effected under the same conditions as Emulsion D but ripening is effected at 20° C., the resulting emulsion is as monodisperse as Emulsion A, which is a monodisperse fine grain emulsion of the invention, but has a far greater size than that of Emulsion A. In other words, the preparation of fine grains according to the method of the invention makes it possible to obtain an emulsion which is monodisperse within a small size range which has heretofore been difficultly attained in the batchwise process, at short times.

TABLE 2

| | | | Number- | | |
|---|---|---|---|---|---|
| | | | average | % Coefficient | |
| | Nucleation | Ripening | equivalent | of variation in | |
| | temperature | temperature | circle diameter | equivalent | |
| Emulsion | (° C.) | (° C.) | (nm) | circle diameter | Remarks |
| A | 25 | 50 | 26 | 10 | Invention |
| D | 5 | 5 | 26 | 16 | Comparison |
| E | 5 | 20 | 34 | 10 | Comparison |

### EXAMPLE 2

The process for the preparation of the emulsion of the invention will be described in detail hereinafter.

(Preparation of Emulsion a)

1,192 mL of an aqueous solution containing 0.9 g of KBr and 1.7 g of a low molecular oxidized gelatin having an average molecular weight of 15,000 was vigorously stirred while being kept at 35° C. To the aqueous solution were then added 25.4 ml of an aqueous solution of AgNO₃ (0.1 g) and 45.1 cc of an aqueous solution containing KBr (0.24 g) and a low molecular oxidized gelatin having an average molecular weight of 15,000 in 49 seconds by a double jet process. After the termination of ripening, to the emulsion was added 30.1 g of phthalated gelatin.

Subsequently, in order to cause first growth, silver bromoidode fine grains (number-average equivalent circle diameter: 0.025 μm; coefficient of variation in equivalent circle diameter: 11%; proportion of twin grains: 1%) which had been prepared by charging 700.7 ml of an aqueous solution of AgNO₃ (10.67 g) and an aqueous solution containing KI and a low molecular oxidized gelatin having a molecular weight of 15,000 into a device shown in FIG. 5 comprising a mixer free of rotary shaft piercing the wall of a closed agitation tank which allows impellor blades connected by a magnetic coupling to rotate in opposite directions and a piping which can be temperature-controlled to cause continuous ripening were continuously charged into a reaction vessel. The preparation of the fine grains was carried out by ripening the fine grains prepared in the mixer of the device in the temperature-controlled piping in the device. The unripened fine grains had a number-average equivalent circle diameter of 0.011 μm, coefficient of variation in equivalent circle diameter of 35% and a percent twinning of 1%. The ripening of the grains was conducted at 50° C. for 5 minutes. During this procedure, the pBr value in the reaction vessel was kept at 2.7. Thereafter, the solution was bailed out of the reaction vessel to keep the liquid volume at 600 ml. Subsequently, in order to cause second growth, silver bromoidode fine grains (number-average equivalent circle diameter: 0.027 μm; coefficient of variation in equivalent circle diameter: 11%; proportion of twin grains: 1%) which had been prepared by charging 1,179.4 ml of an aqueous solution of AgNO₃ (39.8 g) and an aqueous solution containing KBr, KI and a low molecular oxidized gelatin having a molecular weight of 15,000 into the fine grain preparation device similar to that of first growth were continuously charged into the reaction vessel. During the preparation of the fine grains, the unripened fine grains had a number-average equivalent circle diameter of 0.012 μm, coefficient of variation in equivalent circle diameter of 36% and a percent twinning of 1%. The ripening of the grains was conducted at 50° C. for 5 minutes. During this procedure, the pBr value in the reaction vessel was kept at 2.7. Thereafter, an epitaxial portion was formed by the method described in JP-A-2001-235821. At this time, sensitizing dyes I, II and III were added before the formation of the epitaxial portion. During the epitaxial formation, potassium hexacyanorutheniumate (II) was added such that the chemically-sensitize, emulsion attained maximum 1/100 sensitivity.

Thereafter, the emulsion was rinsed by an ordinary flocculation method. Subsequently, to the emulsion were added potassium thiocyanate, chloroauric acid, sodium thiosulfate and N,N-dimethylselenourea to cause optimum chemical sensitization.

The emulsion a thus prepared comprised tabular grains having coefficient of variation in equivalent circle diameter of 25%, a number-average equivalent circle diameter of 5.64 pin and a number-average thickness of 0.043 μm. In some detail, these tabular grains were hexagonal tabular grains 90% or more of which as calculated in terms of projected area have a longest side length-to-shortest side length ratio of 1.5 or less and have an epitaxial junction all at six tops. As a result of observation under transmission electron microscope at low temperature, 90% or more of all the grains as calculated in terms of projected area are free of dislocation line on the main planes other than the epitaxial portions and have networked dislocation lines on the epitaxial portions. The content of the epitaxial portion is 9.1% as calculated in terms of silver and the composition of the epitaxial portion is AgBr (52) Cl (40) I (8). 90% or more all the grains as calculated in terms of projected area fall within ±30% from the average silver chloride content and average silver iodide content.

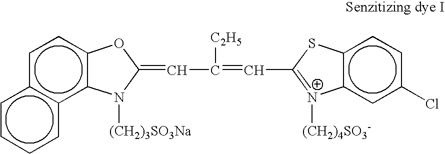

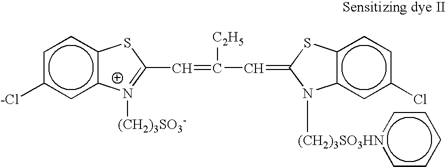

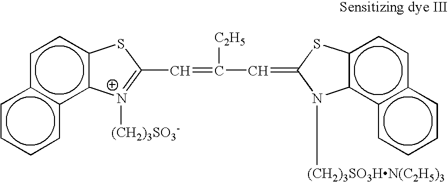

(Preparation of Emulsion b)

1,192 mL of an aqueous solution containing 0.9 g of KBr and 1.7 g of a low molecular oxidized gelatin having an average molecular weight of 15,000 was vigorously stirred while being kept at 35° C. To the aqueous solution were then added 25.4 ml of an aqueous solution of AgNO₃ (0.1 g) and 45.1 cc of an aqueous solution containing KBr (0.24 g) and a low molecular oxidized gelatin having an average molecular weight of 15,000 in 49 seconds by a double jet process. After the termination of ripening, to the emulsion was added 30.1 g of phthalated gelatin.

Subsequently, in order to cause first growth, silver bromoidode fine grains (number-average equivalent circle diameter: 0.025 μm; coefficient of variation in equivalent circle diameter: 11%; proportion of twin grains: 1%) which had been prepared by charging 700.7 ml of an aqueous solution of AgNO₃ (10.67 g) and an aqueous solution containing KBr, KI and a low molecular oxidized gelatin having a molecular weight of 15,000 into a device comprising a mixer free of rotary shaft piercing the wall of a closed agitation tank which allows impellor blades connected by a magnetic coupling to rotate in opposite directions and a piping which can be temperature-controlled to cause continuous ripening were continuously charged into a reaction vessel. The preparation of the fine grains was carried out by ripening the fine grains prepared in the mixer of the device in the temperature-controlled piping in the device. The unripened fine grains had a number-average equivalent circle diameter of 0.011 μm, coefficient of variation in equivalent circle diameter of 35% and a percent twinning of 1%. The ripening of the grains was conducted at 50° C. for 5 minutes. During this procedure, the pBr value in the reaction vessel was kept at 2.7. Subsequently, in order to cause second growth, silver bromoidode fine grains (number-average equivalent circle diameter: 0.027 μm; coefficient of variation in equivalent circle diameter: 11%; proportion of twin grains: 2%) which had been prepared by charging 1,525.3 ml of an aqueous solution of AgNO₃ (209.2 g) and an aqueous solution containing KBr, KI and a low molecular oxidized gelatin having a molecular weight of 15,000 into the fine grain preparing device similar to that of first growth were continuously charged into the reaction vessel. During the preparation of the fine grains, the unripened fine grains had a number-average equivalent circle diameter of 0.013 μm, coefficient of variation in equivalent circle diameter of 35% and a percent twinning of 2%. The ripening of the grains was conducted at 50° C. for 5 minutes. During this procedure, the pBr value in the reaction vessel was kept at 2.7. The second growth was accompanied by ultrafiltration. As the ultrafiltration module for the ultrafiltration device there was used Nove Series of flat membrane centramate made of pole (molecular weight cut off: 30,000). During this procedure, the reflux flow rate was 1 l/min. The feed pressure was 0.09 MPa. The reflux pressure was 0.05 MPa. The osmotic pressure was 0 MPa. At the end of the second growth, the volume of the solution was 3,000 ml. Thereafter, an epitaxial portion was formed by the method described in JP-A-2001-235821. Before the formation of epitaxial portion, sensitizing dyes I, II and III were added. During the epitaxial formation, potassium hexacyanorutheniumate (II) was added such that the chemically-sensitized emulsion attained maximum 1/100 sensitivity. Thereafter, the emulsion was subjected to rinsing and chemical sensitization in the same manner as Emulsion a. The emulsion b thus prepared comprised tabular grains having coefficient of variation in equivalent circle diameter of 24%, a number-average equivalent circle diameter of 5.57 μm and a number-average thickness of 0.044 μm.

(Preparation of Emulsion c)

Emulsion c was prepared in the same manner as Emulsion a except that the second growth was effected in the following manner.

In order to cause second growth, silver bromoidode fine grains (number-average equivalent circle diameter: 0.013 μm; coefficient of variation in equivalent circle diameter: 35%; proportion of twin grains: 2%) which had been prepared by charging 1,179.4 ml of an aqueous solution of AgNO₃ (39.8 g) and an aqueous solution containing KBr, KI and a low molecular oxidized gelatin having a molecular weight of 15,000 into a device shown in FIG. 2 comprising a mixer free of rotary shaft piercing the wall of a closed agitation tank which allows impellor blades connected by a magnetic coupling to rotate in opposite directions were charged into a reaction vessel. During this procedure, the pBr value in the reaction vessel was kept at 2.7. Thereafter, the emulsion preparation procedure of Emulsion a was followed. The emulsion c thus prepared comprised tabular grains having coefficient of variation in equivalent circle diameter of 26%, a number-average equivalent circle diameter of 4.73 μm and a number-average thickness of 0.061 μm.

(Preparation of Emulsion d)

Emulsion d was prepared in the same manner as Emulsion a except that the second growth was effected in the following manner.

In order to cause second growth, fine grains f1 for growth which had been prepared in the following manner were charged into the reaction vessel where they were then ripened at 75° C. until they were dissolved. During this procedure, the pBr value in the reaction vessel was kept at 2.7. Thereafter, the emulsion preparation procedure of Emulsion a was followed.

The fine grains f1 for growth were obtained by adding 960 cc of an aqueous solution of AgNO₃ (288 g) and an aqueous solution containing KBr and KI to 1,200 ml of an aqueous solution containing 0.2 g of KBr and 90 g of a low molecular oxidized gelatin having an average molecular weight of 15,000 in a reaction vessel as described in JP-B-55-10545 in 12 minutes by a controlled double jet process while the pBr value of the mixture was being kept at 2.55 and the temperature of the latter aqueous solution was being kept at 20° C. to prepare fine grains f0 (number-average equivalent circle diameter: 32 nm; coefficient of variation in equivalent circle diameter: 18%), and then subjecting the fine grains f0 to ripening at 5° C. for 5 days. The fine grains f1 thus prepared had a number-average equivalent circle diameter of 36 nm and coefficient of variation in equivalent circle diameter of 11%.

Emulsion d thus prepared comprised tabular grains having coefficient of variation in equivalent circle diameter of 26%, a number-average equivalent circle diameter of 5.67 μm and a number-average thickness of 0.043 μm.

(Preparation of Emulsion e)

Emulsion e was prepared in the same manner as Emulsion a except that the second growth was effected in the following manner.

In order to cause second growth, fine grains f2 for growth which had been prepared in the following manner were charged into the reaction vessel where they were then ripened at 75° C. until they were dissolved. During this procedure, the pBr value in the reaction vessel was kept at 2.7. Thereafter, the emulsion preparation procedure of Emulsion a was followed.

The fine grains f2 for growth were obtained by adding 960 cc: of an aqueous solution of AgNO₃ (288 g) and an aqueous solution containing KBr and KI to 1,200 ml of an aqueous solution containing 0.2 g of KBr and 90 g of a low molecular oxidized gelatin having an average molecular weight of 15,000 in the reaction vessel as described in JP-B-55-10545 in 36 minutes by a controlled double jet process while the pBr value of the mixture was being kept at 2.55 and the temperature of the latter aqueous solution was being kept at 20° C. The fine grains f2 thus prepared had a number-average equivalent circle diameter of 36 nm and coefficient of variation in equivalent circle diameter of 17%.

Emulsion e thus prepared comprised tabular grains having coefficient of variation in equivalent circle diameter of 26%, a number-average equivalent circle diameter of 5.50 μm and a number-average thickness of 0.044 μm. Emulsion e had part of the fine grain for growth left undissolved therein.

The properties of Emulsions a, b, c, d and e are set forth in Table 3 below. AS can be seen in the results of Table 3, the preparation process of the invention makes it possible to efficiently prepare thinner large-sized tabular grains without leaving the fine grains undissolved therein.

TABLE 3

| | | Number- | | % Coefficient | | | |
|---|---|---|---|---|---|---|---|
| | | average | | of variation in | | | |
| | | equivalent | Number- | equivalent | | | |
| | Use of | circle | average | circle | | Fine | |
| | ultra- | diameter | thickness | diameter of | Silver | grains | |
| Emulsion | filtration | (μm) | (μm) | all grains | content | left | Remarks |
| a | Absence | 5.64 | 0.043 | 25 | 100 | Absence | Invention |
| b | Presence | 5.57 | 0.044 | 24 | 414 | Absence | Invention |
| c | Absence | 4.73 | 0.061 | 26 | 100 | Absence | Comparison |
| d | Absence | 5.67 | 0.043 | 26 | 284 | Absence | Invention |
| e | Absence | 5.50 | 0.044 | 26 | 284 | Absence | Comparison |

*Silver content per unit volume is represented relative to that of Emulsion a as 100.

The chemically-sensitized Emulsions a to e were each spread over a cellulose triacetate film support having an undercoat layer provided thereon with a protective layer provided interposed therebetween under conditions as set forth below to prepare Sample Nos. 801, 802, 803, 804 and 805.

(1) Emulsion Layer

Emulsion: Various emulsions (silver content:

2.1×10⁻² mol/m²)

Coupler (1.5×10⁻³ mol/m²) 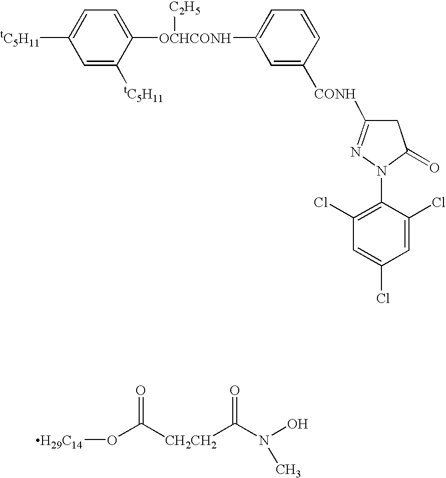 (1.1×10⁻¹ mol/m²)

Tricresyl phosphate (1.10 g/m²)

Gelatin (2.30 g/m²)

(2) Protective Layer

2,4-Dichloro-6-hydroxy-s-triazine sodium (0.08 g/m²)

Gelatin (1.80 g/m²)

These samples were each then exposed to light through a Type SC-50 gelatin filter (produced by Fuji Photo film Co., Ltd.) and a continuous wedge for 1/100 seconds.

Using a Type FP-350 negative processor (produced by Fuji Photo film Co., Ltd.), these samples were each then processed under the following conditions (until the accumulated replenishment of processing solution reached three times the volume of the mother liquor tank).

(Processing Method)

| | Processing | Processing | Replenishment |
|---|---|---|---|
| Step | time | temperature | rate* |
| Color | 3 m. 15 s. | 38° C. | 45 ml |
| development | | | |
| Bleach | 1 m. 00 s. | 38° C. | 20 ml |
| | | | (The overflow |
| | | | from the |
| | | | bleaching bath is |
| | | | all allowed to |
| | | | flow in the blix |
| | | | bath) |
| Blix | 3 m. 15 s. | 38° C. | 30 ml |
| Rinse (1) | 40 s. | 35° C. | Countercurrent |
| | | | piping system |
| | | | from (2) to (1) |
| Rinse (2) | 1 m. 00 s. | 35° C. | 30 ml |
| Stabilization | 40 s. | 38° C. | 20 ml |
| Drying | 1 m. 15 s. | 55° C. | |

*Replenishment rate is represented per 35 mm width and 1.1 m length (corresponding to one 24Ex.)

The formulation of the processing solutions will be given below.

| | Running | |
|---|---|---|
| | solution | |
| (Color developer) | (g) | Replenisher (g) |
| Diethylenetriaminepentaacetic acid | 1.0 | 1.1 |
| 1-Hydroxyethylidene-1,1-diphosphonic acid | 2.0 | 2.0 |
| Sodium sulfite | 4.0 | 4.4 |
| Potassium carbonate | 30.0 | 37.0 |
| Potassium bromide | 1.4 | 0.7 |
| Potassium iodide | 1.5 mg | — |
| Hydroxyaminesulfate | 2.4 | 2.8 |
| 4-[N-ethyl-N-(β-hydroxyethyl) amino]- | 4.5 | 5.5 |
| 2-methylaniline sulfate | | |
| Water to make | 1.01 | 1.01 |
| pH (adjusted with potassium | 10.05 | 10.10 |
| hydroxide and sulfuric acid) | | |

| | (unit: g (common to running |
|---|---|
| (Bleaching solution) | solution and replenisher)) |
| Ammonium ethylenediaminetetraacetato | 120.0 |
| ferrate dihydrate | |
| Disodium ethylenediaminetetraacetate | 10.0 |
| Ammonium bromide | 100.0 |
| Ammonium nitrate | 10.0 |
| Bleach accelerator | 0.005 mol |
| (CH₃)₂N—CH₂—CH₂—S—S— | |
| CH₂—CH₂—N(CH₃)₂.2HCl | |
| Aqueous ammonia (27%) | 15.0 ml |
| Water to make | 1.0 l |
| pH (adjusted with aqueous | 6.3 |
| ammonia and nitric acid) | |

| | Running | |
|---|---|---|
| | solution | |
| (Blix solution) | (g) | Replenisher (g) |
| Ammonium | 50.0 | — |
| ethylenediaminetetraacetato | | |
| ferrate dihydrate | | |
| Disodium | 5.0 | 2.0 |
| ethylenediaminetetraacetate | | |
| Sodium sulfite | 12.0 | 20.0 |
| Aqueous solution of | 240.0 ml | 400.0 ml |
| ammonium thiosulfate (700 g/l) | | |
| Aqueous ammonia (27%) | 6.0 ml | — |
| Water to make | 1.0 l | 1.0 l |
| pH (adjusted with aqueous | 7.2 | 7.3 |
| ammonia and acetic acid) | | |

(Rinsing solution) (unit: g (common to running solutionand replenisher))

Tap water was passed through a mixed bed column filled with an H type strongly acidic cation exchange resin (Amberlite IR-120B, produced by Rohm & Haas Inc.) and an OH type anion exchange resin (Amberlite IR-400, produced by Rohm & Haas Inc.) to reduce the calcium and magnesium ion concentrations to 3 mg/l or less. Subsequently, to the tap water thus processed were added 20 mg/l of sodium isocyanurate dichloride and 0.15 g/l of sodium sulfate. The rinsing solution thus obtained had a pH value of from 6.5 to 7.5.

(Stabilizer) (Unit: g (Common to Running Solution and Replenisher))

| | |
|---|---|
| Sodium p-toluenesulfinate | 0.03 |
| Polyoxyethylene-p-monononylphenylether | 0.2 |
| (average polymerization degree: 10) | |
| Disodium ethylenediaminetetraacetate | 0.05 |
| 1,2,4-Triazole | 1.3 |
| 1,4-Bis(1,2,4-triazole-1-ilmethyl) piperadine | 0.75 |
| Water to make | 1.0 l |
| pH | 8.5 |

The samples thus processed were each then measured for density through a green filter. The sensitivity at a density of fog plus 0.2 and the fog thus measured are set forth in Table 4.

TABLE 4

| Sample No. | Emulsion | Fogging | Sensitivity | Remarks |
|---|---|---|---|---|
| 801 | a | 0.22 | 130 | Invention |
| 802 | b | 0.22 | 129 | Invention |
| 803 | c | 0.24 | 100 | Comparison |
| 804 | d | 0.22 | 130 | Invention |
| 805 | e | 0.23 | 124 | Comparison |

*Sensitivity is represented relative to that of Sample No.

Sensitivity is represented relative to that of Sample No. 803 as 100.

As can be seen in the results of Table 4, the preparation method of the invention makes it possible to obtain a high sensitivity emulsion.

### EXAMPLE 3

The effect of the emulsions prepared by the preparation method of the invention on multilayer color photographic light-sensitive material will be described hereinafter. The properties of silver halide emulsions Em-A to P are set forth in Table 5 below.

TABLE 5-1
(Grain properties of silver halide emulsions Em-A to O)

| | | | | Average projected | Average thickness | |
|---|---|---|---|---|---|---|
| | | | Average diameter as | area diameter (μm)/ | (μm)/ | Average |
| Emulsion | Layer in which emulsion is | | calculated in term of | % Coefficient of | % Coefficient of | aspect |
| No. | incorporated | Grain form | sphere (μm) | variation | variation | ratio |
| Em-A | High sensitivity | (111) main plane | 1.6 | 5.2/26 | 0.101/29 | 51 |
| | blue-sensitive layer | tabular grain | | | | |
| Em-B | Low sensitivity | (111) main plane | 0.9 | 2.3/19 | 0.092/23 | 25 |
| | blue-sensitive layer | tabular grain | | | | |
| Em-C | Low sensitivity | (111) main plane | 0.5 | 0.9/18 | 0.103/19 | 8.7 |
| | blue-sensitive layer | | | | | |
| Em-D | Low sensitivity | (100) main plane | 0.2 | 0.2/7 | 0.2/7 | 1 |
| | blue-sensitive layer | cubic grain | | | | |
| Em-E | Layer giving interimage | (111) Main plane | 1.1 | 3.0/18 | 0.099/16 | 30 |
| | effect on red-sensitive layer | tabular grain | | | | |
| Em-F | High sensitivity | (111) Main plane | 1.2 | 6.0/18 | 0.032/16 | 188 |
| | green-sensitive layer | tabular grain | | | | |
| Em-G | Middle sensitivity | (111) Main plane | 0.9 | 3.8/23 | 0.034/17 | 112 |
| | green-sensitive layer | tabular grain | | | | |
| Em-H | Low-middle sensitivity | (111) Main plane | 0.6 | 1.8/20 | 0.044/13 | 41 |
| | green-sensitive layer | tabular grain | | | | |
| Em-I | Low sensitivity | (111) Main plane | 0.5 | 1.2/21 | 0.058/13 | 21 |
| | green-sensitive layer | tabular grain | | | | |
| Em-J | Low sensitivity | (111) Main plane | 0.4 | 1.0/17 | 0.043/12 | 23 |
| | green-sensitive layer | tabular grain | | | | |
| Em-K | High sensitivity | (111) Main plane | 1.2 | 5.4/18 | 0.040/15 | 135 |
| | red-sensitive layer | tabular grain | | | | |
| Em-L | Middle sensitivity | (111) Main plane | 0.9 | 3.6/23 | 0.038/16 | 95 |
| | red-sensitive layer | tabular grain | | | | |
| Em-M | Low-middle sensitivity | (111) Main plane | 0.6 | 1.5/20 | 0.064/12 | 23 |
| | red-sensitive layer | tabular grain | | | | |
| Em-N | Low sensitivity | (111) Main plane | 0.4 | 0.9/17 | 0.053/11 | 17 |
| | red-sensitive layer | tabular grain | | | | |
| Em-O | Low sensitivity | (111) Main plane | 0.3 | 0.7/18 | 0.037/10 | 19 |
| | red-sensitive layer | tabular grain | | | | |

TABLE 5-1

| | | | % Silver content and halogen composition of grain structure |
|---|---|---|---|
| | % Proportion of average grains in | Characteristics of grains accounting | (represented in the order close to core)(The figure in angle |
| Emulsion No. | total projected area | 70% or more of total projected area | bracket indicates the value in epitaxial junction) |
| Em-A | 97 | High density dislocation line in fringe | (1%)AgBr/(10%)AgBr₉₀l₁₀/ |
| | | | (60%)AgBr₈₅l₁₅/(12%)AgBr/ |
| | | | (4%)Agl/(13%)AgBr |
| Em-B | 99 | ″ | (1%)AgBr/(20%)AgBr₉₀l₁₀/ |
| | | | (50%)AgBr₈₅l₁₅/(6%)AgBr/ |
| | | | (3%)Agl/(19%)AgBr |
| Em-C | 99 | High density dislocation line in fringe | (15%)AgBr/(40%)AgBr₉₇l₃/ |
| | | and main plane | (10%)AgBr/(2%)Agl/(33%)AgBr |
| Em-D | 0 | Free of dislocation line | (35%)AgBr/(25%)AgBr₉₀l₁₀/ |
| | | | (1%)Agl/(39%)AgBr |
| Em-E | 96 | High density dislocation line in fringe | (8%)AgBr/(35%)AgBr₉₇l₃/ |
| | | | (15%)AgBr/(4%)Agl/(38%)AgBr |
| Em-F | 99 | Hexagonal tabular grain with perfect | (7%)AgBr/(66%)AgBr₉₇l₃/ |
| | | epitaxial junction at six tops | (25%)AgBr₈₆l₁₄/(2%)<AgBr₆₀Cl₃₀l₁₀> |
| Em-G | 99 | Hexagonal tabular grain with perfect | (15%)AgBr/(67%)AgBr₉₇l₃/ |
| | | epitaxial junction at six tops | (15%)AgBr₉₃l₇/(3%)<AgBr₇₀Cl₂₅l₅> |
| Em-H | 99 | Hexagonal tabular grain with perfect | (15%)AgBr/(65%)AgBr₉₉l₁/ |
| | | epitaxial junction at six tops | (15%)AgBr₉₅l₅/(5%)<AgBr₈₃Cl₂₀> |
| Em-I | 97 | Hexagonal tabular grain with perfect | (82%)AgBr/(10%)AgBr₉₅l₅/ |
| | | epitaxial junction at six tops | (8%)<AgBr₇₅Cl₂₀l₅> |
| Em-J | 96 | Hexagonal tabular grain with perfect | (78%)AgBr/(10%)AgBr₉₅l₅/ |
| | | epitaxial junction at one top | (12%)<AgBr₇₅Cl₂₀l₅> |
| Em-K | 99 | Hexagonal tabular grain with perfect | (7%)AgBr/(66%)AgBr₉₇l₃/ |
| | | epitaxial junction at six tops | (25%)AgBr₈₆l₁₄/(2%)<AgBr₆₀Cl₃₀l₁₀> |
| Em-L | 99 | Hexagonal tabular grain with perfect | (15%)AgBr/(67%)AgBr₉₇l₃/ |
| | | epitaxial junction at six tops | (15%)AgBr₉₃l₇/(3%)<AgBr₇₀Cl₂₅l₅> |
| Em-M | 97 | Hexagonal tabular grain with perfect | (15%)AgBr/(65%)AgBr₉₃l₁/ |
| | | epitaxial junction at six tops | (15%)AgBr₉₅l₅/(5%)<AgBr₈₀Cl₂₀> |
| Em-N | 96 | Hexagonal tabular grain with perfect | (78%)AgBr/(10%)AgBr₉₆l₅/ |
| | | epitaxial junction at one top | (12%)<AgBr₇₅Cl₂₀l₅> |
| Em-O | 96 | Hexagonal tabular grain with perfect | (78%)AgBr/(10%)AgBr₉₅l₅/ |
| | | epitaxial junction at one top | (12%)<AgBr₇₀Cl₂₀l₁₀> |

TABLE 5-2

| | Average Iodine | | Average chlorine | | Distance between | | |
|---|---|---|---|---|---|---|---|
| | content (mol %)/ | Surface | content (mol %)/ | | twinning planes | % | |
| | % Coefficient of | Iodine | % Coefficient of | | (μm)/ | Proportion of | |
| Emulsion | variation between | content | variation between | Surface chloride | % Coefficient of | (100) planes | |
| No. | grains | (mol %) | grains | content (mol %) | variation | to side | Sensitizing dye |
| Em-A | 14/17 | 8 | 0 | 0 | 0.013/25 | 21 | ExS-1,2 |
| Em-B | 12.5/22 | 7 | 0 | 0 | 0.011/18 | 32 | ″ |
| Em-C | 3.2/15 | 2 | 0 | 0 | 0.011/22 | 18 | ″ |
| Em-D | 3.5/8 | 0.9 | 0 | 0 | — | — | ″ |
| Em-E | 5.1/9 | 3.5 | 0 | 0 | 0.010/22 | 3 | ExS-3,4 |
| Em-F | 5.7/9 | 12 | 0.6/<10 | 2 | 0.008/18 | 8 | ExS-3,5,6,7,8 |
| Em-G | 3.2/7 | 6 | 0.8/<10 | 2 | 0.008/18 | 10 | ″ |
| Em-H | 1.4/7 | 4 | 1/<10 | 3 | 0.008/18 | 12 | ″ |
| Em-I | 0.9/8 | 4 | 1.6/<10 | 5 | 0.008/18 | 25 | ″ |
| Em-J | 1.1/8 | 4 | 2.4/8 | 7 | 0.008/18 | 17 | ″ |
| Em-K | 5.7/9 | 12 | 0.6/<10 | 2 | 0.008/18 | 8 | ExS-9,10,11 |
| Em-L | 3.2/7 | 6 | 0.8/<10 | 2 | 0.008/18 | 10 | ″ |
| Em-M | 1.4/7 | 4 | 1/<10 | 3 | 0.008/18 | 12 | ″ |
| Em-N | 1.1/8 | 4 | 2.4/8 | 7 | 0.008/18 | 17 | ″ |
| Em-O | 1.7/8 | 4 | 2.4/8 | 7 | 0.008/18 | 22 | ″ |

TABLE 5-3

| Emulsion No. | Dopant | Chemical sensitization, fog inhibitor, etc. |
|---|---|---|
| Em-A | K₂lrCl₆ | The contents described in the above cited patents are |
| | | properly selected and combined |
| Em-B | ″ | The contents described in the above cited patents are |
| | | properly selected and combined |
| Em-C | K₂RhCl₆, K₂lrCl₆ | The contents described in the above cited patents are |
| | | properly selected and combined |
| Em-D | K₂lrCl₆ | The contents described in the above cited patents are |
| | | properly selected and combined |
| Em-E | K₂lrCl₆, K₂lrCl₆(H₂O), K₄Fe(CN)₆ | The contents described in the above cited patents are |
| | | properly selected and combined |
| Em-F | K₂lrCl₆, K₂lrCl₅(H₂O), K₄Ru(CN)₆ | The contents described in the above cited patents are |
| | | properly selected and combined |
| Em-G | ″ | The contents described in the above cited patents are |
| | | properly selected and combined |
| Em-H | ″ | The contents described in the above cited patents are |
| | | properly selected and combined |
| Em-I | ″ | The contents described in the above cited patents are |
| | | properly selected and combined |
| Em-J | ″ | The contents described in the above cited patents are |
| | | properly selected and combined |
| Em-K | ″ | The contents described in the above cited patents are |
| | | properly selected and combined |
| Em-L | ″ | The contents described in the above cited patents are |
| | | properly selected and combined |
| Em-M | ″ | The contents described in the above cited patents are |
| | | properly selected and combined |
| Em-N | ″ | The contents described in the above cited patents are |
| | | properly selected and combined |
| Em-O | ″ | The contents described in the above cited patents are |
| | | properly selected and combined |

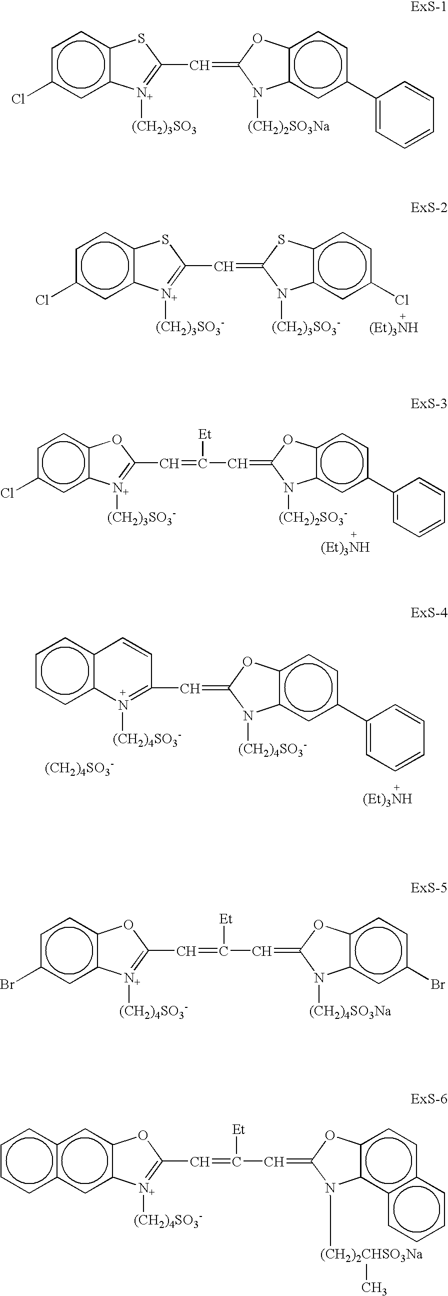

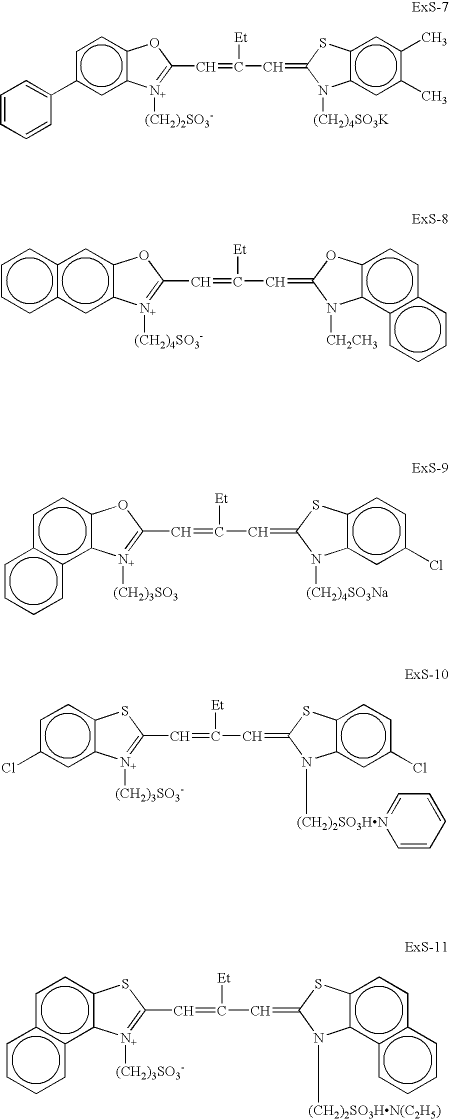

These emulsions were prepared according to proper selection, combination and/or modification of contents described in the detailed description and/or examples in the patents cited below.

The stricture, chemical sensitization and spectral sensitization of emulsion were based on the contents described in EP573649B1, JP2912768, JP-A-11-249249, JP-A-11-295832, JP-A-11-72860, U.S. Pat. Nos. 5,985,534 and 5,965,343, JP3002715, JP3045624, JP3045623, JP-A-2000-275771, U.S. Pat. No. 6,172,110, JP-A-2000-321702, JP-A-2000-321700, JP-A-2000-321698, U.S. Pat. No. 6,153,370, JP-A-2001-92065, JP-A-2001-92064, JP-A-2000-92059, JP-A-2001-147501, U.S. Patent 2001/0006768A1, JP-A-2001-228572, JP-A-2001-255613, JP-A-2001-264911, U.S. Pat. No. 6,280,920B1, JP-A-2001-264912, JP-A-2001-281778, and U.S. Patent 2001/003143A1.

The preparation of emulsion was based on the contents described in JP2878903, JP-A-11-143002, JP-A-11-143003, JP-A-11-174612, U.S. Pat. No. 5,925,508, U.S. Pat. No. 5,955,253, JP-A-11-327072, U.S. Pat. No. 5,989,800, JP3005382, JP3014235, EP04315858B1, U.S. Pat. No. 6,040,127A, JP3049647, JP3045622, JP3066692, EP0563708B1, JP3091041, JP-A-2000-338620, JP-A-2001-83651, JP-A-2001-75213, JP-A-2001-100343, U.S. Pat. No. 6,251,577B1, EP0563701B1, JP-A-2001-281780, and U.S. 2001/0036606A1.

1) Support

The support used in the present example was prepared in the following manner.

A mixture of 100 parts by weight of a polyethylene-2,6-naphthalate polymer and 2 parts by weight of Tinuvin P. 326 (produced by Ciba Geigy Inc.) as an ultraviolet absorber was dried, melted at 300° C., extruded through a T-die, longitudinally stretched at 140° C. and a factor of 3.3, crosswise stretched at 130° C. and a factor of 3.3, and then thermally-fixed at 250° C. for 6 seconds to obtain a PEN (polyethylenenapththalate) film having a thickness of 90 μm. The PEN film had a blue dye, a magenta dye and yellow dye (I-1, I-4, I-6, I-24, I-26, I-27, II-5 described Kokai Giho 94-6023) incorporated therein in a proper amount. The PEN film as given a heat history at 110° C. for 48 hours while being wound on a stainless steel core having a diameter of 20 cm to form a less curling support.

2) Spreading of Undercoat Layer

The aforementioned support was subjected to corona discharge treatment, UV discharge treatment and glow discharge treatment on the both sides thereof, and then coated with an undercoating solution containing 0.1 g/m² of gelatin, 0.01 g/m² of sodium-α-sulfodi-2-ethylhexyl succinate, 0.04 g/m² of salicylic acid, 0.2 g/m² of p-chlorophenol, 0.012 g/m² of (CH₂═CHSO₂CH₂CH₂NHCO)₂CH₂ and 0.02 g/m² of a polyamideepichlorohydrinpolycondensate on the respective side (10 cc//m², using a bar coater). The support was then positioned with the undercoat layer side thereof facing the high temperature side during stretching. The drying of the support was conducted at 115° C. for 6 minutes (The roller and conveying device in the drying zone were all at 115° C.).

3) Spreading of Back Layer

The aforementioned support thus undercoated was then coated with an antistatic layer, a magnetic recording layer and a slipping layer having the following formulation as a back layer on one side thereof.

3-1) Spreading of Antistatic Layer

A mixture of 0.2 g/m² of a dispersion of a finely divided powder of tin oxide-antimony oxide composite having an average grain diameter of 0.005 μm and a specific resistivity of 5 Ω·cm (secondary agglomerated grain diameter: about 0.08 μm) 0.05 g/m² of gelatin, 0.02 g/m² of (CH₂═CHSO₂CH₂CH₂NHCO)₂CH₂, 0.005 g/m² of a poly(polymerization degree: 10)oxyethylene-p-nonylphendol and resorcin was spread.

3-2) Spreading of Magnetic Recording Layer

0.06 g/m² of cobalt-γ-iron oxide (specific surface area: 43 m²/g; major axis length: 0.14 μm; minor axis length: 0.03 μm; saturated magnetization: 89 A·m²/kg; Fe²⁺/Fe³⁺=6/94; surface treated with silicon oxoaluminate in an amount 2% by weight of iron oxide) coated with a 3-poly(polymerization degree: 15) oxyethylene-propyloxytrimethoxysilane (15% by weight) was spread with 1.2 g/m² of diacetyl cellulose (The dispersion of iron oxide was carried out by an open kneader and a sand mill), 0.3 g/m² of C₂H₅C (CH₂OCONH—C₆H₃ (CH₃) NCO)₃ as a hardener and acetone, methyl ethyl ketone and cyclohexanone as a solvent using a bar coater to form a magnetic recording layer to a thickness of 1.2 μm. To the magnetic recording layer thus spread were then added particulate silica (0.3 μm diameter) as a matting agent and aluminum oxide (0.15 μm diameter) coated with a 3-poly(polymerization degree: 15)oxyethylene-propyloxy trimethoxysilane (15% by weight) as an abrasive each in an amount of 10 mg/m². The magnetic recording layer thus spread was then dried at 115° C. for 6 minutes (The roller and conveying device in the drying zone were all at 115° C.). The color density increase D^{B} of the magnetic recording layer under X-light (blue filter) was about 0.1. The saturated magnetization moment of the magnetic recording layer was 4.2 emu/g. The coercive force of the magnetic recording layer was 7.3×10⁴ A/m. The rectangularity ratio of the magnetic recording layer was 65%.

3-3) Preparation of Slipping Layer

A mixture of diacetyl cellulose (25 mg/m²) and C₆H₁₃CH(OH)C₁₀H₂₀COOC₄₀H₈₁ (compound a: 6 mg/m²)/C₅₀H₁₀₁O(CH₂CH₂O)₁₆H (compound b: 9 mg/m²) was spread. Before spreading, this mixture was melted in xylene/propylene monomethyl ether (1/1) at 105° C., poured into and dispersed in propylene monomethyl ether (in a 10-fold amount) at ordinary temperature, and then dispersed in acetone to form a dispersion (average grain diameter; 0.01 μm). To the mixture were added particulate silica (0.3 μm diameter) as a matting agent and aluminum oxide (0.15 μm diameter) coated with a 3-poly(polymerization degree: 15) oxyethylene-propyloxy trimethoxysilane (15% by weight) as an abrasive each in an amount of 15 mg/m². The slipping recording layer thus spread was then dried at 115° C. for 6 minutes (The roller and conveying device in the drying zone were all at 115° C.). The slipping layer thus formed had a dynamic friction coefficient of 0.06 (5 mmφ stainless steel hard sphere; load: 100 g; speed: 6 cm/min) and a static friction coefficient of 0.07 (clip method). The emulsion surface and the slipping layer described later, too, exhibited a dynamic friction coefficient as excellent as 0.12.

4) Spreading of Light-Sensitive Layer

Various layers having the following formulations were simultaneously spread over the support on the side opposite the back layer to prepare Sample 901 as a color negative photographic light-sensitive material.

(Formulation of Light-sensitive Layer)

The main materials to be incorporated in the various layers are classified as follows:

| | |
|---|---|
| ExC: Cyan coupler | UV: Ultraviolet absorber |
| ExM: Magenta coupler | HBS: High boiling |
| | organic solvent |
| ExY: Yellow coupler | |
| H: Gelatin hardener | |

(In the following description, these symbols were suffixed to indicate specific compounds the chemical formula of which are shown later.)

The various components are provided with a figure that indicates its spread (unit; g/m²), with the proviso that the spread of silver halide is represented as calculated in terms of silver.

1st layer (1st Anti-halation Layer)

| Black colloidal silver | 0.10 (as |
|---|---|
| | calculated in |
| | terms of silver) |
| Gelatin | 0.66 |
| ExM-1 | 0.048 |
| Cpd-2 | 0.001 |
| F-8 | 0.001 |
| HBS-1 | 0.090 |
| HBS-2 | 0.010 |

2nd Layer (2nd Anti-halation Layer)

| Black colloidal silver | 0.10 (as |
|---|---|
| | calculated in |
| | terms of silver) |
| Gelatin | 0.80 |
| ExM-1 | 0.057 |
| ExF-1 | 0.002 |
| F-8 | 0.001 |
| HBS-1 | 0.090 |
| HBS-2 | 0.010 |

3rd Layer (Interlayer)

| | |
|---|---|
| ExC-2 | 0.010 |
| Cpd-1 | 0.086 |
| UV-2 | 0.029 |
| UV-3 | 0.052 |
| UV-4 | 0.011 |
| HBS-1 | 0.100 |
| Gelatin | 0.60 |

4th Layer (Low Sensitivity Red-sensitive Emulsion Layer)

| Em-M | 0.42 (as |
|---|---|
| | calculated in |
| | terms of silver) |
| Em-N | 0.52 (as |
| | calculated in |
| | terms of silver) |
| Em-O | 0.10 (as |
| | calculated in |
| | terms of silver) |
| ExC-1 | 0.222 |
| ExC-2 | 0.010 |
| ExC-3 | 0.072 |
| ExC-4 | 0.148 |
| ExC-5 | 0.005 |
| ExC-6 | 0.008 |
| ExC-8 | 0.071 |
| ExC-9 | 0.010 |
| UV-2 | 0.036 |
| UV-3 | 0.067 |
| UV-4 | 0.014 |
| Cpd-2 | 0.010 |
| Cpd-4 | 0.012 |
| HBS-1 | 0.240 |
| HBS-5 | 0.010 |
| Gelatin | 1.50 |

5th Layer (Middle Sensitivity Red-sensitive Emulsion Layer)

| Em-L | 0.38 (as |
|---|---|
| | calculated in |
| | terms of silver) |
| Em-M | 0.28 (as |
| | calculated in |
| | terms of silver) |
| ExC-1 | 0.111 |
| ExC-2 | 0.039 |
| ExC-3 | 0.018 |
| ExC-4 | 0.074 |
| ExC-5 | 0.019 |
| ExC-6 | 0.024 |
| ExC-8 | 0.010 |
| ExC-9 | 0.021 |
| Cpd-2 | 0.020 |
| Cpd-4 | 0.021 |
| HBS-1 | 0.129 |
| Gelatin | 0.85 |

6th Layer (High Sensitivity Red-sensitive Emulsion Layer)

| Emulsion a of Example 2 | 1.40 (as |
|---|---|
| | calculated in |
| | terms of silver) |
| ExC-1 | 0.122 |
| ExC-6 | 0.032 |
| ExC-8 | 0.110 |
| ExC-9 | 0.005 |
| ExC-10 | 0.159 |
| Cpd-2 | 0.068 |
| Cpd-4 | 0.015 |
| HBS-1 | 0.440 |
| Gelatin | 1.51 |

7th Layer (Interlayer)

| | |
|---|---|
| Cpd-1 | 0.081 |
| Cpd-6 | 0.002 |
| Solid disperse dye ExF-4 | 0.015 |
| HBS-1 | 0.049 |
| Polyethyl acrylate latex | 0.088 |
| Gelatin | 0.80 |

8th Layer (Interimaging Donor Layer (Layer Giving Interimage Effect to Red-sensitive Layer)

| Em-E | 0.40 (as |
|---|---|
| | calculated in |
| | terms of silver) |
| Cpd-4 | 0.010 |
| ExM-2 | 0.082 |
| ExM-3 | 0.006 |
| ExM-4 | 0.026 |
| ExY-1 | 0.010 |
| ExY-4 | 0.040 |
| ExC-7 | 0.007 |
| HBS-1 | 0.203 |
| HBS-3 | 0.003 |
| HBS-5 | 0.010 |
| Gelatin | 0.52 |

9th Layer (Low Sensitivity Green-sensitive Emulsion Layer)

| Em-H | 0.15 (as |
|---|---|
| | calculated in |
| | terms of silver) |
| Em-I | 0.23 (as |
| | calculated in |
| | terms of silver) |
| Em-J | 0.26 (as |
| | calculated in |
| | terms of silver) |
| ExM-2 | 0.388 |
| ExM-3 | 0.040 |
| ExY-1 | 0.003 |
| ExY-3 | 0.002 |
| ExC-7 | 0.009 |
| HBS-1 | 0.337 |
| HBS-3 | 0.018 |
| HBS-4 | 0.260 |
| HBS-5 | 0.110 |
| Cpd-5 | 0.010 |
| Gelatin | 1.45 |

10th Layer (Middle Sensitivity Green-sensitive Emulsion Layer)

| Em-G | 0.30 (as |
|---|---|
| | calculated in |
| | terms of silver) |
| Em-H | 0.12 (as |
| | calculated in |
| | terms of silver) |
| ExM-2 | 0.084 |
| ExM-3 | 0.012 |
| ExM-4 | 0.005 |
| ExY-3 | 0.002 |
| ExC-6 | 0.003 |
| ExC-7 | 0.007 |
| ExC-8 | 0.008 |
| HBS-1 | 0.096 |
| HBS-3 | 0.002 |
| HBS-5 | 0.002 |
| Cpd-5 | 0.004 |
| Gelatin | 0.42 |

11th Layer (High Sensitivity Green-sensitive Emulsion Layer)

| Em-F | 1.20 (as |
|---|---|
| | calculated in |
| | terms of silver) |
| ExC-6 | 0.002 |
| ExC-8 | 0.010 |
| ExM-1 | 0.014 |
| ExM-2 | 0.023 |
| ExM-3 | 0.023 |
| ExM-4 | 0.005 |
| ExM-5 | 0.040 |
| ExY-3 | 0.003 |
| Cpd-3 | 0.004 |
| Cpd-4 | 0.007 |
| Cpd-5 | 0.010 |
| HBS-1 | 0.259 |
| HBS-5 | 0.020 |
| Polyethyl acrylate latex | 0.099 |
| Gelatin | 1.110 |

12th Layer (Yellow Filter Layer)

| | |
|---|---|
| Cpd-1 | 0.088 |
| Oil-soluble dye ExF-2 | 0.051 |
| Solid disperse dye ExF-8 | 0.010 |
| HBS-1 | 0.049 |
| Gelatin | 0.54 |

13th Layer (Low Sensitivity Blue-sensitive Emulsion Layer)

| Em-B | 0.50 (as |
|---|---|
| | calculated in |
| | terms of silver) |
| Em-C | 0.15 (as |
| | calculated in |
| | terms of silver) |
| Em-D | 0.10 (as |
| | calculated in |
| | terms of silver) |
| ExC-1 | 0.024 |
| ExC-7 | 0.011 |
| ExY-1 | 0.002 |
| ExY-2 | 0.956 |
| ExY-4 | 0.091 |
| Cpd-2 | 0.037 |
| Cpd-3 | 0.004 |
| HBS-1 | 0.372 |
| HBS-5 | 0.047 |
| Gelatin | 2.00 |

14th Layer (High Sensitivity Blue-sensitive Emulsion Layer)

| Em-A | 1.22 (as |
|---|---|
| | calculated in |
| | terms of silver) |
| ExY-2 | 0.235 |
| ExY-4 | 0.018 |
| Cpd-2 | 0.075 |
| Cpd-3 | 0.001 |
| HBS-1 | 0.087 |
| Gelatin | 1.30 |

15th Layer (1st Protective Layer)

| Emulsion of silver bromoiodide | 0.25 (as |
|---|---|
| grains having a diameter of 0.07 μm | calculated in |
| | terms of silver) |
| UV-1 | 0.358 |
| UV-2 | 0.179 |
| UV-3 | 0.254 |
| UV-4 | 0.025 |
| F-11 | 0.008 |
| S-1 | 0.078 |
| ExF-5 | 0.0024 |
| ExF-6 | 0.0012 |
| ExF-7 | 0.0010 |
| HBS-1 | 0.175 |
| HBS-4 | 0.050 |
| Gelatin | 1.80 |

16th Layer (2nd Protective Layer)

| | |
|---|---|
| H-1 | 0.400 |
| B-1 (diameter: 1.7 μm) | 0.050 |
| B-2 (diameter: 1.7 μm) | 0.150 |
| B-3 | 0.050 |
| S-1 | 0.200 |
| Gelatin | 0.75 |

The various layers further comprised W-1 to W-6, B-4 to B-6, F-1 to F-17, iron salts, lead salts, gold salts, palladium salts, iridium salts, ruthenium salts and rhodium salts incorporated properly therein to improve the preservability, processability, pressure resistance, mildewproofing and antibacterial properties, antistatic properties and spredability thereof.

Sample No. 902 was prepared in the same manner as mentioned above except that Emulsion a prepared in Example 2 to be incorporated in the 6th layer was changed to Emulsion b.

Sample No. 903 was prepared in the same manner as mentioned above except that Emulsion a prepared in Example 2 to be incorporated in the 6th layer was changed to Emulsion c.

Sample No. 904 was prepared in the same manner as mentioned above except that Emulsion a prepared in Example 2 to be incorporated in the 6th layer was changed to Emulsion d.

Sample No. 905 was prepared in the same manner as mentioned above except that Emulsion a prepared in Example 2 to be incorporated in the 6th layer was changed to Emulsion e.

Preparation of Dispersion of Organic Solid Disperse Dye

ExF-4 having the following formulation was dispersed in the following manner. In some detail, 21.7 ml of water, 3 ml of a 5% aqueous solution of sodium p-octylphenoxyethoxyethoxyethanesulfonate and 0.5 g of a 5% aqueous solution of p-octylnoehoxypolyoxyethylene ether (polymerization degree: 10) were charged in a 700 ml pot mill. To the contents of the pot mill were then added 5.0 g of the dye ExF-4 and 500 ml of oxidized zirconium beads (diameter: 1 mm). The contents of the pot -mill were then subjected to dispersion for 2 hours. For dispersion, a BO type oscillation ballmill produced by Chuo Koki Sangyo CO., LTD. was used. After dispersion, the contents were withdrawn from the pot mill, and then added to 8 g of a 12.5% aqueous solution of gelatin. The beads were then withdrawn from the dispersion by filtration to obtain a gelatin dispersion of dye. The particulate dye had an average grain diameter of 0.44 μm.

ExF-2 was dispersed by a microprecipitation dispersion method as described in Example 1 of EP 549,489A. The particulate dye had an average grain diameter of 0.06 μm.

The solid dispersion of ExF-8 was prepared in the following manner.

To 2,800 g of wet cake of ExF-8 having a water content of 18% were added 4,000 g of water and 376 g of a 3% aqueous solution of W-2. The mixture was then stirred to make a 32% slurry of ExF-6. Subsequently, the slurry was passed through a Type UVM-2 ultraviscomill (produced by IMEX Co., Ltd.) filled with zirconia beads having an average particle diameter of 0.5 mm to undergo grinding at a peripheral speed of 10 m/sec and a discharge rate of 0.5 l/min for 8 hours. The resulting solid dispersion had an average grain diameter of 0.45 μm.

The chemical formula of the compounds used in the formation of the aforementioned various layers will be given below.

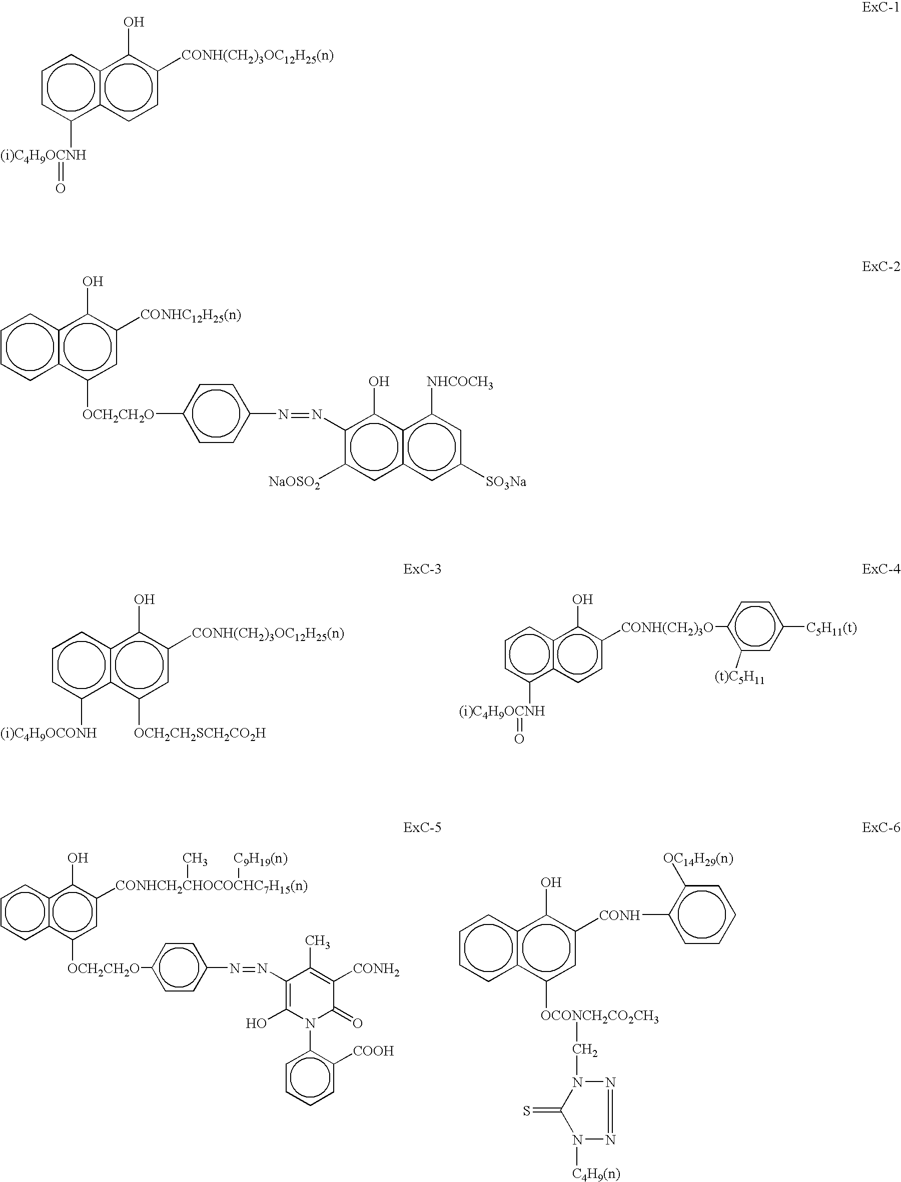

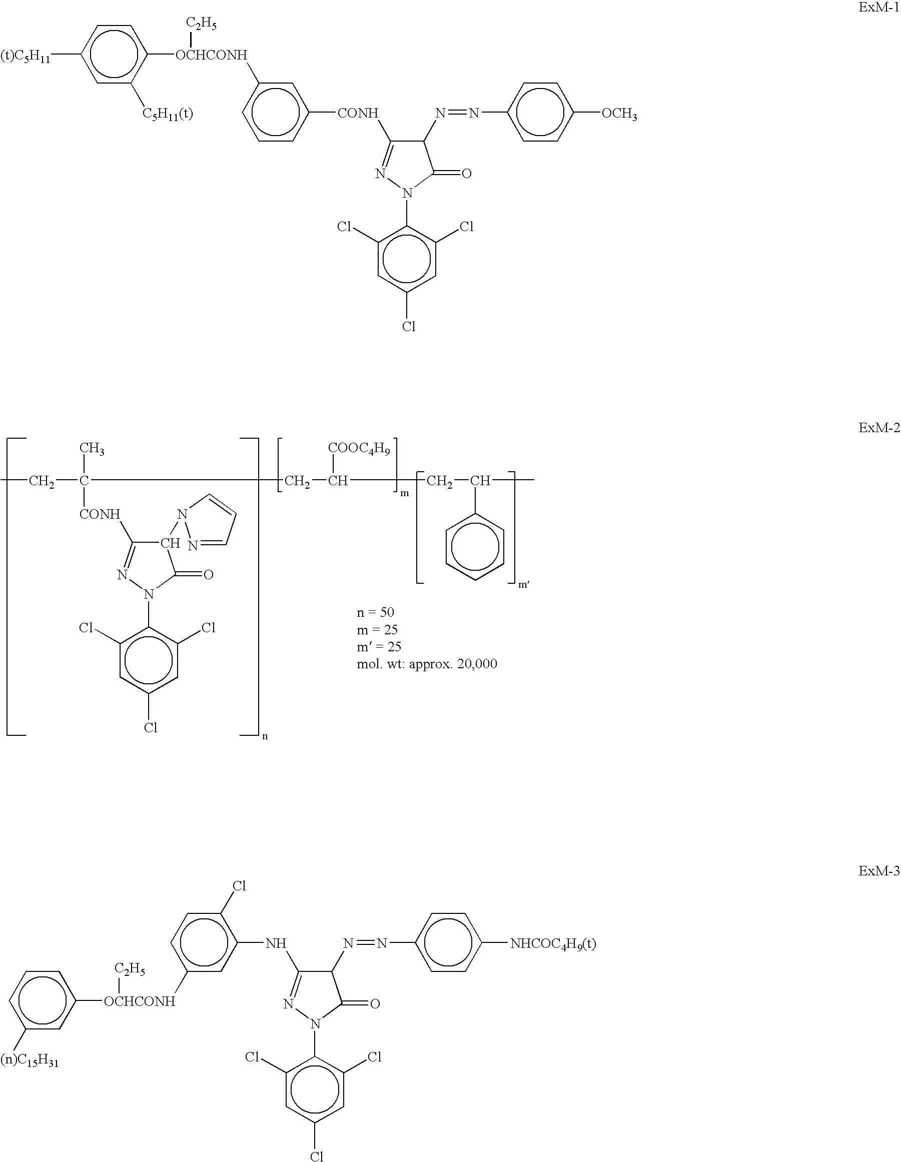

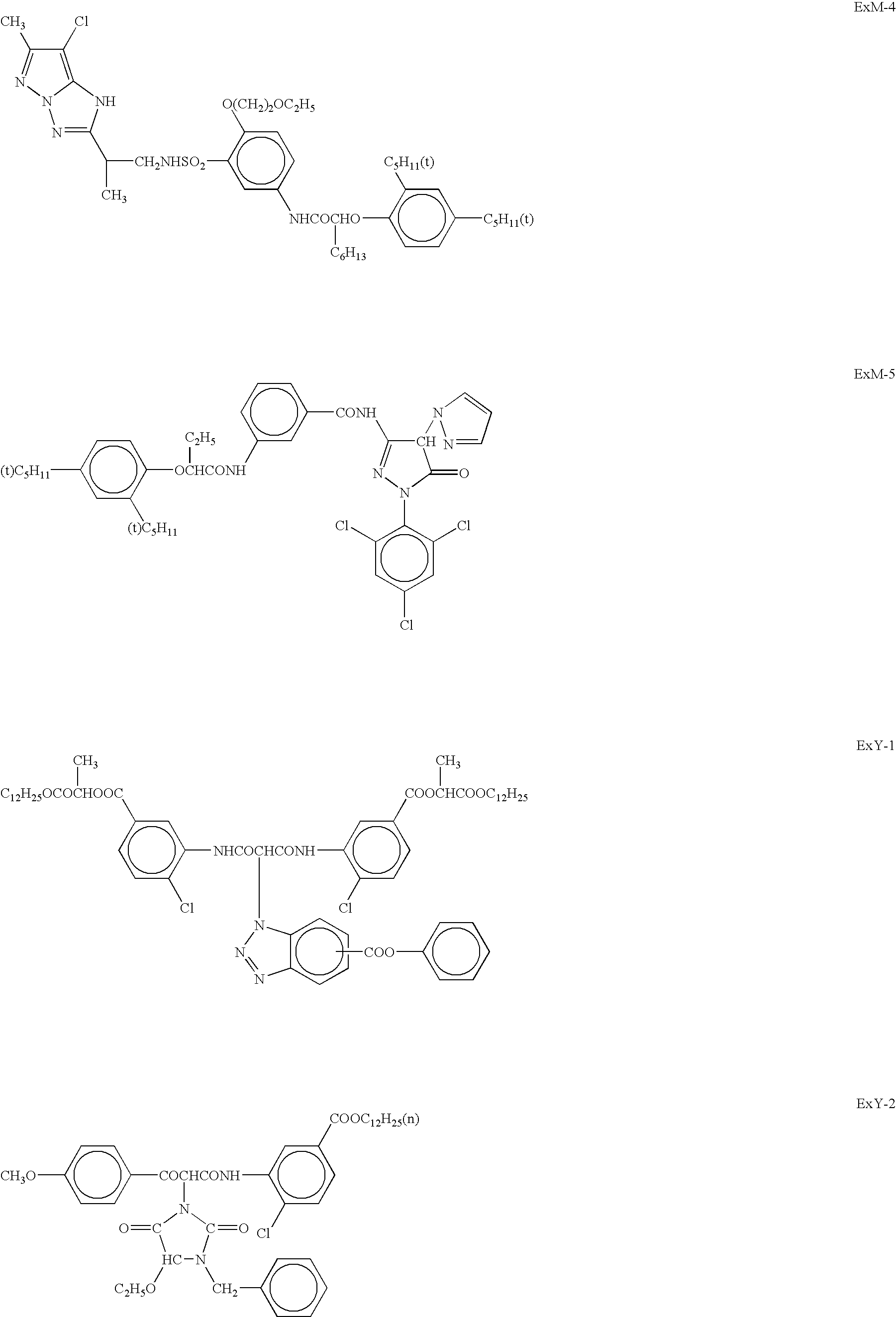

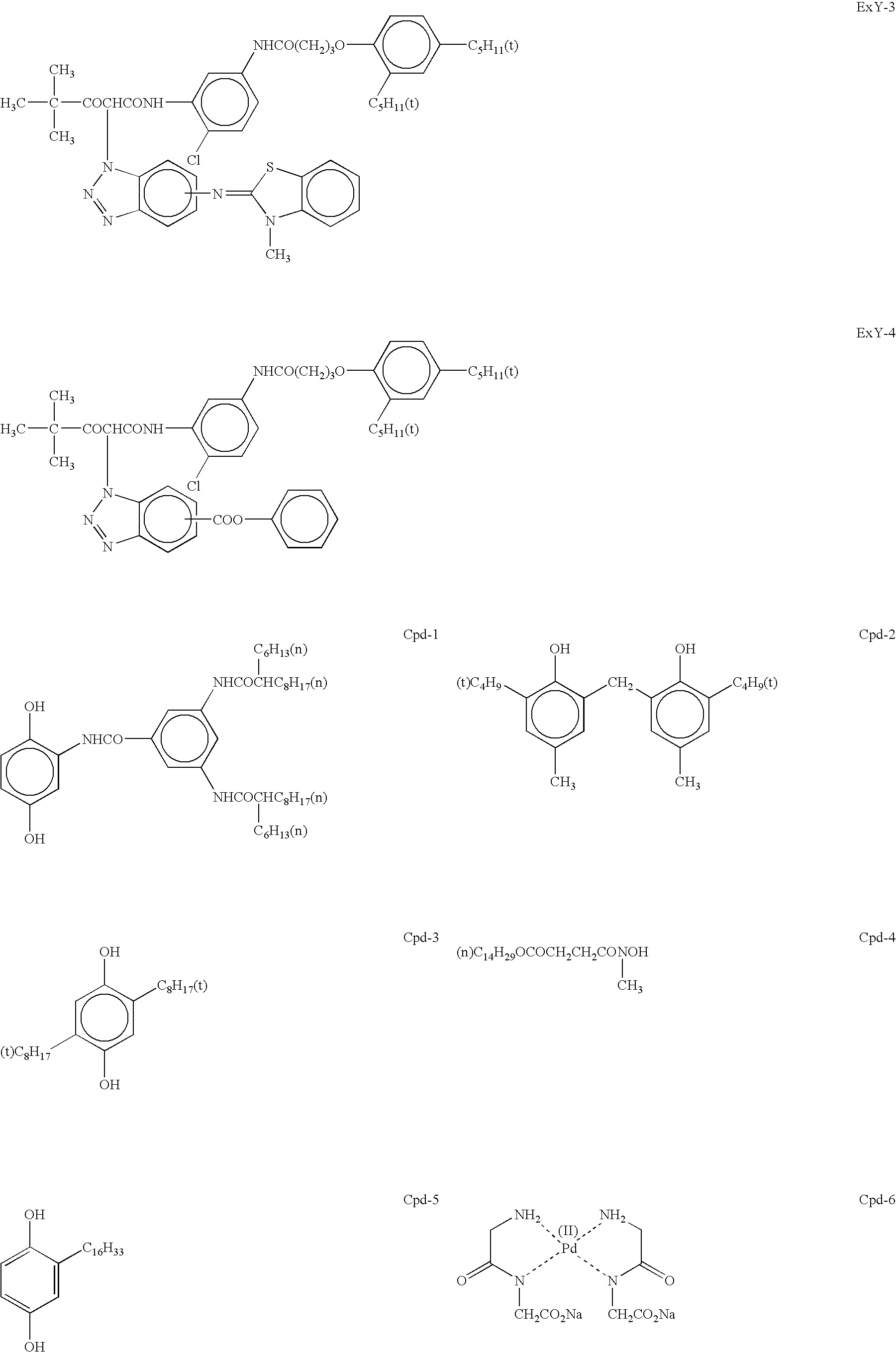

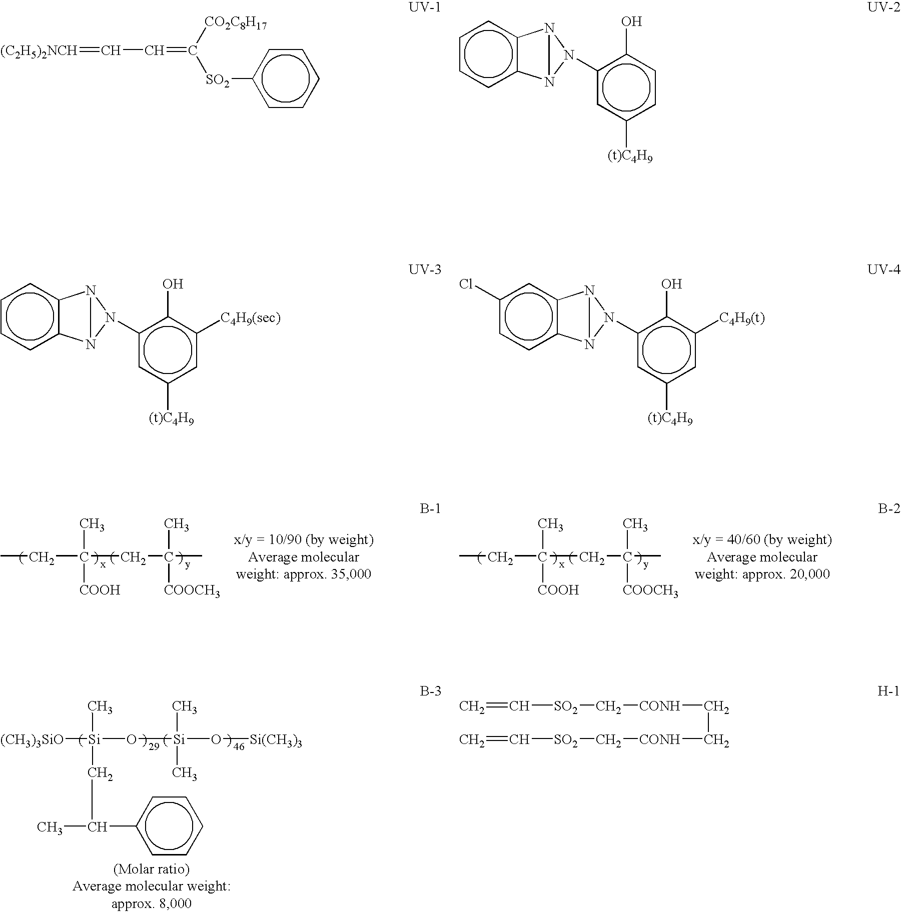

HBS-1: Tricresyl phosphate

HBS-2: Di-n-butyl phthalate

HBS-3:

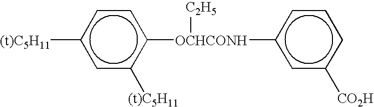

HBS-4: Tri (2-ethylhexyl)phosphate

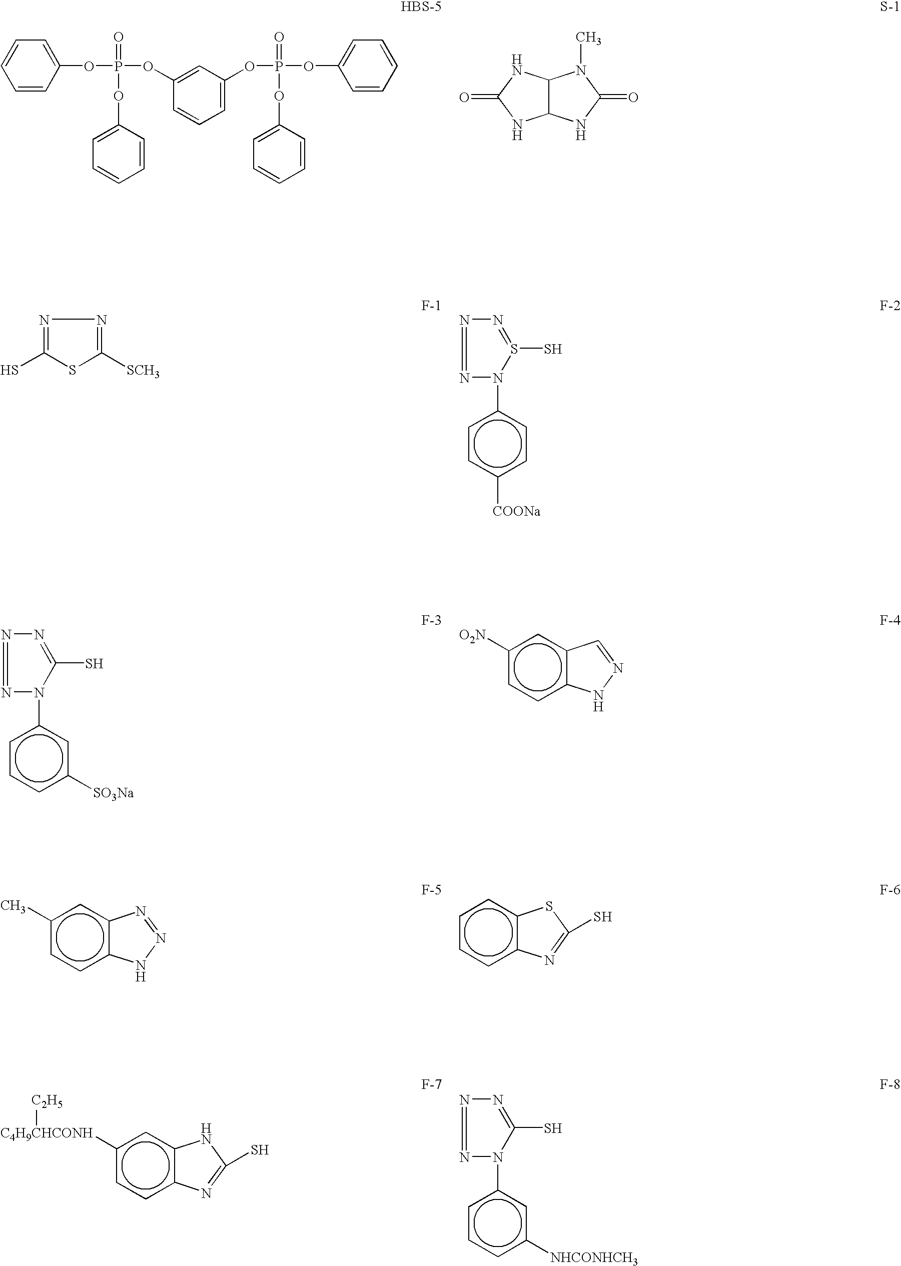

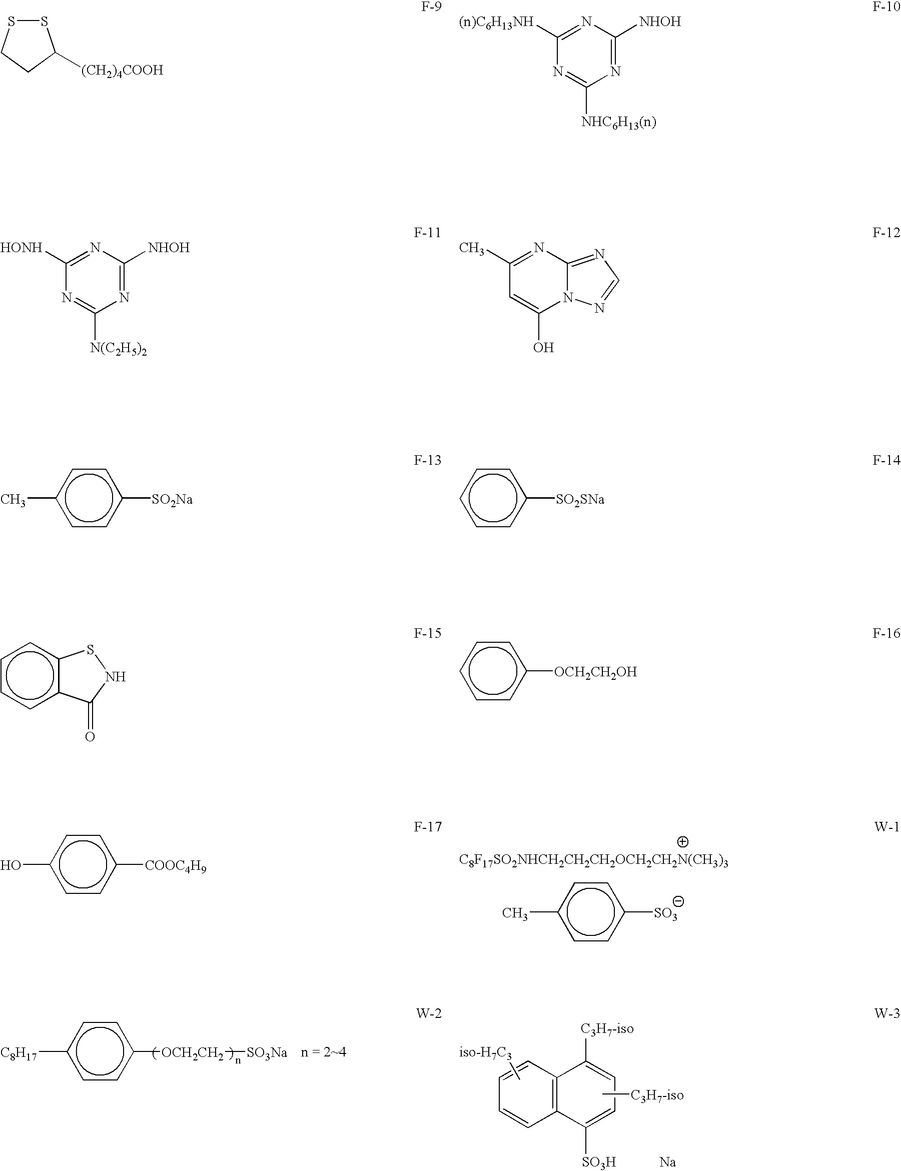

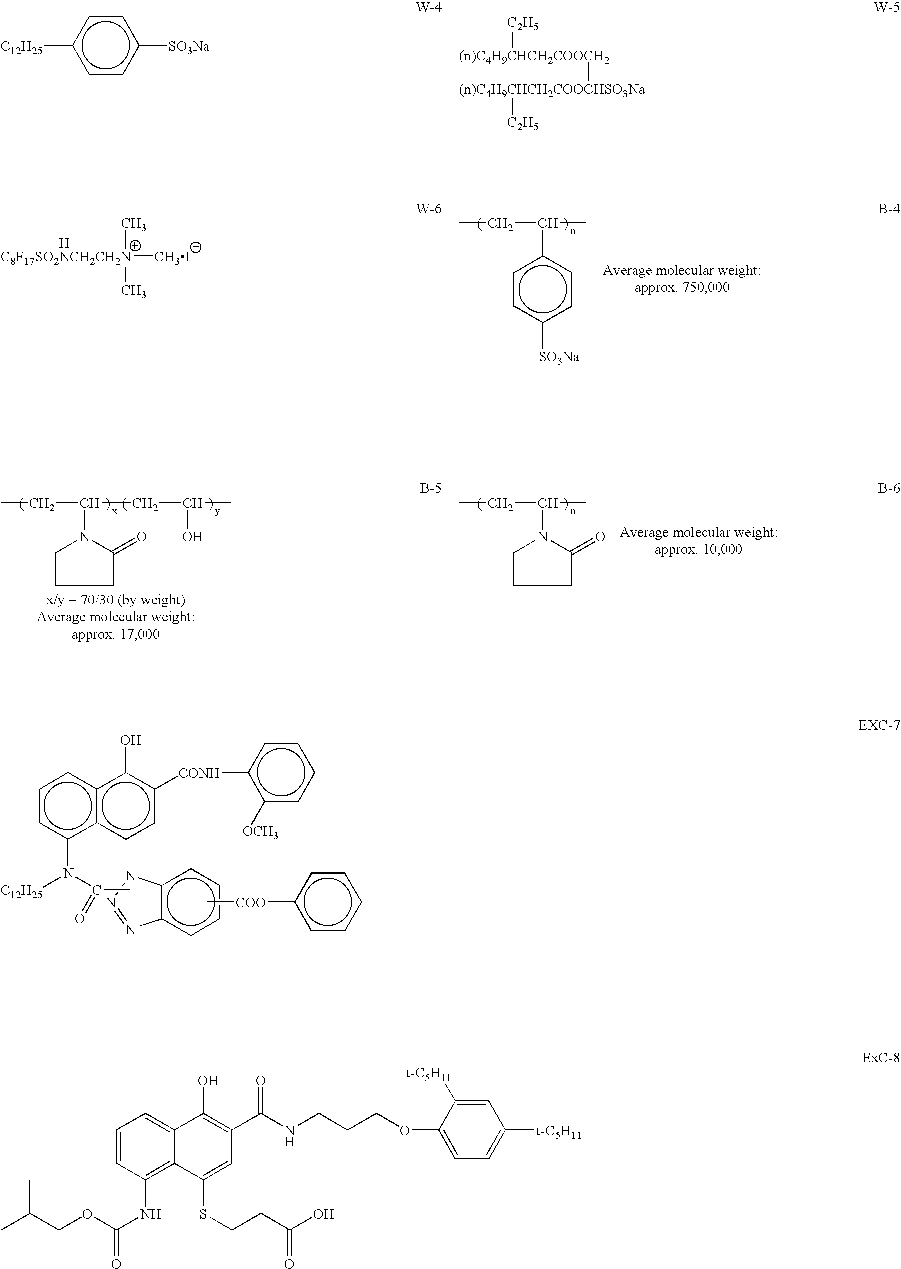

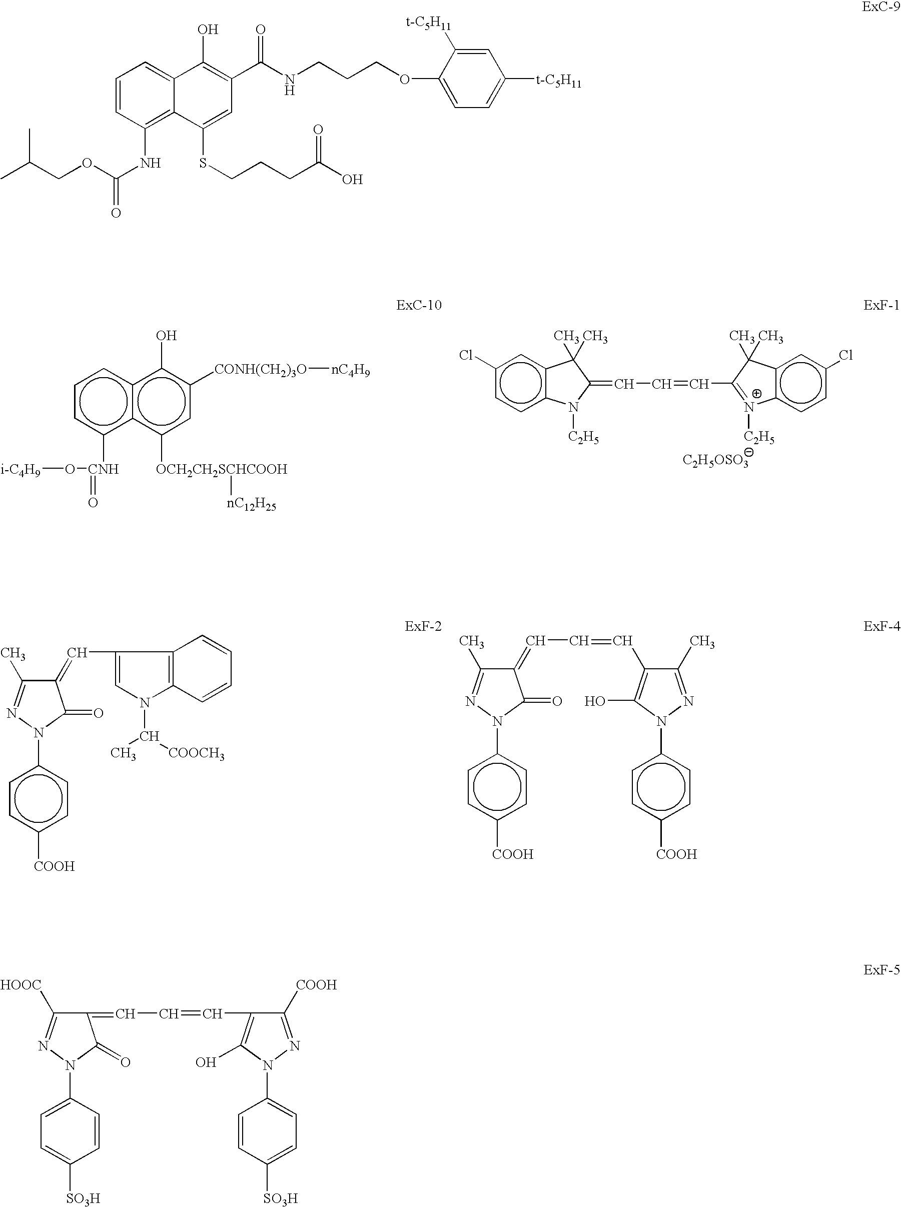

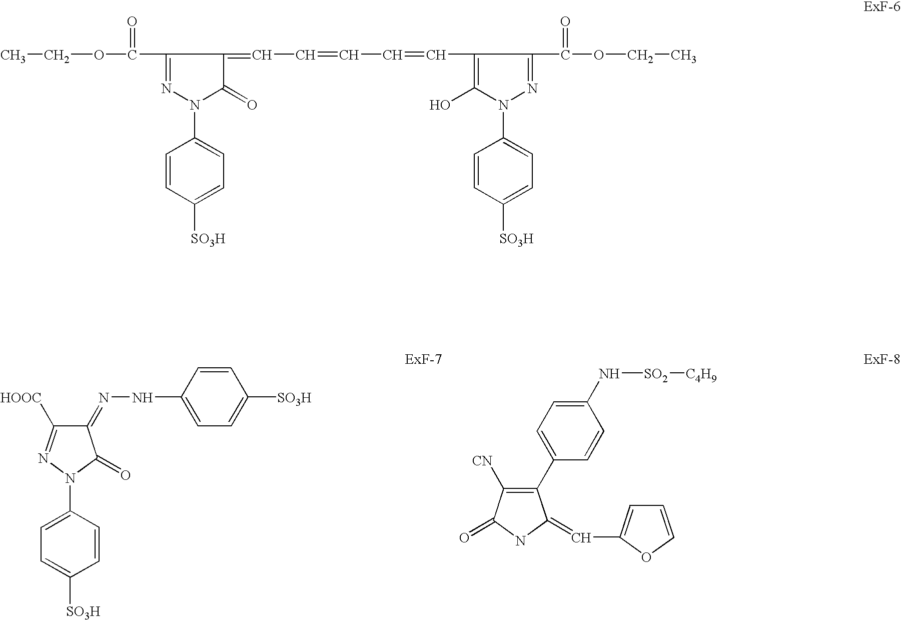

The measurement of specific photographic sensitivity in the invention was conducted substantially according to JIS K 7614-1681 except that development was completed in from 30 minutes to 6 hours after exposure for sensimetry and development was conducted according to Fuji Color Processing CN-16 described below. The others were substantially the same as the measurement described in the JIS

The photographic processing was conducted in the same manner as in test conditions, exposure, measurement of density and determination of specific photographic sensitivity described in JP-A-63-22650 except the processing conditions described later.

Development was conducted using a Type FP-360B automatic developing machine (produced by Fuji Photo Film Co., Ltd.). The automatic developing machine was remodeled such that the overflow solution from the bleach bath is all discharged into the waste liquid tank instead of into the subsequent bath. The automatic developing machine FP-360B was equipped with an evaporation correcting unit described in Kokai Giho 94-4992 of Japan Institute of Invention and Innovation.

The processing steps and the formulation of the processing solutions will be given below.

(Processing Step)

| | | | | Capacity |
|---|---|---|---|---|
| | | | | of running |
| | Processing | Processing | Replenishment | solution |
| Step | time | temperature | Rate* | tank |
| Color | 3 m. 5 s. | 37.8° C. | 20 ml | 11.5 l |
| development | | | | |
| Bleach | 50 s. | 38.0° C. | 5 ml | 5 l |
| Fixing (1) | 50 s. | 38.0° C. | — | 5 l |
| Fixing (2) | 50 s. | 38.0° C. | 8 ml | 5 l |
| Rinsing | 30 s. | 38.0° C. | 17 ml | 3 l |
| Stabilization (1) | 20 s. | 38.0° C. | — | 3 l |
| Stabilization (2) | 20 s. | 38.0° C. | 15 ml | 3 l |
| Drying | 1 m. 30 s. | 60.0° C. | | |

*Replenishment rate is represented per 35 mm width and 1.1 m length of photographic light-sensitive material (corresponding to one 24Ex.)

The stabilizer and the fixing solution were allowed to flow from the bath (2) to the bath (1) in a countercurrent system. The overflow solution from the rinsing bath was all introduced into the fixing bath (2). The amount of the developer carried over to the bleach step, the amount of the bleaching solution carried over to the fixing step and the amount of the fixing solution carried over to the rinsing step were 2.5 ml, 2.0 ml and 2.0 ml per 35 mm width and 1.1 m length of photographic light-sensitive material, respectively. The crossover time was 6 seconds at every step. This crossover time is included in the processing time at the prebath.

The opening area of the processing machine was 100 cm² for color developer, 120 cm² for bleaching solution and about 100 cm² for other processing solutions.

The formulation of the processing solutions will be given below.

| | Running | |
|---|---|---|
| | solution | Replenisher |
| | (g) | (g) |
| (Color developer) | | |
| Diethylenetriaminepentaacetic acid | 3.0 | 3.0 |
| Disodium catechol-3,5-disulfonate | 0.3 | 0.3 |
| Sodium sulfite | 3.9 | 5.3 |
| Potassium carbonate | 39.0 | 39.0 |
| Disodium-N,N-bis(2- | 1.5 | 2.0 |
| sulfonatoethyl)hydroxylamine | | |
| Potassium bromide | 1.3 | 0.3 |
| Potassium iodide | 1.3 mg | — |
| 4-Hydroxy-6-methyl-1,3,3a,7-tetrazaindene | 0.05 | — |
| Hydroxyaminesulfate | 2.4 | 3.3 |
| 2-Methyl-4-[N-ethyl-N-(β- | 4.5 | 6.5 |
| hydroxyethyl)amino]aniline sulfate | | |
| Water to make | 1.0 l | 1.0 l |
| pH (adjusted with potassium hydroxide | 10.05 | 10.18 |
| and sulfuric acid | | |
| (Bleaching solution) | | |
| Ammonium 1,3-diaminopropanetetraacetato | 113 | 170 |
| ferrate monohydrate | | |
| Ammonium bromide | 70 | 105 |
| Ammonium nitrate | 14 | 21 |
| Succinic acid | 34 | 51 |
| Maleic acid | 28 | 42 |
| Water to make | 1.0 l | 1.0 l |
| pH [adjusted with aqueous ammonia] | 4.6 | 4.0 |
| (Running fixing solution (1)) 5:95 (by volume) | | |
| mixture of the aforementioned running | | |
| bleaching solution and the following running | | |
| fixing solution (pH 6.8) | | |
| (Fixing solution (2)) | | |
| Aqueous solution of ammonium thiosulfate | 240 ml | 720 ml |
| (750 g/l) | | |
| Imidazole | 7 | 21 |
| Ammonium methanesulfonate | 5 | 15 |
| Ammonium methanesulfinate | 10 | 30 |
| Ethylenediaminetetraacetate | 13 | 39 |
| Water to make | 1.0 l | 1.0 l |
| pH [adjusted with aqueous ammonia and | 7.4 | 7.45 |
| acetic acid] | | |

(Rinsing Solution)

Tap water was passed through a mixed bed column filled with an H type strongly acidic cation exchange resin (Amberlite IR-120B, produced by Rohm & Haas Inc.) and an OH type strongly acidic anion exchange resin (Amberlite IR-400, produced by Rohm & Haas Inc.) to reduce the calcium and magnesium ion concentrations to 3 mg/l or less. Subsequently, to the tap water thus processed were added 20 mg/l of sodium isocyanurate dichloride and 150 mg/l of sodium sulfate. The rinsing solution thus obtained had a pH value of from 6.5 to 7.5.

(Stabilizer) Common in Running Solution and Replenishment Solution (Unit: g)

| | |
|---|---|
| Sodium p-toluenesulfinate | 0.03 |
| Polyoxyethylene-p-monononylphenylether (average | 0.2 |
| polymerization degree: 10) | |
| Disodium ethylenediaminetetraacetate | 0.10 |
| 1,2,4-Triazole | 1.3 |
| 1,4-Bis(1,2,4-triazole-1-ilmethyl)piperadine | 0.75 |
| Water to make | 1.0 l |
| pH | 8.5 |

The results are set forth in Table 6.

TABLE 6

| | Emulsion to be | | | |
|---|---|---|---|---|
| | incorporated in 6th | | | |
| Sample No. | layer | Fogging | Sensitivity | Remarks |
| 901 | a | 0.18 | 124 | Invention |
| 902 | b | 0.18 | 123 | Invention |
| 903 | c | 0.19 | 100 | Comparison |
| 904 | d | 0.18 | 124 | Invention |
| 905 | e | 0.19 | 119 | Comparison |

*Sensitivity is represented relative to that of Sample No. 903 as 100.

As can be seen in Table 6, the use of the emulsion prepared according to the preparation process of the invention makes it possible to prepare a high sensitivity silver halide emulsion which is subject to fogging to the same extent as ever.

While the invention has been described in detail and with reference to specific embodiments thereof, it will be apparent to one skilled in the art that various changes and modifications can be made therein without departing from the spirit and scope thereof.

What is claimed is:

1. A process for the preparation of an emulsion of silver halide fine grains having a number-average equivalent circle diameter of 100 nm or less and coefficient of variation in equivalent circle diameter of 40% or less, wherein the fine grains are prepared via at least one Ostwald ripening step.

2. The process for the preparation of an emulsion of silver halide fine grains as claimed in claim 1, wherein one or more Ostwald ripening steps are effected in such a manner that the absolute value of coefficient of variation in equivalent circle diameter of the fine grains shows a drop of at least 5% from before ripening.

3. The process for the preparation of an emulsion 6f silver halide fine grains as claimed in claim 1, wherein the silver halide fine grains are continuously prepared using a device substantially free of residence portion.

4. The process for the preparation of an emulsion of silver halide fine grains as claimed in claim 1, wherein the silver halide fine grains have coefficient of variation in equivalent circle diameter of 20% or less.

5. The process for the preparation of an emulsion of silver halide fine grains as claimed in claim 1, wherein the silver halide fine grains have a number-average equivalent circle diameter of 40 nm or less.

6. The process for the preparation of an emulsion of silver halide fine grains as claimed in claim 1, wherein the silver halide fine grains have a percent twinning of 10% or less.

7. A process for the preparation of an emulsion of silver halide tabular grains, wherein at least a part of the growth of the silver halide tabular grains is carried out by charging silver halide fine grains prepared by the method claimed in claim 1 in the reaction vessel in which the growth of the silver halide tabular grains is effected.

8. The process for the preparation of an emulsion of silver halide tabular grains as claimed in claim 7, wherein the addition of the fine grains is effected immediately after the preparation thereof.

9. The process for the preparation of an emulsion of silver halide tabular grains as claimed in claim 7, wherein ultrafiltration is effected in at least a part of the step of preparation of the emulsion of silver halide tabular grains.
